(19) United States
(12) Patent Application Publication
(10) Pub. No.: US 2021/0079029 A1
(43) Pub. Date: Mar. 18, 2021

(54) POLYMERISATION OF OLEFINS

(71) Applicant: SCG CHEMICALS CO., LTD., Bangkok (TH)

(72) Inventors: Charlotte Katherine Williams, Oxford (GB); Christopher Blair Durr, Oxford (GB)

(21) Appl. No.: 16/644,341

(22) PCT Filed: Sep. 4, 2018
(86) PCT No.: PCT/GB2018/052503

§ 371 Date: Mar. 4, 2020

(30) Foreign Application Priority Data
Sep. 5, 2017 (GB) 1714267.0

(51) Int. Cl. C07F 7/28; C08F 110/02

(52) U.S. Cl. CPC C07F 7/28; C08F 110/02

(57) ABSTRACT

A process for the polymerisation of olefins is provided, which uses a Group IV transition metal catalyst.

The present invention relates to the use of catalytic compounds in the polymerisation of olefins. More particularly, the present invention relates to the use of catalytic compounds in the homopolymerisation or copolymerisation of olefins (e.g. ethene).

### BACKGROUND OF THE INVENTION

It is well known that ethylene (and α-olefins in general) can be readily polymerized at low or medium pressures in the presence of certain transition metal catalysts. These catalysts are generally known as Zeigler-Natta type catalysts.

A particular group of these Ziegler-Natta type catalysts, which catalyse the polymerization of ethylene (and α-olefins in general), comprise an aluminoxane activator and a metallocene transition metal catalyst. Metallocenes comprise a metal bound between two η⁵-cyclopentadienyl type ligands. Generally the η⁵-cyclopentadienyl type ligands are selected from η⁵-cyclopentadienyl, η⁵-indenyl and η⁵-fluorenyl.

The advent of constrained geometry complexes (CGCs) represented one of the first major departures from metallocene-based catalysts. In structural terms, CGCs feature a π-bonded ligand linked to one of the other ligands on the same metal centre, in such a manner that the angle subtended by the centroid of the 7-system and the other ligand from the metal centre is smaller than in comparable complexes wherein the 7-bonded ligand and the other ligand are not linked. To date, research in the field of CGCs has centred around ansa-bridged cyclopentadienyl amido complexes, with such catalysts presently featuring heavily in the industrial preparation of CGC-derived polymers.

In spite of the advances made by metallocene and CGC complexes, there remains a need for new non-metallocene catalysts capable of effectively polymerizing olefins.

The present invention was devised with the foregoing in mind.

### SUMMARY OF THE INVENTION

According to a first aspect of the present invention there is provided a process for the polymerisation of at least one olefin, the process comprising the step of contacting the at least one olefin with a compound having a structure according to formula (I-A), (I-B) or (I-C) defined herein.

According to a second aspect of the present invention there is provided a use of a compound having a structure according to formula (I-A), (I-B) or (I-C) defined herein in the polymerisation of at least one olefin.

### DETAILED DESCRIPTION OF THE INVENTION

### Definitions

The term “(m-nC)” or “(m-nC) group” used alone or as a prefix, refers to any group having m to n carbon atoms.

The term “alkyl” as used herein refers to straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tert-butyl), pentyl, hexyl and the like. In particular, an alkyl may have 1, 2, 3 or 4 carbon atoms.

The term “alkenyl” as used herein refers to straight or branched chain alkenyl moieties, typically having 1, 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “alkynyl” as used herein refers to straight or branched chain alkynyl moieties, typically having 1, 2, 3, 4, 5 or 6 carbon atoms. The term includes reference to alkynyl moieties containing 1, 2 or 3 carbon-carbon triple bonds (C═C). This term includes reference to groups such as ethynyl, propynyl, butynyl, pentynyl and hexynyl.

The term “haloalkyl” as used herein refers to alkyl groups being substituted with one or more halogens (e.g. F, Cl, Br or I). This term includes reference to groups such as 2-fluoropropyl, 3-chloropentyl, as well as perfluoroalkyl groups, such as perfluoromethyl.

The term “alkoxy” as used herein refers to —O-alkyl, wherein alkyl is straight or branched chain and comprises 1, 2, 3, 4, 5 or 6 carbon atoms. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “dialkylamino” as used herein means a group —N(R_{A})(R_{B}), wherein R_{A} and R_{B} are alkyl groups.

The term “aryl” or “aromatic” as used herein means an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like. Unless otherwise specification, aryl groups may be substituted by one or more substituents. A particularly suitable aryl group is phenyl.

The term “aryloxy” as used herein refers to —O-aryl, wherein aryl has any of the definitions discussed herein. Also encompassed by this term are aryloxy groups in having an alkylene chain situated between the 0 and aryl groups.

The term “heteroaryl” or “heteroaromatic” means an aromatic mono-, bi-, or polycyclic ring incorporating one or more (for example 1-4, particularly 1, 2 or 3) heteroatoms selected from nitrogen, oxygen or sulfur. Examples of heteroaryl groups are monocyclic and bicyclic groups containing from five to twelve ring members, and more usually from five to ten ring members. The heteroaryl group can be, for example, a 5- or 6-membered monocyclic ring or a 9- or 10-membered bicyclic ring, for example a bicyclic structure formed from fused five and six membered rings or two fused six membered rings. Each ring may contain up to about four heteroatoms typically selected from nitrogen, sulfur and oxygen. Typically the heteroaryl ring will contain up to 3 heteroatoms, more usually up to 2, for example a single heteroatom.

The term “heteroaryloxy” as used herein refers to —O-heteroaryl, wherein heteroaryl has any of the definitions discussed herein. Also encompassed by this term are heteroaryloxy groups in having an alkylene chain situated between the 0 and heteroaryl groups.

The term “carbocyclyl”, “carbocyclic” or “carbocycle” means a non-aromatic saturated or partially saturated monocyclic, or a fused, bridged, or spiro bicyclic carbocyclic ring system(s). Monocyclic carbocyclic rings contain from about 3 to 12 (suitably from 3 to 7) ring atoms. Bicyclic carbocycles contain from 7 to 17 carbon atoms in the rings, suitably 7 to 12 carbon atoms, in the rings. Bicyclic carbocyclic rings may be fused, spiro, or bridged ring systems. A particularly suitable carbocyclic group is adamantyl.

The term “heterocyclyl”, “heterocyclic” or “heterocycle” means a non-aromatic saturated or partially saturated monocyclic, fused, bridged, or spiro bicyclic heterocyclic ring system(s). Monocyclic heterocyclic rings contain from about 3 to 12 (suitably from 3 to 7) ring atoms, with from 1 to 5 (suitably 1, 2 or 3) heteroatoms selected from nitrogen, oxygen or sulfur in the ring. Bicyclic heterocycles contain from 7 to 17 member atoms, suitably 7 to 12 member atoms, in the ring. Bicyclic heterocyclic(s) rings may be fused, spiro, or bridged ring systems.

The term “halogen” or “halo” as used herein refers to F, Cl, Br or I. In a particular, halogen may be F or CI, of which CI is more common.

The term “substituted” as used herein in reference to a moiety means that one or more, especially up to 5, more especially 1, 2 or 3, of the hydrogen atoms in said moiety are replaced independently of each other by the corresponding number of the described substituents. The term “optionally substituted” as used herein means substituted or unsubstituted.

It will, of course, be understood that substituents are only at positions where they are chemically possible, the person skilled in the art being able to decide (either experimentally or theoretically) without inappropriate effort whether a particular substitution is possible.

### Polymerisation of Olefins

According to a first aspect of the present invention there is provided a process for the polymerisation of at least one olefin, the process comprising the step of contacting the at least one olefin with a compound having a structure according to formula (I-A), (I-B) or (I-C) shown below:

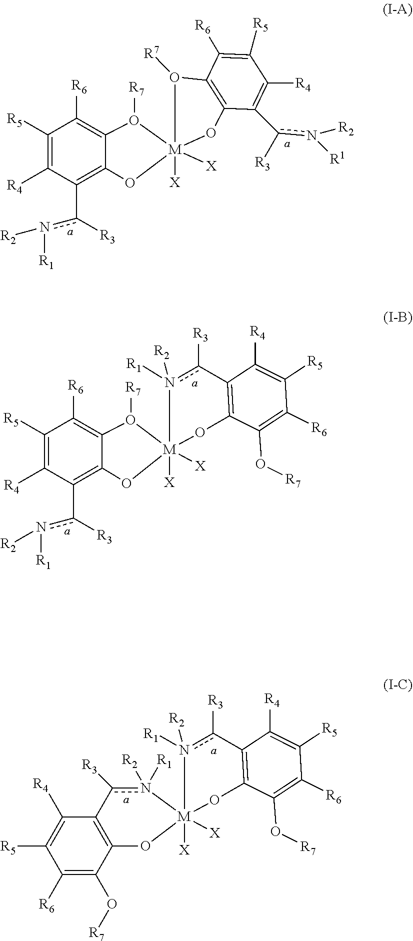

wherein
M is a Group IV transition metal,
each X is independently selected from halo, hydrogen, a phosphonate, sulfonate or boronate group, (1-4C)dialkylamino, (1-6C)alkyl, (1-6C)alkoxy, aryl, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃,
R₂ is absent or is selected from hydrogen, halo, oxo, hydroxy, amino, nitro, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
bond a is a carbon-nitrogen single bond (C—N) or a carbon-nitrogen double bond (C═N), with the proviso that when R₂ is absent, bond a is a carbon-nitrogen double bond (C═N), and when R₂ is other than absent, bond a is a carbon-nitrogen single bond (C—N),
R₃, R₄, R₅ and R₆ are each independently selected from hydrogen, halo, oxo, hydroxy, amino, nitro, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
R₇ is selected from (1-6C)alkyl, (2-6C)alkenyl, (2-6C)alkynyl, (1-6C)haloalkyl, aryl, heteroaryl, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
R₁ is a group having the formula (II) shown below:

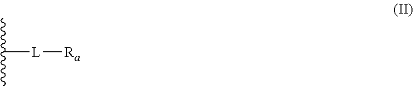

wherein
   Rₐ is selected from (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (2-6C)alkenyl, (2-6C)alkynyl, (1-6C)haloalkyl, aryl, aryloxy, heteroaryl, heteroaryloxy, carbocyclyl and heterocyclyl,
   L is a group —[C(Rₓ)₂]ₙ—
      wherein
         each Rₓ is independently selected from hydrogen, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and aryl, and
         n is 0, 1, 2, 3 or 4.

Through detailed investigations, the inventors have discovered that a new family of Group IV transition metal-based catalysts are capable of catalysing the polymerisation of olefins (e.g. ethene). The use of this new family of catalysts in the polymerisation of olefins represents a significant departure from the use of metallocene and CGC catalytic complexes favoured by industry.

The new family of catalysts encompasses three different coordination chemistry, embodied by formulae (I-A), (I-B) and (I-C). As depicted below, in formula (I-A), both bidentate phenyl-containing ligands are bound to M via two oxygen atoms (O,O:O,O coordination), thereby forming two 5-membered rings. In formula (I-B), one of the phenyl-containing ligands is bound to M via two oxygen atoms, whereas the other phenyl-containing ligand is bound to M via one oxygen atom and one nitrogen atom (O,O:N,O coordination), thereby forming one 5-membered ring and one 6-membered ring. In formula (I-C), both bidentate phenyl-containing ligands are bound to M via one oxygen atom and one nitrogen atom (N,O:N,O coordination), thereby forming two 6-membered rings.

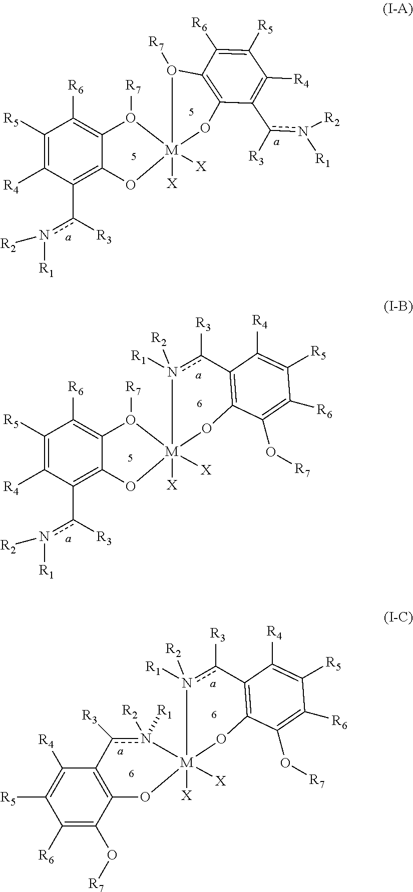

It will be appreciated that the compounds of formulae (I-A), (I-B) and (I-C) may exist in a number of structurally isomeric forms. For example, compounds of formula (I-C) may exist in either of the following structural isomeric forms:

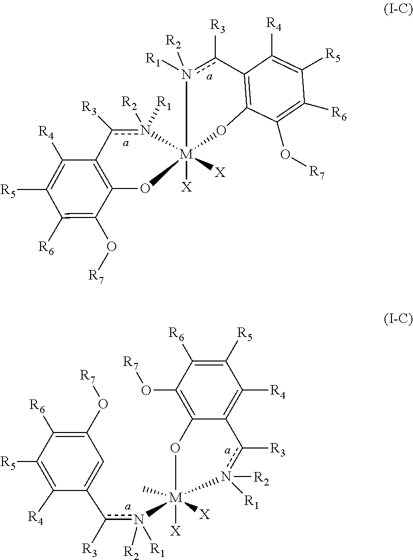

In an embodiment, the compound of formula (I-A), (I-B) or (I-C) has a structure according to formula (I-A) or (I-B). The particular coordination type depicted in formulae (I-A) and (I-B) is preferred.

In an embodiment, the compound of formula (I-A), (I-B) or (I-C) has a structure according to formula (I-A). The particular coordination type depicted in formula (I-A) is most preferred.

In an embodiment, the compound of formula (I-A), (I-B) or (I-C) has a structure according to formula (I-B).

In an embodiment, the compound of formula (I-A), (I-B) or (I-C) has a structure according to formula (I-C).

In an embodiment, the compound has a structure according to formula (I-A), (I-B) or (I-C), wherein
M is a Group IV transition metal,
each X is independently selected from halo, hydrogen, a phosphonate, sulfonate or boronate group, (1-6C)alkyl, (1-6C)alkoxy, aryl, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃,
R₂ is absent or is selected from hydrogen, halo, oxo, hydroxy, amino, nitro, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
bond a is a carbon-nitrogen single bond (C—N) or a carbon-nitrogen double bond (C═N), with the proviso that when R₂ is absent, bond a is a carbon-nitrogen double bond (C═N), and when R₂ is other than absent, bond a is a carbon-nitrogen single bond (C—N),
R₃, R₄, R₅ and R₆ are each independently selected from hydrogen, halo, oxo, hydroxy, amino, nitro, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
R₇ is selected from (1-6C)alkyl, (2-6C)alkenyl, (2-6C)alkynyl, (1-6C)haloalkyl, aryl, heteroaryl, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
R₁ is a group having the formula (II) shown below:

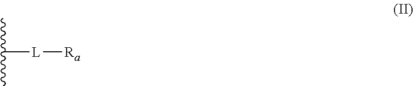

wherein
   Rₐ is selected from (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (2-6C)alkenyl, (2-6C)alkynyl, (1-6C)haloalkyl, aryl, aryloxy, heteroaryl, heteroaryloxy, carbocyclyl and heterocyclyl,
   L is a group —[C(Rₓ)₂]ₙ—
      wherein
         each Rₓ is independently selected from hydrogen, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and aryl, and
         n is 0, 1, 2, 3 or 4.

In an embodiment, M is selected from titanium, zirconium and hafnium. Suitably, M is selected from titanium and zirconium. More suitably, M is titanium.

In an embodiment, each X is independently selected from halo, hydrogen, (1-4C)dialkylamino, (1-6C)alkoxy, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃.

In an embodiment, each X is independently selected from halo, hydrogen, (1-6C)alkoxy, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃.

In an embodiment, each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl.

In an embodiment, each X is independently selected from halo, hydrogen, (1-4C)alkoxy, and phenoxy, any of which may be optionally substituted one of more groups selected from halo, oxo, hydroxy, amino, nitro, (1-4C)alkyl, (1-4C)haloalkyl, (1-4C)alkoxy and phenyl.

In an embodiment, each X is independently selected from halo, hydrogen, —N(CH₃)₂, —N(CH₂CH₃)₂ and (1-4C)alkoxy, any of which may be optionally substituted one of more groups selected from halo, hydroxy, amino, (1-4C)alkyl and (1-4C)alkoxy.

In an embodiment, each X is independently selected from halo, hydrogen, and (1-4C)alkoxy, any of which may be optionally substituted one of more groups selected from halo, hydroxy, amino, (1-4C)alkyl and (1-4C)alkoxy.

In an embodiment, each X is independently selected from chloro, bromo, —N(CH₃)₂, —N(CH₂CH₃)₂ and (1-4C)alkoxy.

In an embodiment, each X is independently selected from chloro, bromo and (1-4C)alkoxy.

In an embodiment, each X is independently (1-4C)alkoxy.

In an embodiment, each X is isopropoxy.

In an embodiment, each X is independently (1-4C)dialkylamino. Suitably, X is independently —N(CH₃)₂ or —N(CH₂CH₃)₂.

In an embodiment, R₂ is absent or is selected from hydrogen, hydroxy, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-4C)alkyl, (1-4C)haloalkyl and (1-4C)alkoxy.

In an embodiment, R₂ is absent or is selected from hydrogen, hydroxy, (1-4C)alkyl, (2-4C)alkenyl, (2-4C)alkynyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy.

In an embodiment, R₂ is absent or is selected from hydrogen, (1-4C)alkyl, (2-4C)alkenyl, (2-4C)alkynyl and aryl, any of which may be optionally substituted with one or more substituents selected from halo, hydroxy, amino, (1-4C)alkyl and (1-4C)alkoxy.

In an embodiment, R₂ is absent or is selected from hydrogen, (1-4C)alkyl and phenyl, any of which may be optionally substituted with one or more substituents selected from halo, hydroxy, amino, (1-4C)alkyl and (1-4C)alkoxy.

In an embodiment, R₂ is absent or is selected from hydrogen, (1-4C)alkyl and phenyl.

In an embodiment, R₂ is absent or is selected from hydrogen and (1-4C)alkyl.

In an embodiment, R₂ is absent or hydrogen.

In an embodiment, R₂ is absent.

In an embodiment, R₂ is hydrogen.

In an embodiment, bond a is a carbon-nitrogen double bond (C═N).

In an embodiment, R₃, R₄, R₅ and R₆ are each independently selected from hydrogen, halo, oxo, hydroxy, amino, nitro, (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-4C)alkyl, (2-4C)alkenyl, (2-4C)alkynyl, (1-4C)haloalkyl and (1-4C)alkoxy.

In an embodiment, R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy.

In an embodiment, R₃, R₄, R₅ and R₆ are each independently selected from hydrogen, halo, amino, nitro, (1-4C)alkyl, (1-4C)haloalkyl, (1-4C)alkoxy, aryl and heteroaryl, any of which may be optionally substituted with one or more substituents selected from halo and (1-4C)alkyl.

In an embodiment, R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl.

In an embodiment, R₃, R₄, R₅ and R₆ are each independently selected from hydrogen, halo, amino, (1-4C)alkyl and phenyl, any of which may be optionally substituted with one or more substituents selected from halo and (1-4C)alkyl.

In an embodiment, R₃, R₄, R₅ and R₆ are each independently selected from hydrogen, (1-4C)alkyl and phenyl.

In an embodiment, R₃ is hydrogen.

In an embodiment, R₃, R₄, R₅ and R₆ are hydrogen.

In an embodiment, R₇ is selected from (1-6C)alkyl, (2-6C)alkenyl, (2-6C)alkynyl, (1-6C)haloalkyl, aryl and heteroaryl, any of which may be optionally substituted with one or more substituents selected from halo, oxo, hydroxy, amino, nitro, (1-6C)alkyl, (1-6C)haloalkyl and (1-6C)alkoxy.

In an embodiment, R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy.

In an embodiment, R₇ is selected from (1-4C)alkyl, (1-4C)haloalkyl, aryl and heteroaryl, any of which may be optionally substituted with one or more substituents selected from halo, hydroxy, amino, (1-4C)alkyl and (1-4C)alkoxy.

In an embodiment, R₇ is selected from (1-4C)alkyl and aryl, any of which may be optionally substituted with one or more substituents selected from halo, hydroxy, amino, (1-4C)alkyl and (1-4C)alkoxy.

In an embodiment, R₇ is selected from (1-2C)alkyl and phenyl, any of which may be optionally substituted with one or more substituents selected from halo, hydroxy, amino and (1-4C)alkyl. Suitably, the one or more optional substituents is halo (e.g. fluoro).

In an embodiment, R₇ is (1-2C)alkyl, optionally substituted with one or more substituents selected from halo.

In an embodiment, R₇ is (1-2C)alkyl.

In an embodiment, R₇ is methyl, optionally substituted with one or more fluoro substituents.

In an embodiment, R₇ is methyl or trifluoromethyl.

In a particularly suitable embodiment, R₇ is methyl.

In an embodiment, Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (2-6C)alkenyl, (2-6C)alkynyl, (1-6C)haloalkyl, aryl, aryloxy, heteroaryl, heteroaryloxy, carbocyclyl and heterocyclyl.

In an embodiment, Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy.

In an embodiment, Rₐ is selected from (1-4C)alkyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy.

In an embodiment, Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy.

In an embodiment, Rₐ is selected from phenyl, phenoxy, 5-7 membered heteroaryl, 5-7 membered heteroaryloxy, 5-12 membered carbocyclyl and 5-12 membered heterocyclyl, any of which (for example the phenyl group) may be optionally substituted with one or more substituents selected from halo, oxo, hydroxy, amino, nitro, (1-5C)alkyl, (1-5C)haloalkyl, phenyl, phenoxy, heteroaryl and heteroaryloxy.

In an embodiment, Rₐ is selected from phenyl, 5-7 membered heteroaryl and 5-12 membered carbocyclyl, any of which (for example the phenyl group) may be optionally substituted with one or more substituents selected from halo, oxo, hydroxy, amino, nitro, (1-5C)alkyl, (1-5C)haloalkyl, phenyl, and heteroaryl.

In an embodiment, Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl.

In an embodiment, Rₐ is selected from phenyl, cyclohexyl and adamantyl, any of which (for example the phenyl group) may be optionally substituted with one or more substituents selected from halo, (1-5C)alkyl, phenyl, and heteroaryl.

In an embodiment, Rₐ is not unsubstituted phenyl or unsubstituted cyclohexyl.

In an embodiment, Rₐ is not unsubstituted phenyl.

In an embodiment, Rₐ is not unsubstituted cyclohexyl.

In an embodiment, Rₓ is independently selected from hydrogen, (1-6C)alkyl, (1-6C)alkoxy and aryl, any of which may be optionally substituted with one or more substituents selected from halo, oxo, hydroxy, amino, nitro, (1-6C)alkyl and (1-6C)haloalkyl.

In an embodiment, Rₓ is independently selected from hydrogen, (1-4C)alkyl, (1-4C)alkoxy and phenyl, any of which may be optionally substituted with one or more substituents selected from halo, amino and (1-6C)alkyl.

In an embodiment, Rₓ is independently selected from hydrogen, (1-4C)alkyl, and phenyl, any of which may be optionally substituted with one or more substituents selected from halo, amino and (1-3C)alkyl.

In an embodiment, each Rₓ is phenyl.

In an embodiment, n is 0, 1 or 2.

In an embodiment, n is 0 or 1.

In an embodiment, n is 0 (in which case Rₐ is bonded directly to N).

In an embodiment, the compound of formula (I-A), (I-B) or (I-C) has a structure according to formula (I-A), (I-B) or (I-C), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound of formula (I-A), (I-B) or (I-C) has a structure according to formula (I-A), (I-B) or (I-C), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₇ is selected from (1-4C)alkyl and aryl, any of which may be optionally substituted with one or more substituents selected from halo, hydroxy, amino, (1-4C)alkyl and (1-4C)alkoxy;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A), (I-B) or (I-C), wherein

M is selected from titanium and zirconium;
each X is independently selected from chloro, bromo and (1-4C)alkoxy;
R₂ is absent or is selected from hydrogen and (1-4C)alkyl;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A), (I-B) or (I-C), wherein

M is titanium;
each X is independently (1-4C)alkoxy;
R₂ is absent;
R₃, R₄, R₅ and R₆ are each independently selected from hydrogen, (1-4C)alkyl and phenyl;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound of formula (I-A), (I-B) or (I-C) has a structure according to formula (I-A-1), (I-B-1) or (I-C-1) shown below:

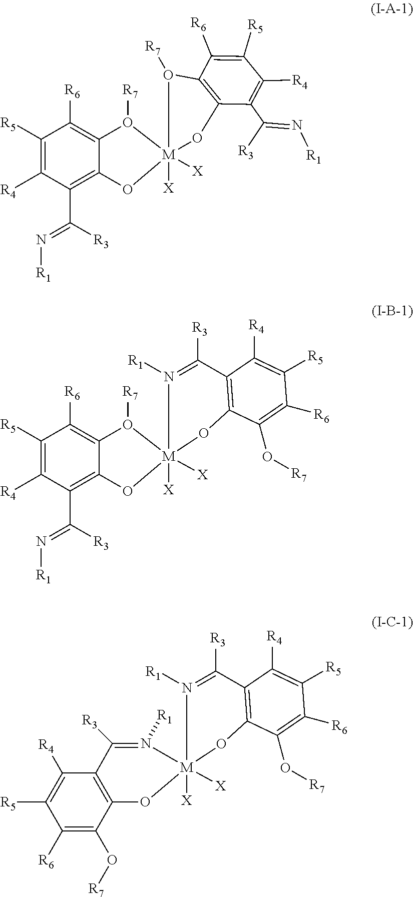

wherein M, X, R₁ and R₃-R₇ have any of the definitions discussed hereinbefore in respect of formulae (I-A), (I-B) and (I-C).

In an embodiment, the compound having a structure according to formula (I-A-1), (I-B-1) or (I-C-1) has a structure according to formula (I-A-1) or (I-B-1).

In an embodiment, the compound having a structure according to formula (I-A-1), (I-B-1) or (I-C-1) has a structure according to formula (I-A-1).

In an embodiment, the compound having a structure according to formula (I-A-1), (I-B-1) or (I-C-1) has a structure according to formula (I-B-1).

In an embodiment, the compound having a structure according to formula (I-A-1), (I-B-1) or (I-C-1) has a structure according to formula (I-C-1).

In an embodiment, the compound of formula (I-A), (I-B) or (I-C) has a structure according to formula (I-A-1), (I-B-1) or (I-C-1), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound of formula (I-A), (I-B) or (I-C) has a structure according to formula (I-A-1), (I-B-1) or (I-C-1), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₇ is selected from (1-4C)alkyl and aryl, any of which may be optionally substituted with one or more substituents selected from halo, hydroxy, amino, (1-4C)alkyl and (1-4C)alkoxy;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A-1), (I-B-1) or (I-C-1), wherein

M is selected from titanium and zirconium;
each X is independently selected from chloro, bromo and (1-4C)alkoxy;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A-1), (I-B-1) or (I-C-1), wherein

M is titanium;
each X is independently (1-4C)alkoxy;
R₃, R₄, R₅ and R₆ are each independently selected from hydrogen, (1-4C)alkyl and phenyl;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound of formula (I-A), (I-B) or (I-C) has a structure according to formula (I-A-2), (I-B-2) or (I-C-2) shown below:

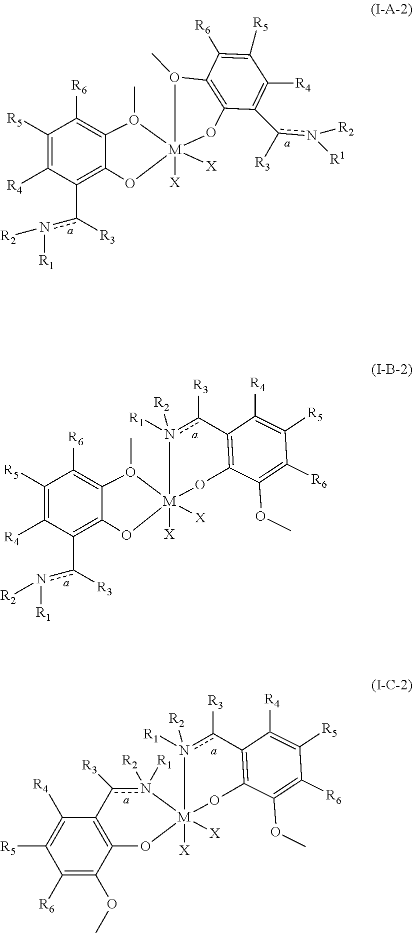

wherein M, X and R₁-R₆ have any of the definitions discussed hereinbefore in respect of formulae (I-A), (I-B) and (I-C).

In an embodiment, the compound having a structure according to formula (I-A-2), (I-B-2) or (I-C-2) has a structure according to formula (I-A-2) or (I-B-2).

In an embodiment, the compound having a structure according to formula (I-A-2), (I-B-2) or (I-C-2) has a structure according to formula (I-A-2).

In an embodiment, the compound having a structure according to formula (I-A-2), (I-B-2) or (I-C-2) has a structure according to formula (I-B-2).

In an embodiment, the compound having a structure according to formula (I-A-2), (I-B-2) or (I-C-2) has a structure according to formula (I-C-2).

In an embodiment, the compound of formula (I-A), (I-B) or (I-C) has a structure according to formula (I-A-2), (I-B-2) or (I-C-2), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound of formula (I-A), (I-B) or (I-C) has a structure according to formula (I-A-2), (I-B-2) or (I-C-2), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A-2), (I-B-2) or (I-C-2), wherein

M is selected from titanium and zirconium;
each X is independently selected from chloro, bromo and (1-4C)alkoxy;
R₂ is absent or hydrogen;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A-2), (I-B-2) or (I-C-2), wherein

M is titanium;
each X is independently (1-4C)alkoxy;
R₂ is absent or hydrogen;
R₃, R₄, R₅ and R₆ are each independently selected from hydrogen, (1-4C)alkyl and phenyl;
R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-2), (I-B-2) or (1-C-2), wherein

M is selected from titanium and zirconium;
each X is independently selected from chloro, bromo and (1-4C)alkoxy;
R₂ is absent;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-2), (I-B-2) or (1-C-2), wherein

M is titanium;
each X is independently (1-4C)alkoxy;
R₂ is absent or hydrogen;
R₃, R₄, R₅ and R₆ are each independently selected from hydrogen, (1-4C)alkyl and phenyl;
R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound of formula (I-A), (I-B) or (I-C) has a structure according to formula (I-A-3), (I-B-3) or (I-C-3) shown below:

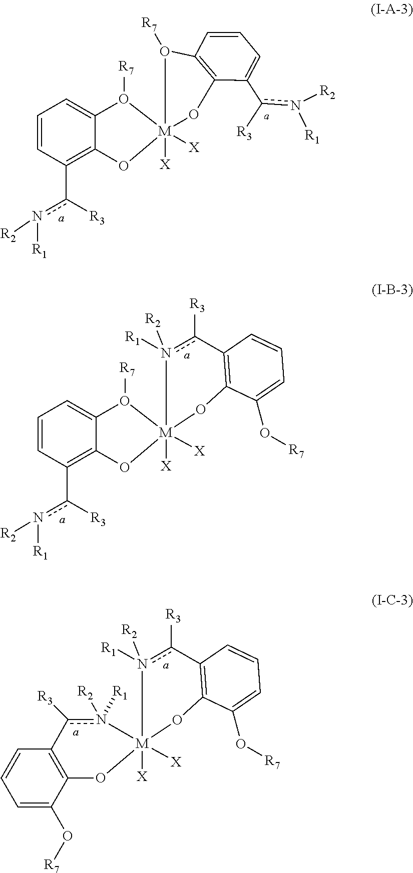

wherein M, X, R₁-R₃ and R₇ have any of the definitions discussed hereinbefore in respect of formulae (I-A), (I-B) and (I-C).

In an embodiment, the compound having a structure according to formula (I-A-3), (I-B-3) or (I-C-3) has a structure according to formula (I-A-3) or (I-B-3).

In an embodiment, the compound having a structure according to formula (I-A-3), (I-B-3) or (I-C-3) has a structure according to formula (I-A-3).

In an embodiment, the compound having a structure according to formula (I-A-3), (I-B-3) or (I-C-3) has a structure according to formula (I-B-3).

In an embodiment, the compound having a structure according to formula (I-A-3), (I-B-3) or (I-C-3) has a structure according to formula (I-C-3).

In an embodiment, the compound of formula (I-A), (I-B) or (I-C) has a structure according to formula (I-A-3), (I-B-3) or (I-C-3), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound of formula (I-A), (I-B) or (I-C) has a structure according to formula (I-A-3), (I-B-3) or (I-C-3), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A-3), (I-B-3) or (I-C-3), wherein

M is selected from titanium and zirconium;
each X is independently selected from chloro, bromo and (1-4C)alkoxy;
R₂ is absent or hydrogen;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-3), (I-B-3) or (1-C-3), wherein

M is selected from titanium and zirconium;
each X is independently selected from chloro, bromo and (1-4C)alkoxy;
R₂ is absent;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A-3), (I-B-3) or (I-C-3), wherein

M is titanium;
each X is independently (1-4C)alkoxy;
R₂ is absent or hydrogen;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-3), (I-B-3) or (1-C-3), wherein

M is titanium;
each X is independently (1-4C)alkoxy;
R₂ is absent;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound of formula (I-A), (I-B) or (I-C) has a structure according to formula (I-A) or (I-B), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound of formula (I-A), (I-B) or (I-C) has a structure according to formula (I-A) or (I-B), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₇ is selected from (1-4C)alkyl and aryl, any of which may be optionally substituted with one or more substituents selected from halo, hydroxy, amino, (1-4C)alkyl and (1-4C)alkoxy;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A) or (I-B), wherein

M is selected from titanium and zirconium;
each X is independently selected from chloro, bromo and (1-4C)alkoxy;
R₂ is absent or is selected from hydrogen and (1-4C)alkyl;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A) or (I-B), wherein

M is titanium;
each X is independently (1-4C)alkoxy;
R₂ is absent;
R₃, R₄, R₅ and R₆ are each independently selected from hydrogen, (1-4C)alkyl and phenyl;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A) or (I-B), wherein

M is selected from titanium, zirconium and hafnium;
each X is independently selected from halo, hydrogen, (1-6C)alkoxy, (1-4C)dialkylamino and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A) or (I-B), wherein

M is selected from titanium and zirconium;
each X is independently selected from halo, hydrogen, (1-4C)dialkylamino and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₇ is selected from (1-4C)alkyl and aryl, any of which may be optionally substituted with one or more substituents selected from halo, hydroxy, amino, (1-4C)alkyl and (1-4C)alkoxy;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A) or (I-B), wherein

M is selected from titanium and zirconium;
each X is independently selected from chloro, bromo, (1-2C)dialkylamino and (1-4C)alkoxy;
R₂ is absent or is selected from hydrogen and (1-4C)alkyl;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A) or (I-B), wherein

M is titanium;
each X is independently (1-2C)dialkylamino or (1-4C)alkoxy;
R₂ is absent;
R₃, R₄, R₅ and R₆ are each independently selected from hydrogen, (1-4C)alkyl and phenyl;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound of formula (I-A), (I-B) or (I-C) has a structure according to formula (I-A-1) or (I-B-1), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound of formula (I-A), (I-B) or (I-C) has a structure according to formula (I-A-1) or (I-B-1), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₇ is selected from (1-4C)alkyl and aryl, any of which may be optionally substituted with one or more substituents selected from halo, hydroxy, amino, (1-4C)alkyl and (1-4C)alkoxy;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A-1) or (I-B-1), wherein

M is selected from titanium and zirconium;
each X is independently selected from chloro, bromo and (1-4C)alkoxy;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A-1) or (I-B-1), wherein

M is titanium;
each X is independently (1-4C)alkoxy;
R₃, R₄, R₅ and R₆ are each independently selected from hydrogen, (1-4C)alkyl and phenyl;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-1) or (I-B-1), wherein

M is selected from titanium, zirconium and hafnium;
each X is independently selected from halo, hydrogen, (1-6C)alkoxy, (1-4C)dialkylamino and aryloxy, any of which may be optionally substituted one of more groups selected from halo, oxo, hydroxy, amino, nitro, (1-6C)alkyl, (1-6C)haloalkyl, (1-6C)alkoxy and aryl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A-1) or (I-B-1), wherein

M is selected from titanium and zirconium;
each X is independently selected from halo, hydrogen, (1-4C)dialkylamino and (1-4C)alkoxy, any of which may be optionally substituted one of more groups selected from halo, hydroxy, amino, (1-4C)alkyl and (1-4C)alkoxy;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₇ is selected from (1-4C)alkyl and aryl, any of which may be optionally substituted with one or more substituents selected from halo, hydroxy, amino, (1-4C)alkyl and (1-4C)alkoxy;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-1) or (I-B-1), wherein

M is selected from titanium and zirconium;
each X is independently selected from chloro, bromo, (1-2C)dialkylamino and (1-4C)alkoxy;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-1) or (I-B-1), wherein

M is titanium;
each X is independently (1-2C)dialkylamino or (1-4C)alkoxy;
R₃, R₄, R₅ and R₆ are each independently selected from hydrogen, (1-4C)alkyl and phenyl;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound of formula (I-A), (I-B) or (I-C) has a structure according to formula (I-A-2) or (I-B-2), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound of formula (I-A), (I-B) or (I-C) has a structure according to formula (I-A-2) or (I-B-2), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A-2) or (I-B-2), wherein

M is selected from titanium and zirconium;
each X is independently selected from chloro, bromo and (1-4C)alkoxy;
R₂ is absent;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A-2) or (I-B-2), wherein

M is titanium;
each X is independently (1-4C)alkoxy;
R₂ is absent;
R₃, R₄, R₅ and R₆ are each independently selected from hydrogen, (1-4C)alkyl and phenyl;
R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-2) or (I-B-2), wherein

M is selected from titanium, zirconium and hafnium;
each X is independently selected from halo, hydrogen, (1-6C)alkoxy, (1-4C)dialkylamino and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A-2) or (I-B-2), wherein

M is selected from titanium and zirconium;
each X is independently selected from halo, hydrogen, (1-4C)dialkylamino and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₃, R₄, R₅ and R₆ are each independently selected from hydrogen, halo, amino, (1-4C)alkyl, (1-4C)haloalkyl, (1-4C)alkoxy and phenyl, any of which may be optionally substituted with one or more substituents selected from halo and (1-4C)alkyl;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-2) or (I-B-2), wherein

M is selected from titanium and zirconium;
each X is independently selected from chloro, bromo, (1-2C)dialkylamino and (1-4C)alkoxy;
R₂ is absent;
R₃, R₄, R₅ and R₆ are each independently selected from hydrogen, halo, amino, (1-4C)alkyl and phenyl, any of which may be optionally substituted with one or more substituents selected from halo and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-2) or (I-B-2), wherein

M is titanium;
each X is independently (1-2C)dialkylamino or (1-4C)alkoxy;
R₂ is absent;
R₃, R₄, R₅ and R₆ are each independently selected from hydrogen, (1-4C)alkyl and phenyl;
R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound of formula (I-A), (I-B) or (I-C) has a structure according to formula (I-A-3) or (I-B-3), wherein

M is selected from titanium, zirconium and hafnium;
each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound of formula (I-A), (I-B) or (I-C) has a structure according to formula (I-A-3) or (I-B-3), wherein

M is selected from titanium and zirconium;
each X is independently selected from halo, hydrogen, and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A-3) or (I-B-3), wherein

M is selected from titanium and zirconium;
each X is independently selected from chloro, bromo and (1-4C)alkoxy;
R₂ is absent;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound of formula (I-A), (I-B) or (I-C) has a structure according to formula (I-A-3) or (I-B-3), wherein

M is titanium;
each X is independently (1-4C)alkoxy;
R₂ is absent;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-3) or (I-B-3), wherein

M is selected from titanium, zirconium and hafnium;
each X is independently selected from halo, hydrogen, (1-6C)alkoxy, (1-4C)dialkylamino and aryloxy, any of which may be optionally substituted one of more groups selected from halo, oxo, hydroxy, amino, nitro, (1-6C)alkyl, (1-6C)haloalkyl, (1-6C)alkoxy and aryl;
R₂ is absent or is selected from hydrogen, (1-4C)alkyl and phenyl;
R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy;
R₁ is a group of formula (II) defined herein, wherein
Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, (1-4C)alkoxy and phenyl, any of which may be optionally substituted with one or more substituents selected from halo, amino and (1-6C)alkyl; and
n is 0, 1 or 2.

In an embodiment, the compound has a structure according to formula (I-A-3) or (I-B-3), wherein

M is selected from titanium and zirconium;
each X is independently selected from halo, hydrogen, (1-4C)dialkylamino and (1-4C)alkoxy, any of which may be optionally substituted one of more groups selected from halo, hydroxy, amino, (1-4C)alkyl and (1-4C)alkoxy;
R₂ is absent or is selected from hydrogen, (1-4C)alkyl and phenyl;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)alkoxy, (1-6C)haloalkyl, aryl, aryloxy, heteroaryl and heteroaryloxy;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-3) or (I-B-3), wherein

M is selected from titanium and zirconium;
each X is independently selected from chloro, bromo, (1-2C)dialkylamino and (1-4C)alkoxy;
R₂ is absent;
R₇ is selected from (1-2C)alkyl and phenyl, any of which may be optionally substituted with one or more substituents selected from halo, hydroxy, amino and (1-4C)alkyl;
R₁ is a group of formula (II) defined herein, wherein
Rₐ is selected from phenyl and 5-12 membered carbocyclyl, any of which (for example the phenyl group) may be optionally substituted with one or more substituents selected from halo, hydroxy, amino, (1-5C)alkyl, (1-3C)alkoxy, (1-5C)haloalkyl, phenyl, and heteroaryl;
Rₓ is independently selected from hydrogen, (1-4C)alkyl, and phenyl, any of which may be optionally substituted with one or more substituents selected from halo, amino and (1-3C)alkyl; and
n is 0 or 1.

In an embodiment, the compound has a structure according to formula (I-A-3) or (I-B-3), wherein

M is titanium;
each X is independently (1-2C)dialkylamino or (1-4C)alkoxy;
R₂ is absent;

### R₇ is (1-2C)alkyl;

R₁ is a group of formula (II) defined herein, wherein
Rₐ is selected from phenyl, cyclohexyl and adamantyl, any of which (for example the phenyl group) may be optionally substituted with one or more substituents selected from halo, (1-5C)alkyl, phenyl, and heteroaryl;
each Rₓ is phenyl; and
n is 0 or 1.

In an embodiment, the compound has a structure according to formula (I-A-4a), (I-B-4a) or (I-C-4a) shown below:

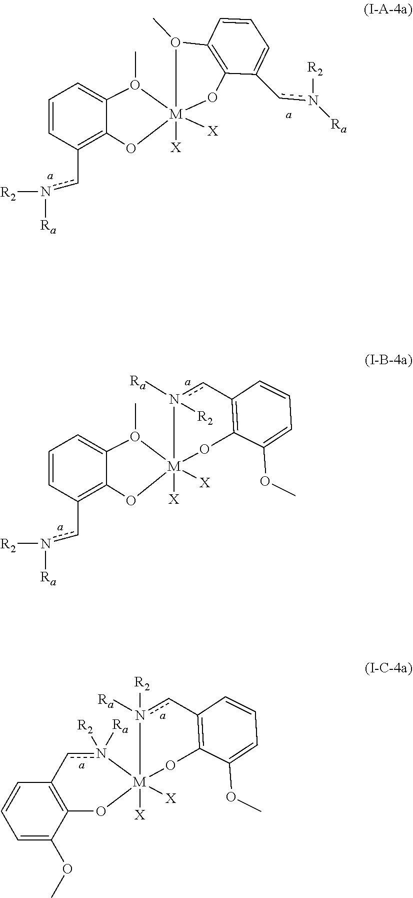

wherein
M is titanium or zirconium,
each X is independently isopropoxide, ethoxide, N(CH₃)₂ or N(CH₂CH₃)₂;
R₂ is absent (in which case bond a is a double bond) or hydrogen (in which case bond a is a single bond); and
Rₐ is selected from perfluorophenyl, cyclohexyl, 2,6-dimethylphenyl, 2,6-diisopropylphenyl, biphenyl, adamantyl, 2,4,6-tritertbutylphenyl and trityl.

In an embodiment, the compound has a structure according to formula (I-A-4a), (I-B-4a) or (I-C-4a), wherein R₂ is absent.

In an embodiment, the compound has a structure according to formula (I-A-4a), (I-B-4a) or (I-C-4a), wherein M is titanium and Rₐ is selected from 2,6-diisopropylphenyl, biphenyl, adamantyl, 2,4,6-tritertbutylphenyl and trityl.

In an embodiment, the compound has a structure according to formula (I-A-4a), (I-B-4a) or (I-C-4a), wherein M is titanium and Rₐ is selected from adamantyl, 2,4,6-tritertbutylphenyl and trityl.

In an embodiment, the compound of formula (I-A), (I-B) or (I-C) has a structure according to formula (I-A-4b), (I-B-4b) or (I-C-4b) shown below:

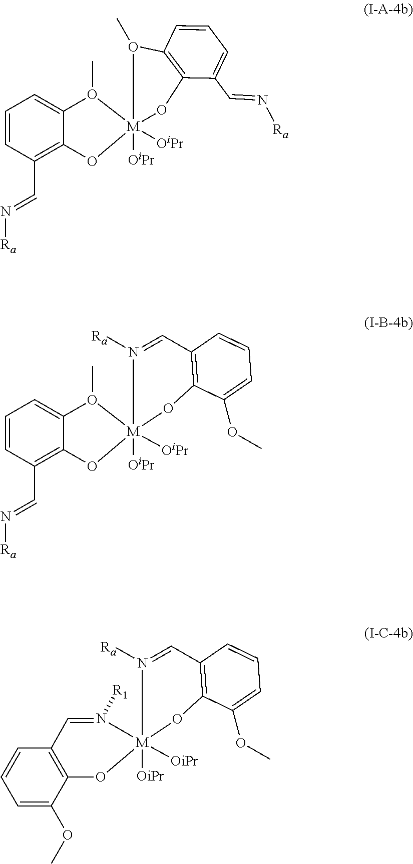

wherein M is titanium or zirconium, and Rₐ is selected from perfluorophenyl, cyclohexyl, 2,6-dimethylphenyl, 2,6-diisopropylphenyl, biphenyl, adamantyl, 2,4,6-tritertbutylphenyl and trityl.

In an embodiment, the compound of formula (I-A), (I-B) or (I-C) has a structure according to formula (I-A-4b), (I-B-4b) or (I-C-4b), wherein M is titanium and Rₐ is selected from 2,6-diisopropylphenyl, biphenyl, adamantyl, 2,4,6-tritertbutylphenyl and trityl.

In an embodiment, the compound of formula (I-A), (I-B) or (I-C) has a structure according to formula (I-A-4b), (I-B-4b) or (I-C-4b), wherein M is titanium and Rₐ is selected from adamantyl, 2,4,6-tritertbutylphenyl and trityl.

In an embodiment, the compound of formula (I-A), (I-B) or (I-C) has a structure according to formula (I-A-4b), (I-B-4b) or (I-C-4b), wherein M is titanium and Rₐ is selected from biphenyl and trityl.

In an embodiment, the compound has a structure according to formula (I-A-4c), (I-B-4c) or (I-C-4c) shown below:

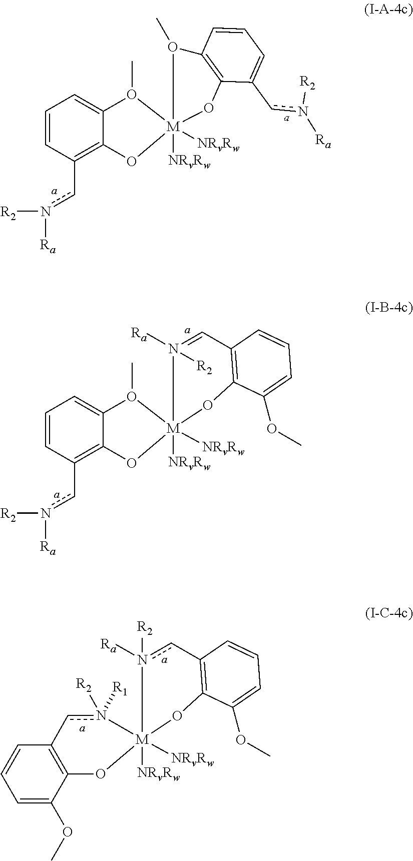

wherein
M is titanium or zirconium,
Rᵥ and R_{w} are each independently methyl or ethyl;
R₂ is absent (in which case bond a is a double bond) or hydrogen (in which case bond a is a single bond); and
Rₐ is selected from perfluorophenyl, cyclohexyl, 2,6-dimethylphenyl, 2,6-diisopropylphenyl, biphenyl, adamantyl, 2,4,6-tritertbutylphenyl and trityl.

In an embodiment, the compound has a structure according to formula (I-A-4c), (I-B-4c) or (I-C-4c), wherein R₂ is absent.

In an embodiment, the compound has a structure according to formula (I-A-4c), (I-B-4c) or (I-C-4c), wherein M is titanium and Rₐ is selected from 2,6-diisopropylphenyl, biphenyl, adamantyl, 2,4,6-tritertbutylphenyl and trityl.

In an embodiment, the compound has a structure according to formula (I-A-4c), (I-B-4c) or (I-C-4c), wherein M is titanium and Rₐ is selected from adamantyl, 2,4,6-tritertbutylphenyl and trityl.

In an embodiment, the compound of formula (I-A), (I-B) or (I-C) has a structure according to formula (I-A-4c), (I-B-4c) or (I-C-4c), wherein M is titanium and Rₐ is selected from 2,6-diisopropylphenyl, biphenyl, adamantyl and trityl.

In an embodiment, the compound of formula (I-A), (I-B) or (I-C) has a structure according to formula (I-A-4c), (I-B-4c) or (I-C-4c), wherein M is titanium and Rₐ is selected from biphenyl and trityl.

In an embodiment, the compound of formula (I-A), (I-B) or (I-C) is immobilised on a supporting substrate. Suitably, the supporting substrate is a solid. It will be appreciated that the compound may be immobilised on the supporting substrate by one or more covalent or ionic interactions, either directly, or via a suitable linking moiety. It will be appreciated that minor structural modifications resulting from the immobilisation of the compound of the supporting substrate (e.g. loss of one or both groups, X) are nonetheless within the scope of the invention. Suitably, the supporting substrate is selected from solid methyaluminoxane, silica, silica-supported methylaluminoxane, alumina, zeolite, layered double hydroxide and layered double hydroxide-supported methylaluminoxane. Most suitably, the supporting substrate is solid methylaluminoxane.

The terms “solid MAO”, “sMAO” and “solid polymethylaluminoxane” are used synonymously herein to refer to a solid-phase material having the general formula -[(Me)AlO]ₙ—, wherein n is an integer from 4 to 50 (e.g. 10 to 50). Any suitable solid polymethylaluminoxane may be used.

There exist numerous substantial structural and behavioural differences between solid polymethylaluminoxane and other (non-solid) MAOs. Perhaps most notably, solid polymethylaluminoxane is distinguished from other MAOs as it is insoluble in hydrocarbon solvents and so acts as a heterogeneous support system. The solid polymethylaluminoxane useful in the compositions of the invention are insoluble in toluene and hexane.

In an embodiment, the aluminium content of the solid polymethylaluminoxane falls within the range of 36-41 wt %.

The solid polymethylaluminoxane useful as part of the present invention is characterised by extremely low solubility in toluene and n-hexane. In an embodiment, the solubility in n-hexane at 25° C. of the solid polymethylaluminoxane is 0-2 mol %. Suitably, the solubility in n-hexane at 25° C. of the solid polymethylaluminoxane is 0-1 mol %. More suitably, the solubility in n-hexane at 25° C. of the solid polymethylaluminoxane is 0-0.2 mol %. Alternatively or additionally, the solubility in toluene at 25° C. of the solid polymethylaluminoxane is 0-2 mol %. Suitably, the solubility in toluene at 25° C. of the solid polymethylaluminoxane is 0-1 mol %. More suitably, the solubility in toluene at 25° C. of the solid polymethylaluminoxane is 0-0.5 mol %. The solubility in solvents can be measured by the method described in JP—B(KOKOKU)-H07 42301.

In an embodiment, the at least one olefin is at least one (2-10C)alkene.

In an embodiment, the at least one olefin is at least one α-olefin.

In an embodiment, the at least one olefin is ethene and optionally one or more other (3-10C)alkenes. When the optional one or more other (3-10C)alkenes is present, the polymerisation process is a copolymerisation process. Suitable optional one or more other (3-10C)alkenes include 1-hexene, styrene and methyl methacrylate.

In an embodiment, the polymerisation process is a homopolymerisation process and the at least one olefin is ethene.

In an embodiment, the mole ratio of the compound of formula (I-A), (I-B) or (I-C) to the at least one olefin is 1:50 to 1:10,000. Suitably, the mole ratio of the compound of formula (I-A), (I-B) or (I-C) to the at least one olefin is 1:100 to 1:1000. More suitably, the mole ratio of the compound of formula (I-A), (I-B) or (I-C) to the at least one olefin is 1:150 to 1:300.

In an embodiment, the process is conducted in a solvent selected from toluene, hexane and heptane.

In an embodiment, the process is conducted for a period of 1 minute to 96 hours. Suitably, the process is conducted for a period of 5 minute to 72 hours.

In an embodiment, the process is conducted at a pressure of 0.9 to 10 bar. Suitably, the process is conducted at a pressure of 1.5 to 3 bar.

In an embodiment, the process is conducted at a temperature of 30 to 120° C. Suitably, the process is conducted at a temperature of 40 to 100° C.

In an embodiment, the process is conducted in the presence of an activator or co-catalyst. Suitably, the activator or co-catalyst is one or more organoaluminium compounds. Mores suitably, the one or more organoaluminium compounds are selected from alkylaluminoxane (e.g. methylaluminiumoxane), triisobutylaluminium and triethylaluminium.

### Preparation of the Compounds of Formulae (I-A), (I-B) and (I-C)

The compounds of formula (I-A), (I-B) and (I-C) may be formed by any suitable process known in the art. Particular examples of processes for the preparation of compounds of formula (I-A), (I-B) and (I-C) are set out in the accompanying examples.

Generally, the processes of preparing a compound of formula (I-A), (I-B) and (I-C) comprises:

(i) Reacting two equivalents of compound of formula A shown below:

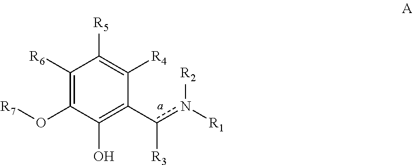

wherein R₁-R₇ and bond a have any of the definitions appearing hereinbefore, with one equivalent of a compound of formula B shown below:

M(X)₄ B
wherein M and X have any of the definitions appearing hereinbefore in the presence of a suitable solvent.

Any suitable solvent may be used for step (i) of the process defined above. A particularly suitable solvent is dry toluene.

It will be appreciated that the compound of formula B may be used in a solvated form (e.g. M(X)₄.(THF)₂).

It will be appreciated that for certain identities of X, it may be necessary to treat the compound of formula A with a strong, non-nucleophilic base (such as potassium bis(trimethylsilyl)amide) prior to reaction with the compound of formula B. For example, when X is chloro, the compound of formula A may be treated with potassium bis(trimethylsilyl)amide prior to reaction with MCl₄.(THF)₂.

Step (i) is suitably conducted at low temperature (e.g. <0° C.). More suitably, step (i) is conducted at a temperature of −80 to 0° C. Other reaction conditions (e.g. pressures, reaction times, agitation, etc.) could be readily selected by one of ordinary skill in the art.

Compounds of formula A may be generally prepared by a process comprising the step of:
(i) Reacting, in a suitable solvent (such as acidic ethanol), a compound of formula C shown below:

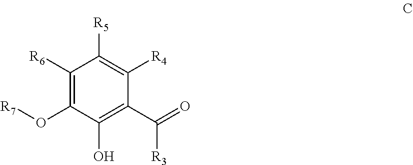

wherein R₃-R₇ have any of the definitions appearing hereinbefore, with a compound of formula D shown below:

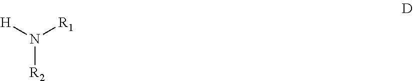

wherein R₁ and R₂ have any of the definitions appearing hereinbefore.

Step (i) is suitably conducted under refluxing conditions. Other reaction conditions (e.g. pressures, reaction times, agitation, etc.) could be readily selected by one of ordinary skill in the art.

### EXAMPLES

One or more examples of the invention will now be described, for the purpose of illustration only, with reference to the accompanying figures, in which:

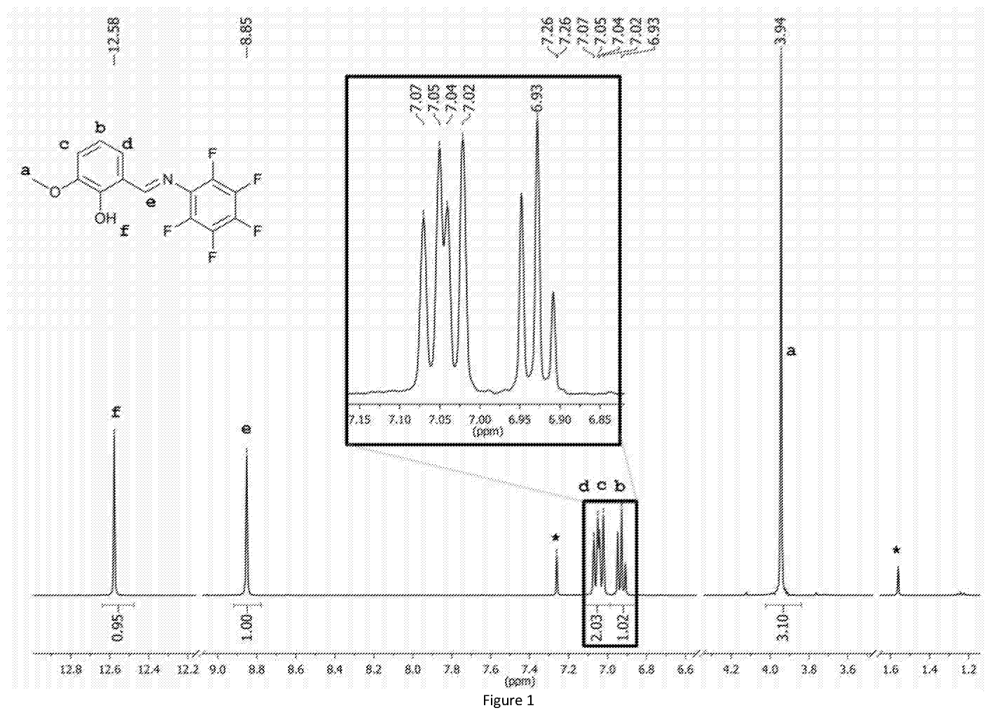

FIG. 1 shows the ¹H NMR spectrum of HL₁ in CDCl₃ at 400 MHz

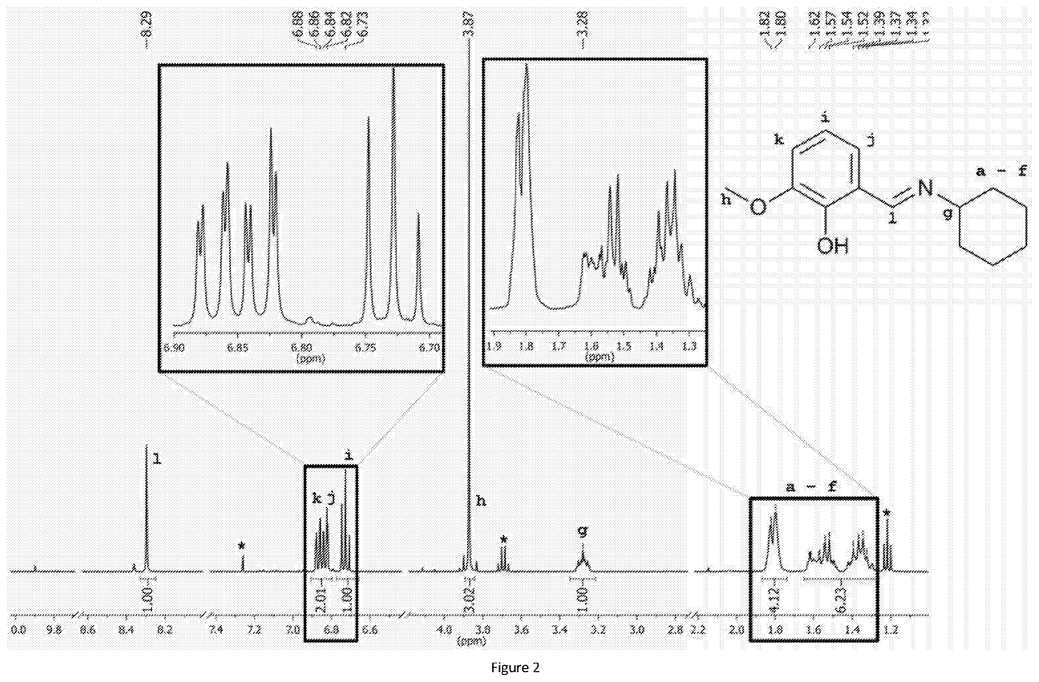

FIG. 2 shows the ¹H NMR spectrum of HL₂ in CDCl₃ at 400 MHz

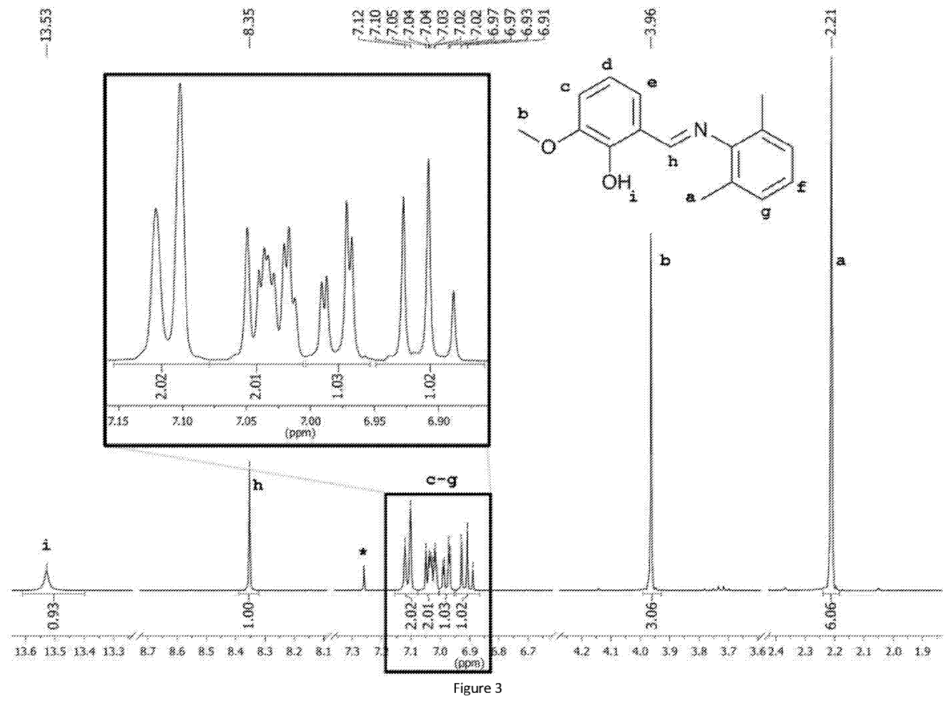

FIG. 3 shows the ¹H NMR spectrum of HL₃ in CDCl₃ at 400 MHz

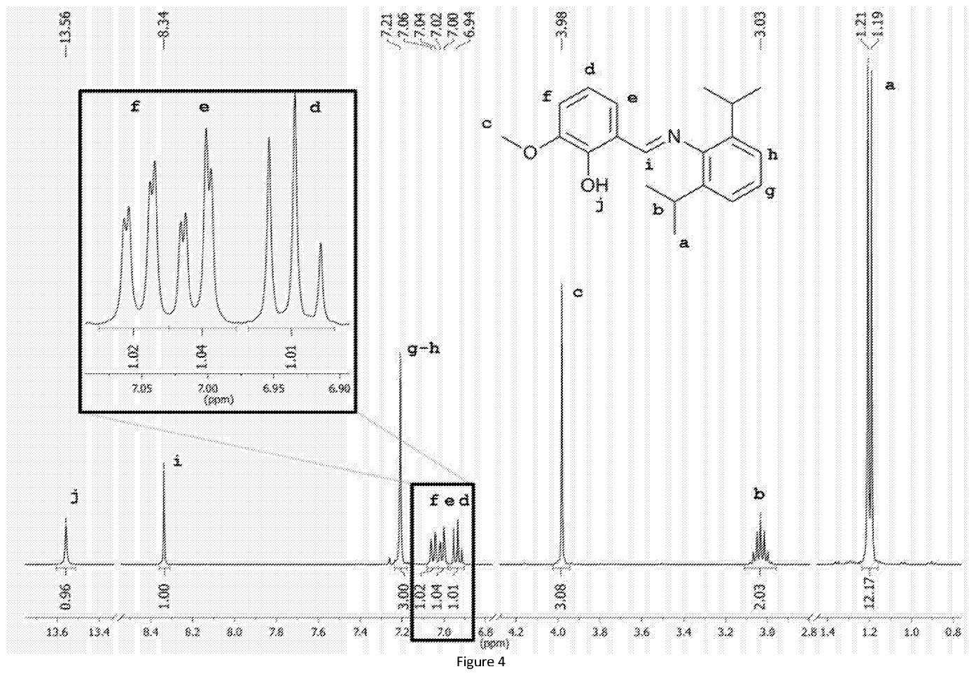

FIG. 4 shows the ¹H NMR spectrum of HL₄ in CDCl₃ at 400 MHz

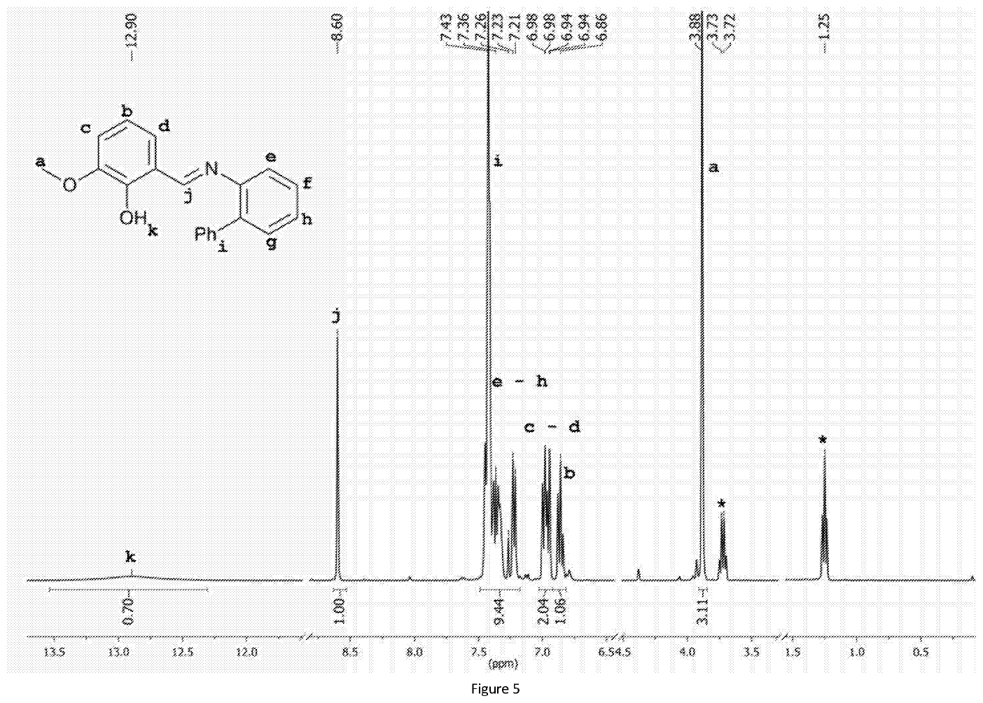

FIG. 5 shows the ¹H NMR spectrum of HL₅ in CDCl₃ at 400 MHz

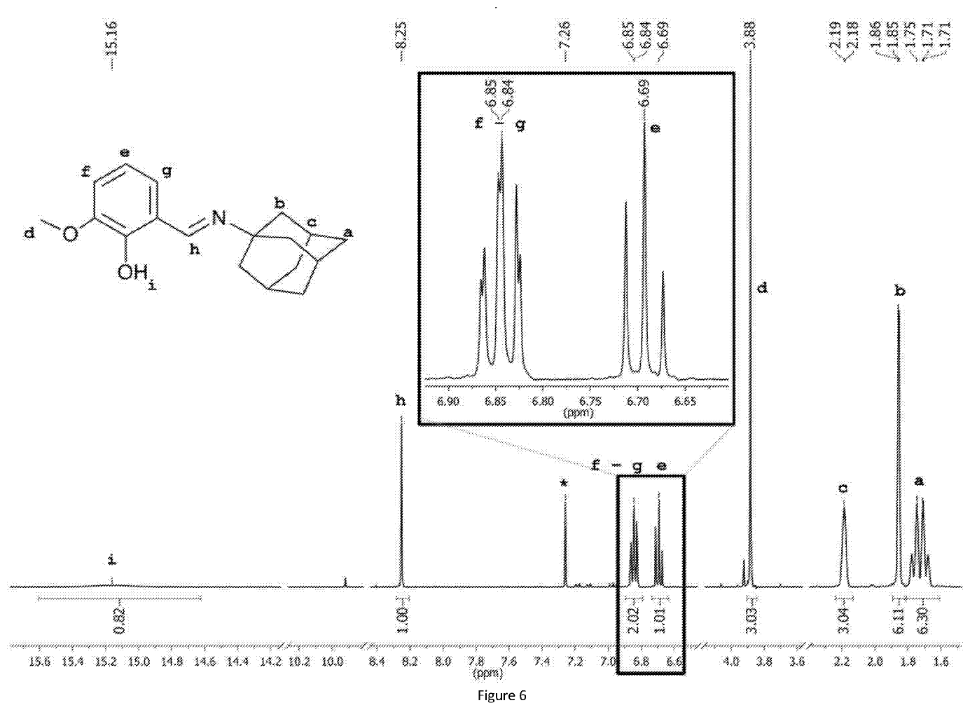

FIG. 6 shows the ¹H NMR spectrum of HL₆ in CDCl₃ at 400 MHz

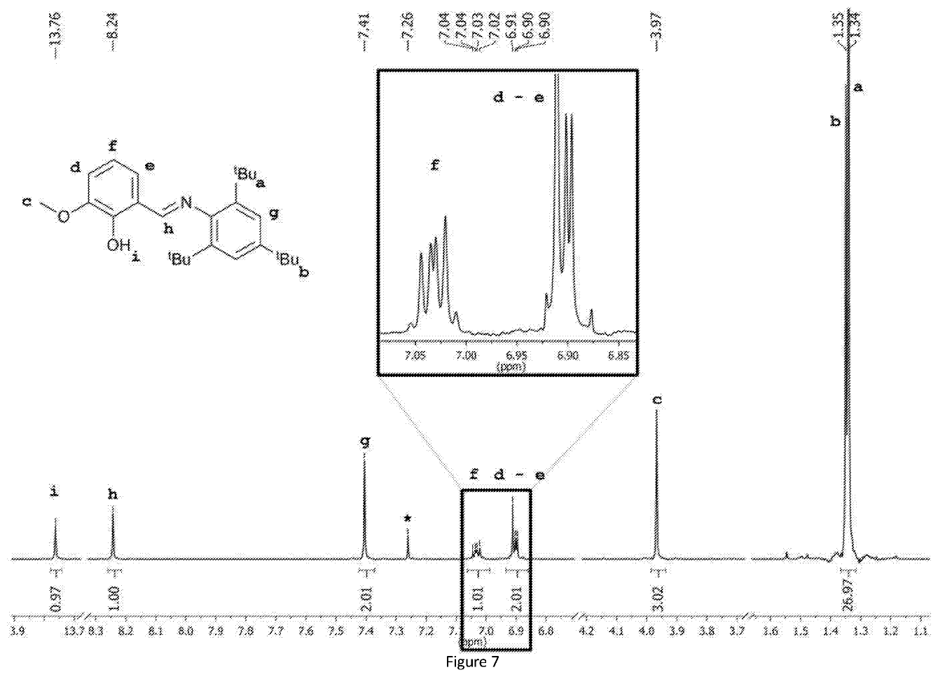

FIG. 7 shows the ¹H NMR spectrum of HL₇ in CDCl₃ at 400 MHz

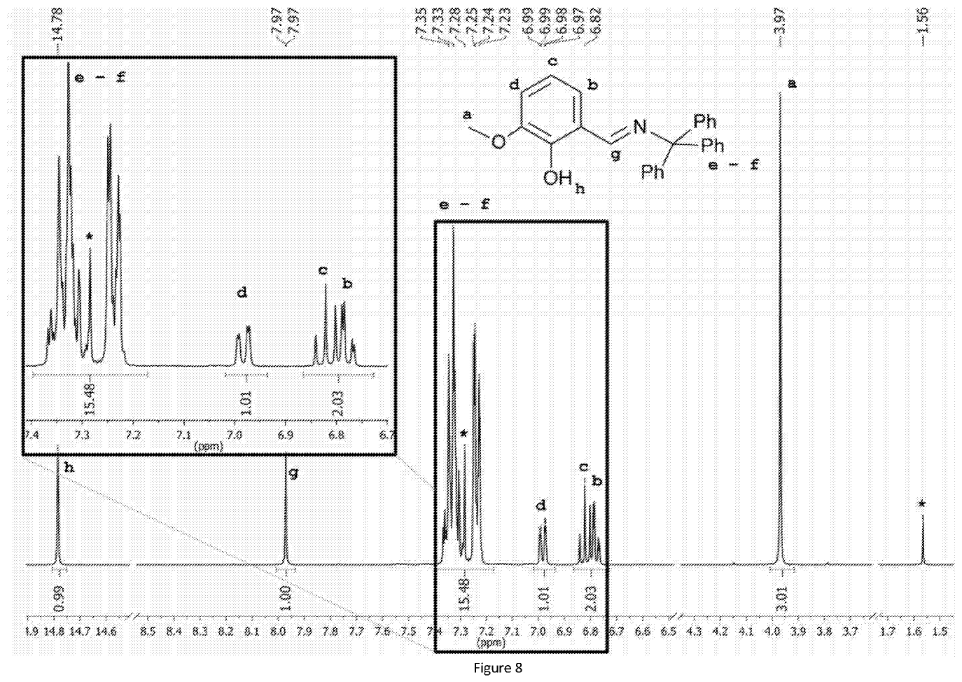

FIG. 8 shows the ¹H NMR spectrum of HL₈ in CDCl₃ at 400 MHz

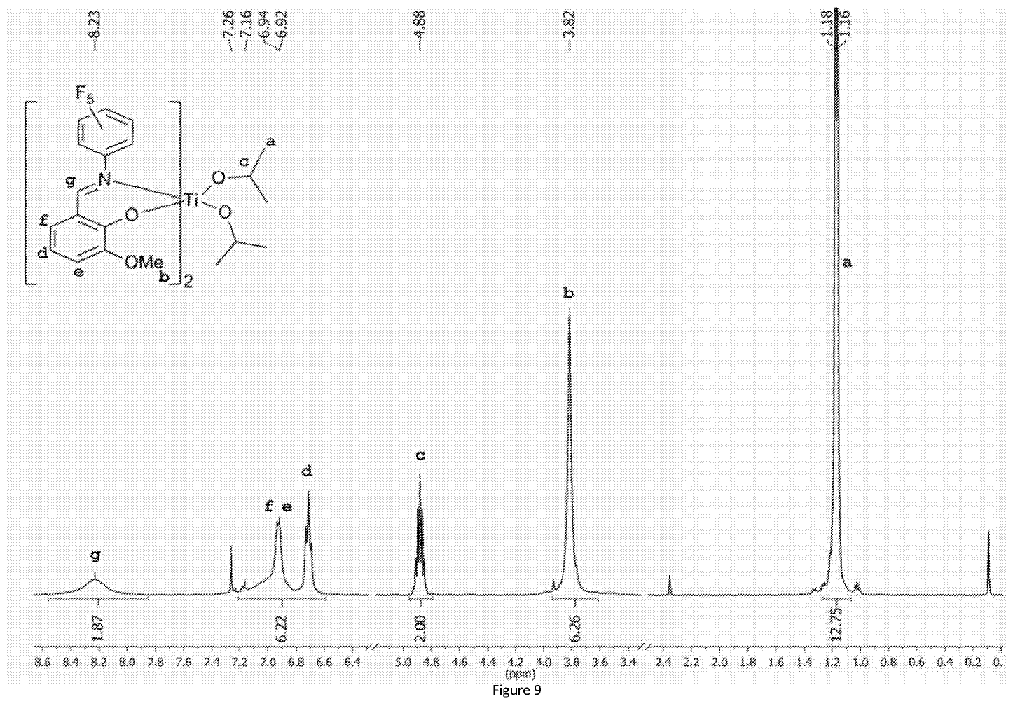

FIG. 9 shows the ¹H NMR spectrum of (Li)₂Ti(OⁱPr)₂ in CDCl₃ at 400 MHz

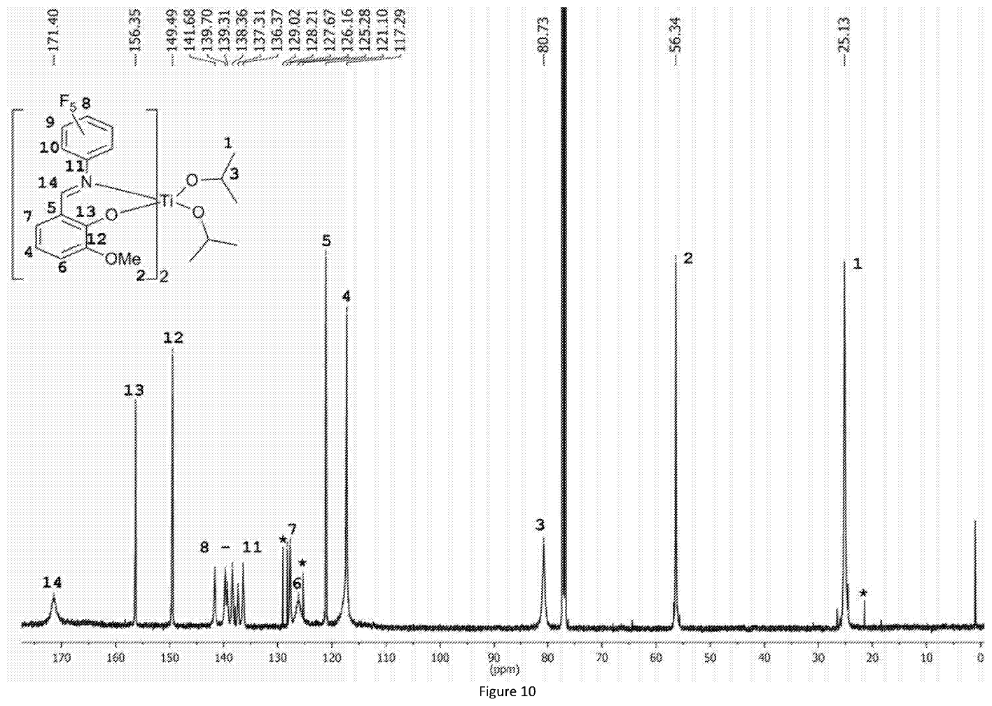

FIG. 10 shows the ¹³C{¹H} NMR spectrum of (Li)₂Ti(OⁱPr)₂ in CDCl₃ at 125 MHz

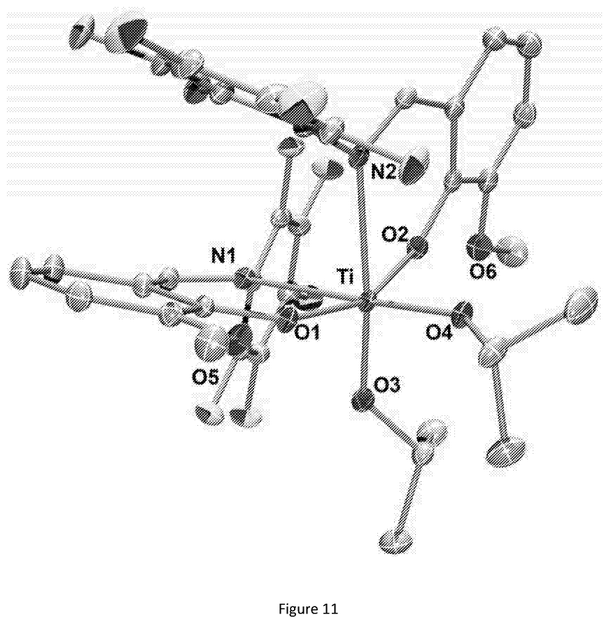

FIG. 11 shows the ORTEP representation of (Li)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon, Lime=Fluorine.

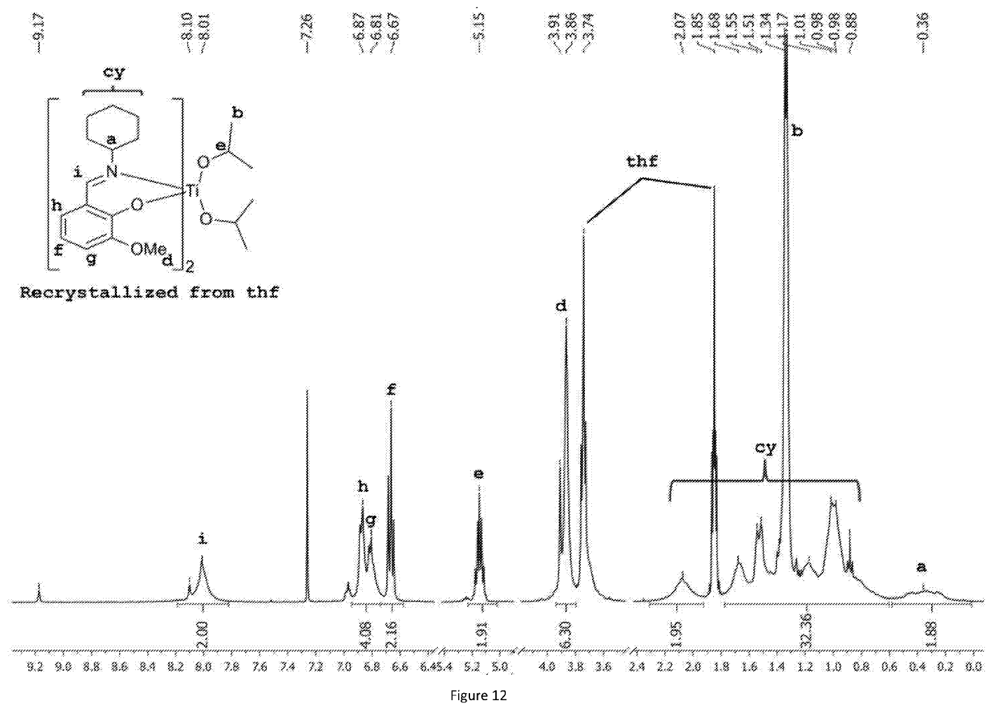

FIG. 12 shows the ¹H NMR spectrum of (L₂)₂Ti(OⁱPr)₂ in CDCl₃ at 400 MHz

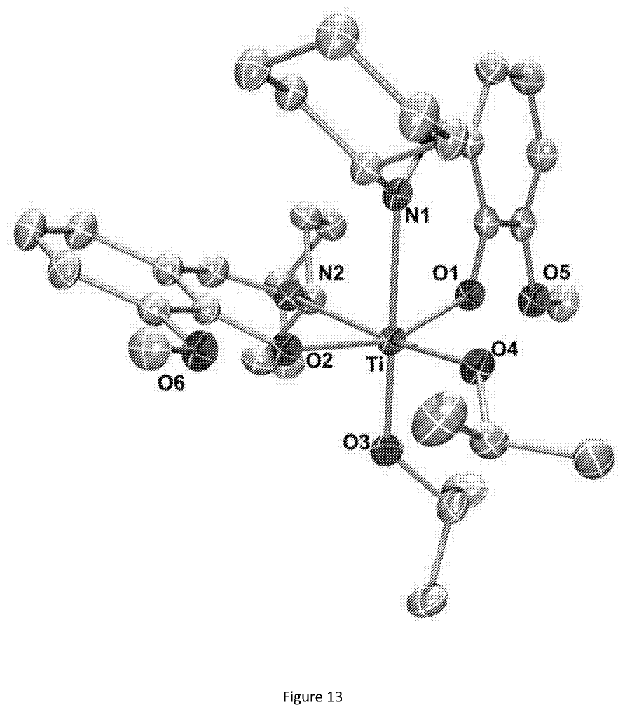

FIG. 13 shows the ORTEP representation of (L₂)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon.

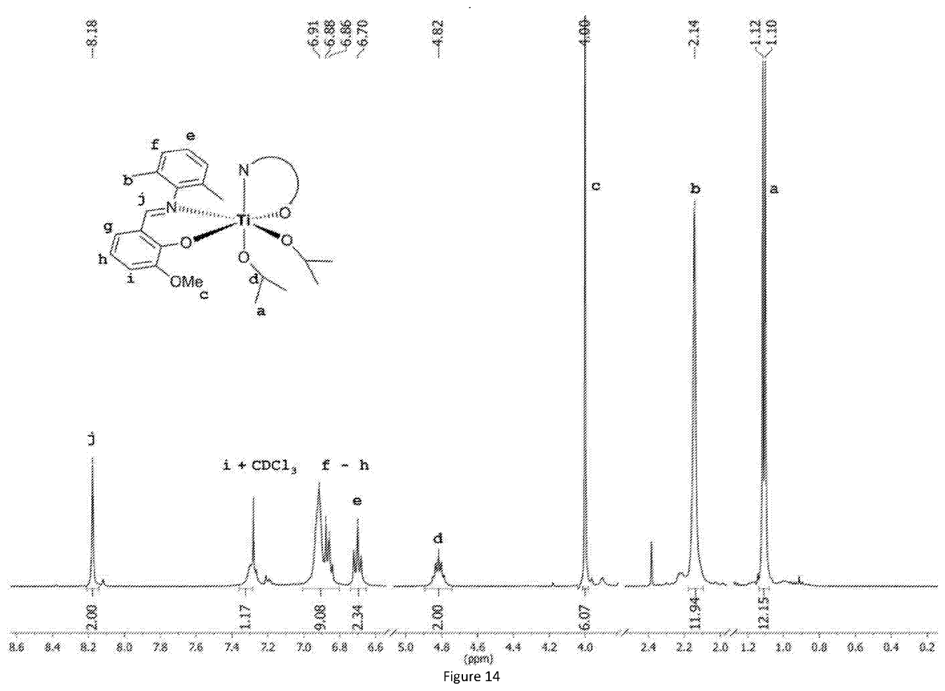

FIG. 14 shows the ¹H NMR spectrum of (L₃)₂Ti(OⁱPr)₂ in CDCl₃ at 400 MHz

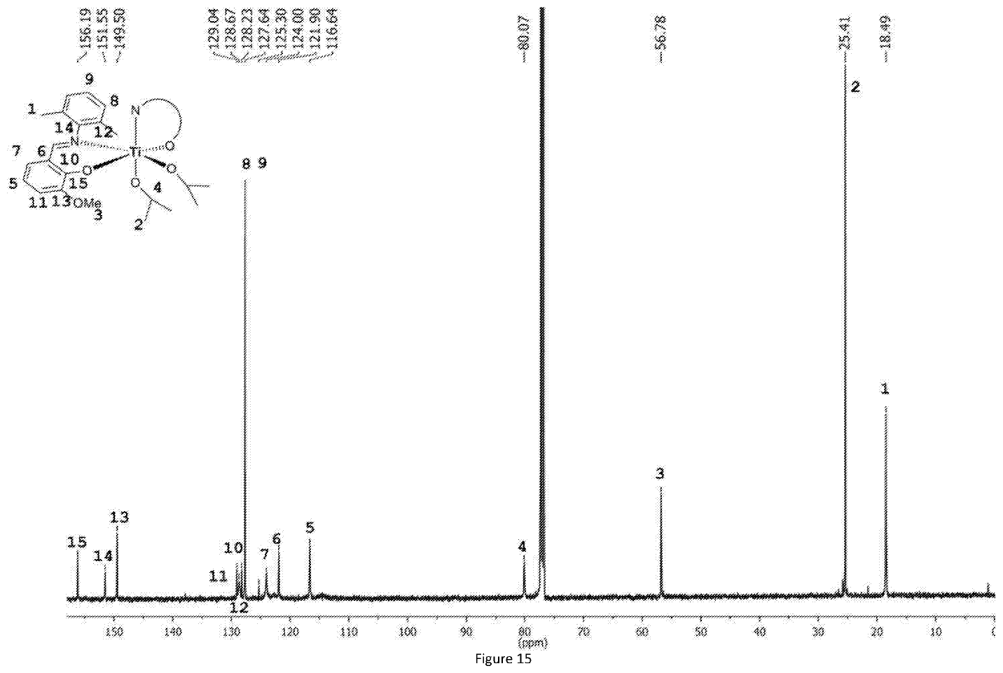

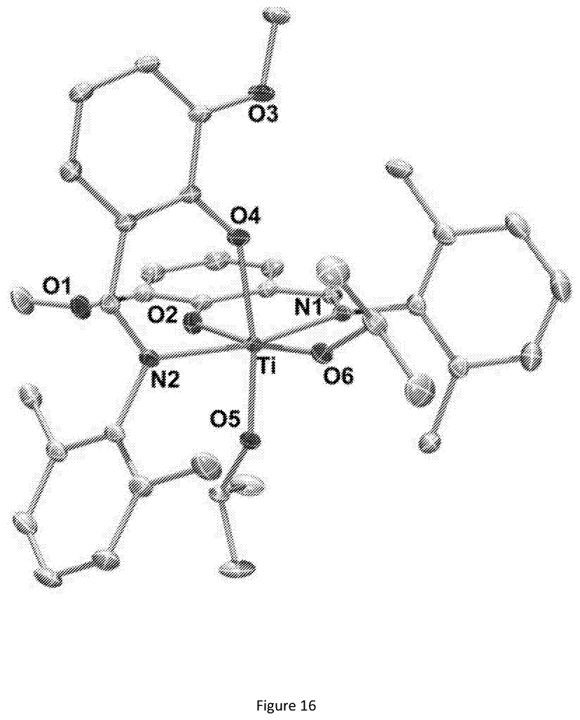

FIG. 15 shows the ¹³C{¹H} NMR spectrum of (L₃)₂Ti(OⁱPr)₂ in CDCl₃ at 125 MHz

FIG. 16 shows the ORTEP representation of (L₃)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon.

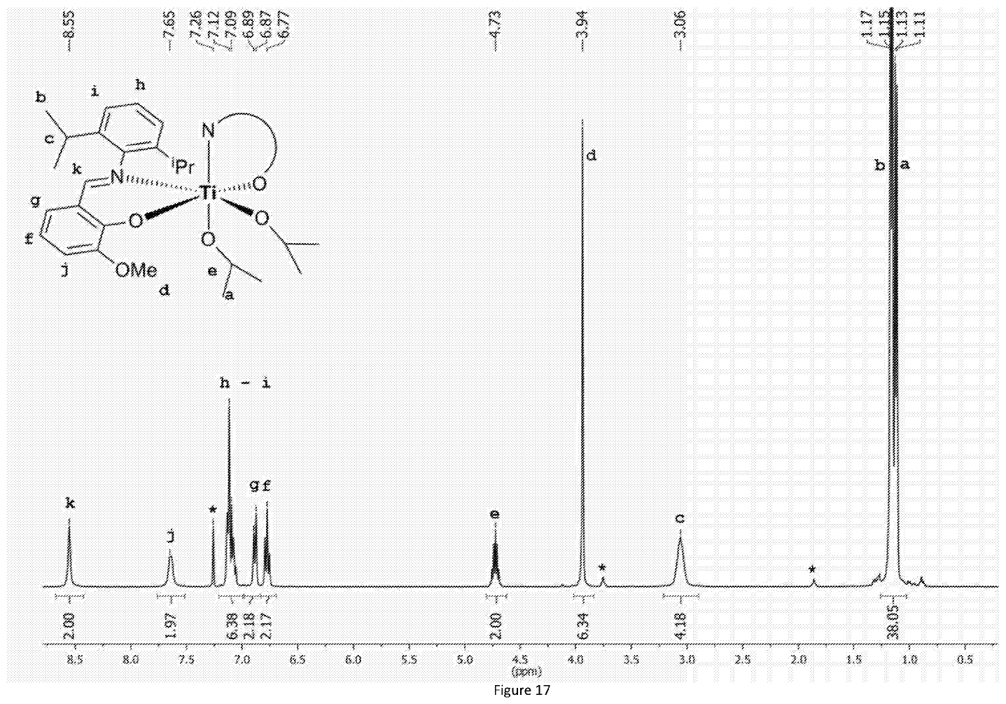

FIG. 17 shows the ¹H NMR spectrum of (L₄)₂Ti(OⁱPr)₂ in CDCl₃ at 400 MHz.

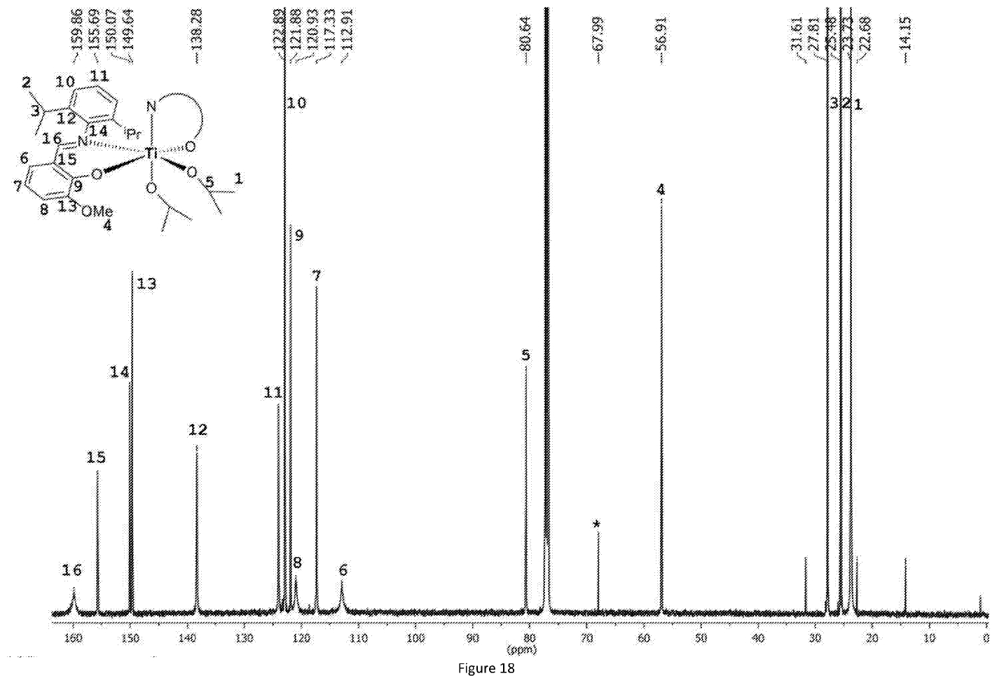

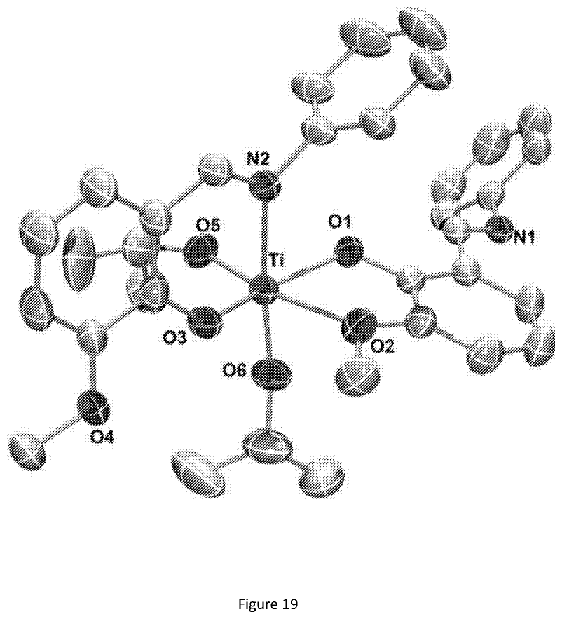

FIG. 18 shows the ¹³C{¹H} NMR spectrum of (L₄)₂Ti(OⁱPr)₂ in CDCl₃ at 125 MHz.

FIG. 19 shows the ORTEP representation of (L₄)₂Ti(OⁱPr)₂. Ellipsoids drawn at 50% probability, hydrogens, disorder, and isopropyls omitted for clarity. Green=Titanium, Blue=Nitrogen, Scarlet=Oxygen, Gray=Carbon

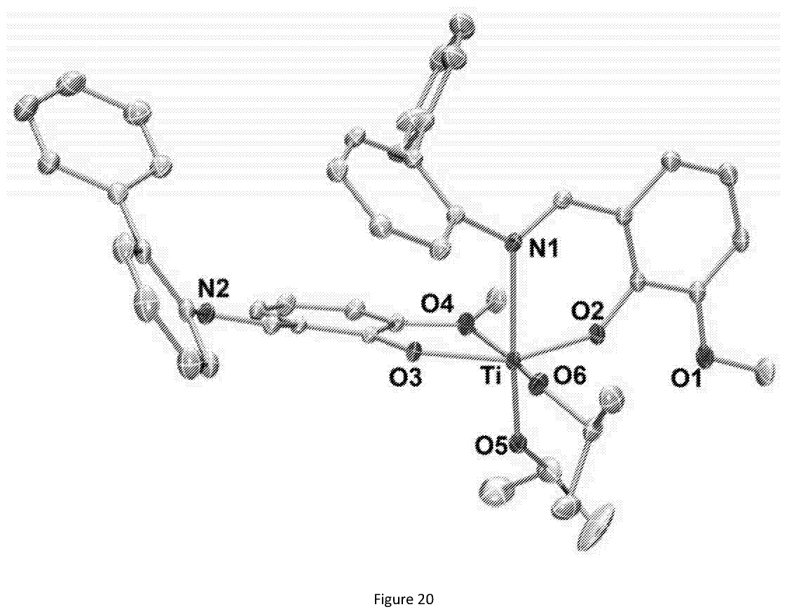

FIG. 20 shows the ORTEP representation of (L₅)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon.

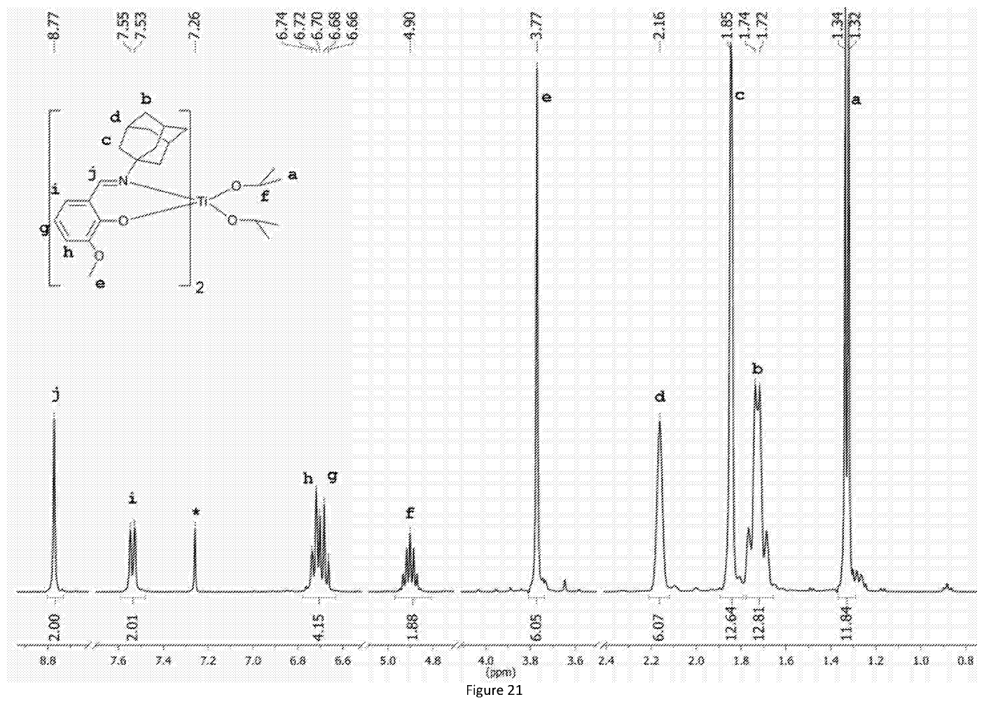

FIG. 21 shows the ¹H NMR spectrum of (L₆)₂Ti(OⁱPr)₂ in CDCl₃ at 400 MHz

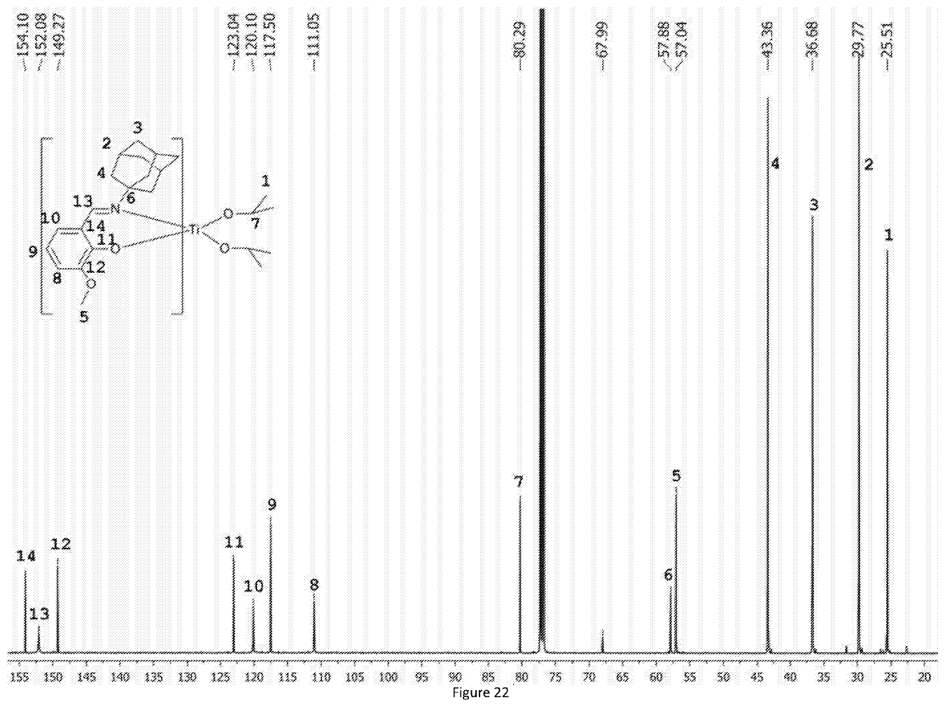

FIG. 22 shows the ¹³C{¹H} NMR spectrum of (L₆)₂Ti(OⁱPr)₂ in CDCl₃ at 125 MHz

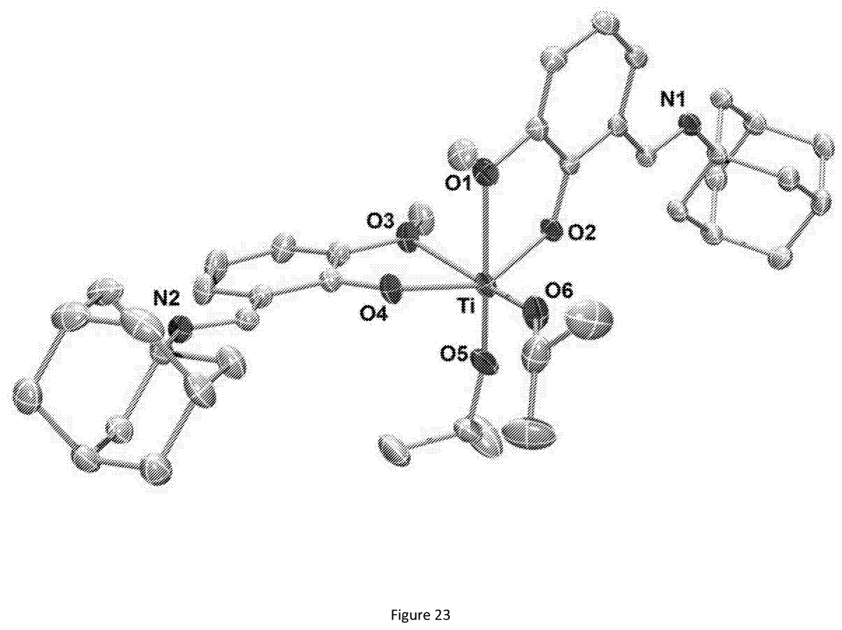

FIG. 23 shows the ORTEP representation of (L₆)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon.

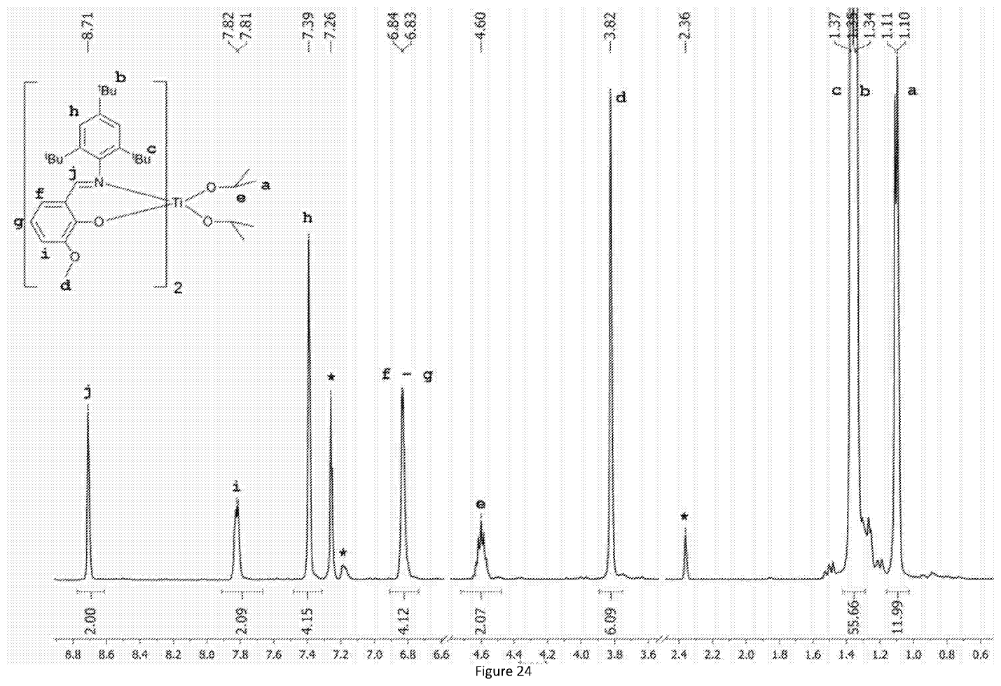

FIG. 24 shows the ¹H NMR spectrum of (L₇)₂Ti(OⁱPr)₂ in CDCl₃ at 400 MHz

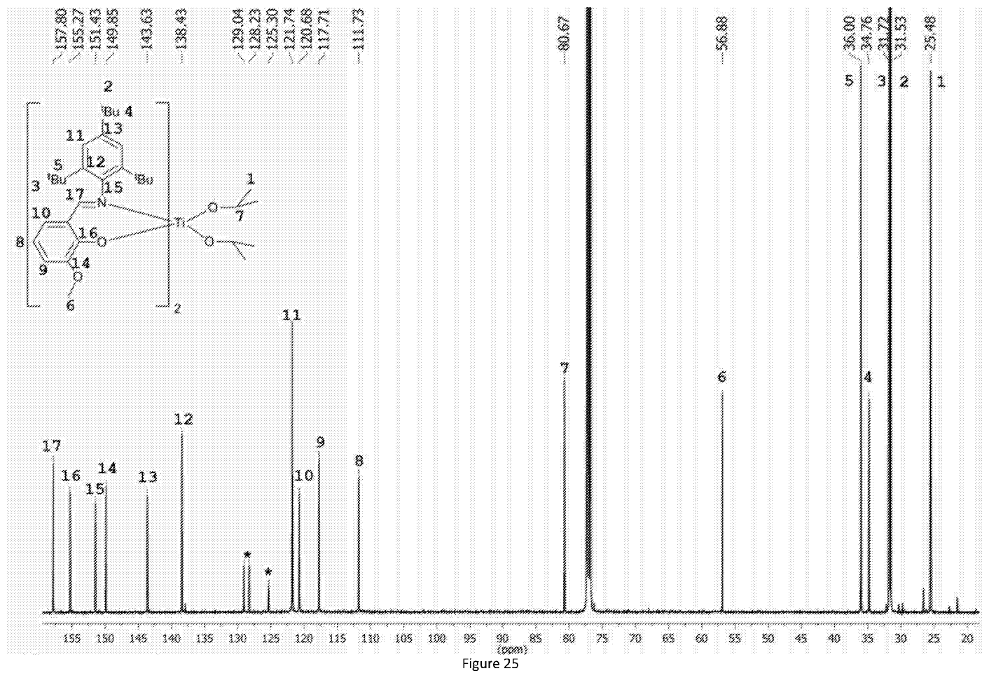

FIG. 25 shows the ¹³C{¹H} NMR spectrum of (L₇)₂Ti(OⁱPr)₂ in CDCl₃ at 125 MHz

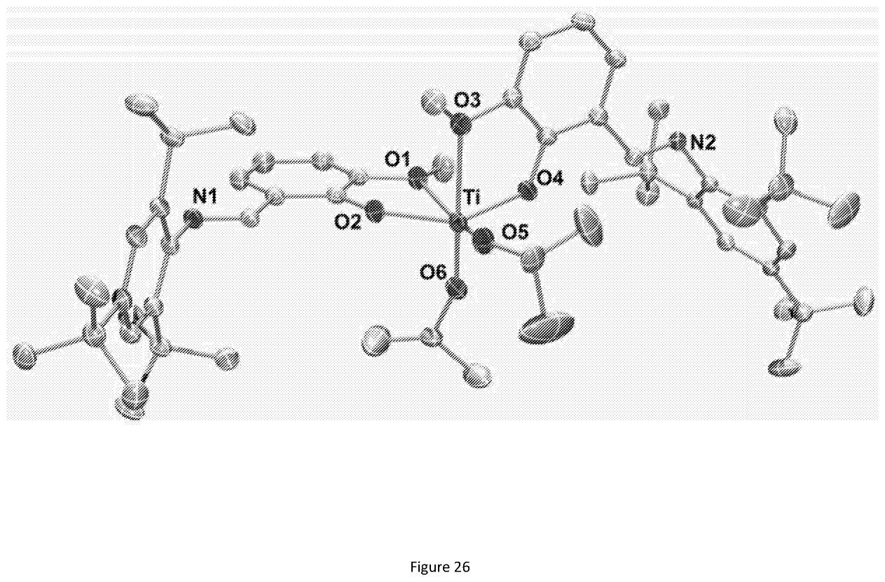

FIG. 26 shows the ORTEP representation of (L₇)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon.

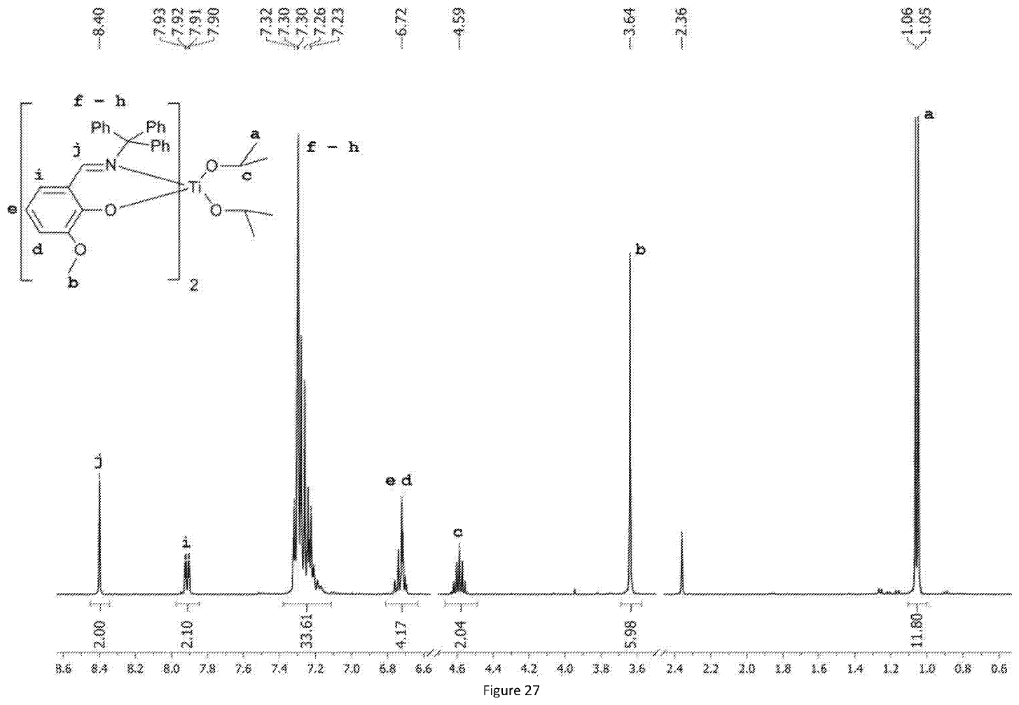

FIG. 27 shows the ¹H NMR spectrum of (L₈)₂Ti(OⁱPr)₂ in CDCl₃ at 400 MHz

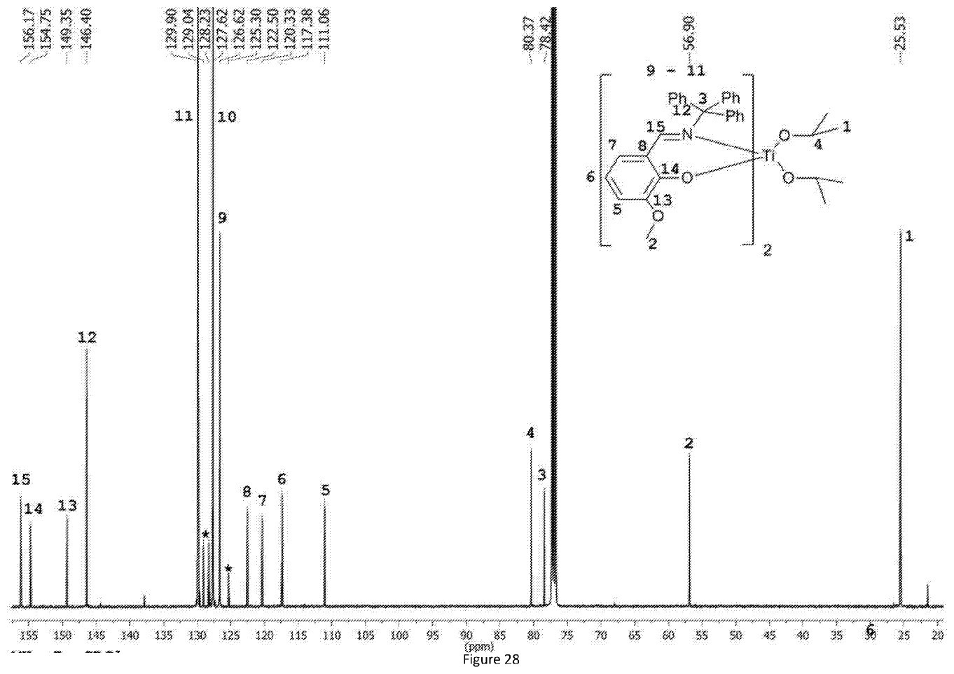

FIG. 28 shows the ¹³C{¹H} NMR spectrum of (L₈)₂Ti(OⁱPr)₂ in CDCl₃ at 125 MHz

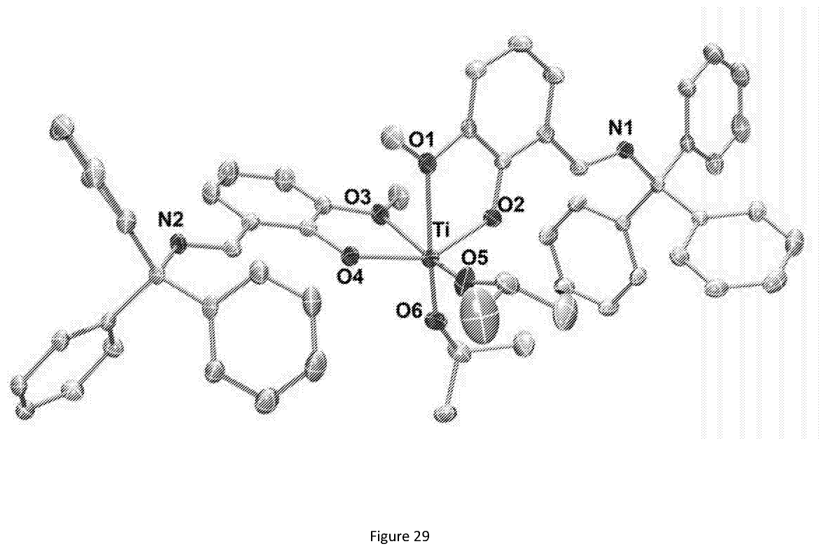

FIG. 29 shows the ORTEP representation of (L₈)₂Ti(OⁱPr)₂. Ellipsoids drawn at 50% probability, hydrogens and disorder omitted for clarity. Green=Titanium, Blue=Nitrogen, Scarlet=Oxygen, Gray=Carbon.

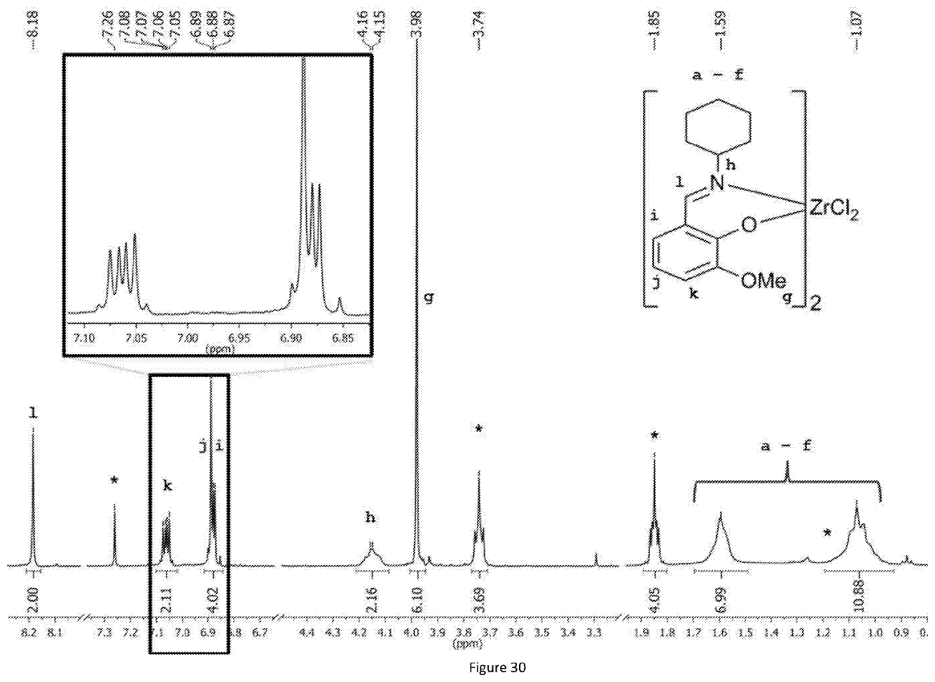

FIG. 30 shows the ¹H NMR spectrum of (L₂)₂ZrCl₂ in CDCl₃ at 400 MHz.

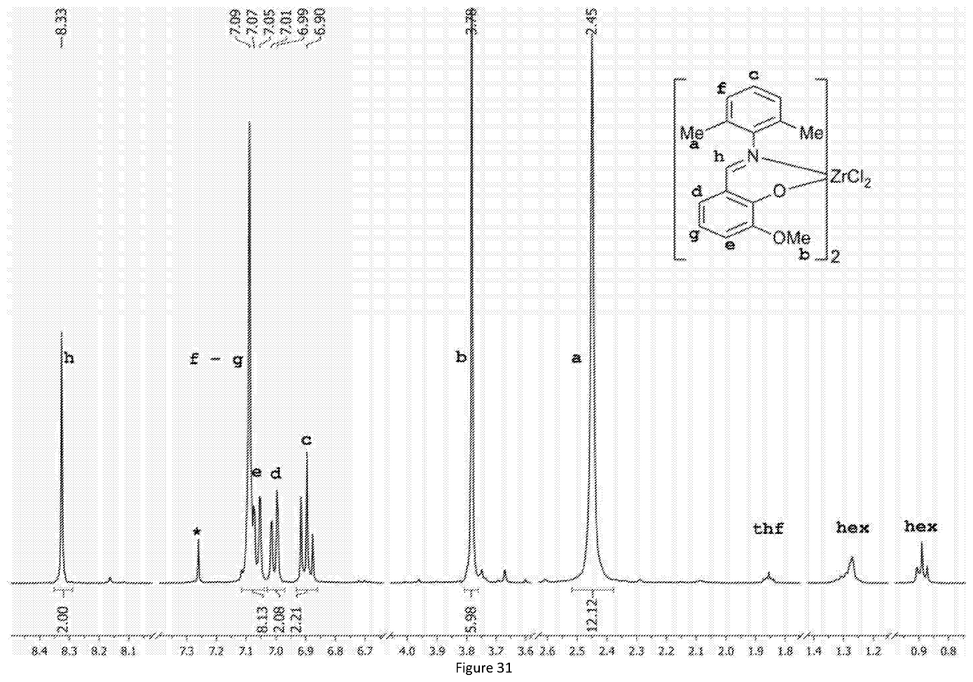

FIG. 31 shows the ¹H NMR spectrum of (L₃)₂ZrCl₂ in CDCl₃ at 400 MHz.

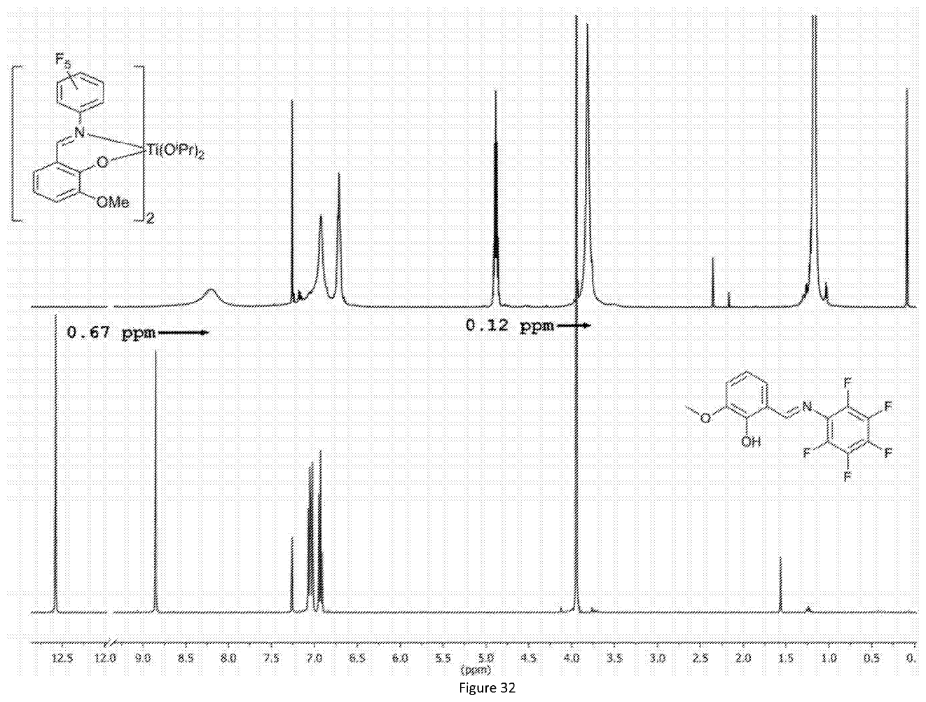

FIG. 32 shows comparative ¹H NMR spectra of (Li)₂Ti(OⁱPr)₂ and HL₁, in CDCl₃, 400 MHz.

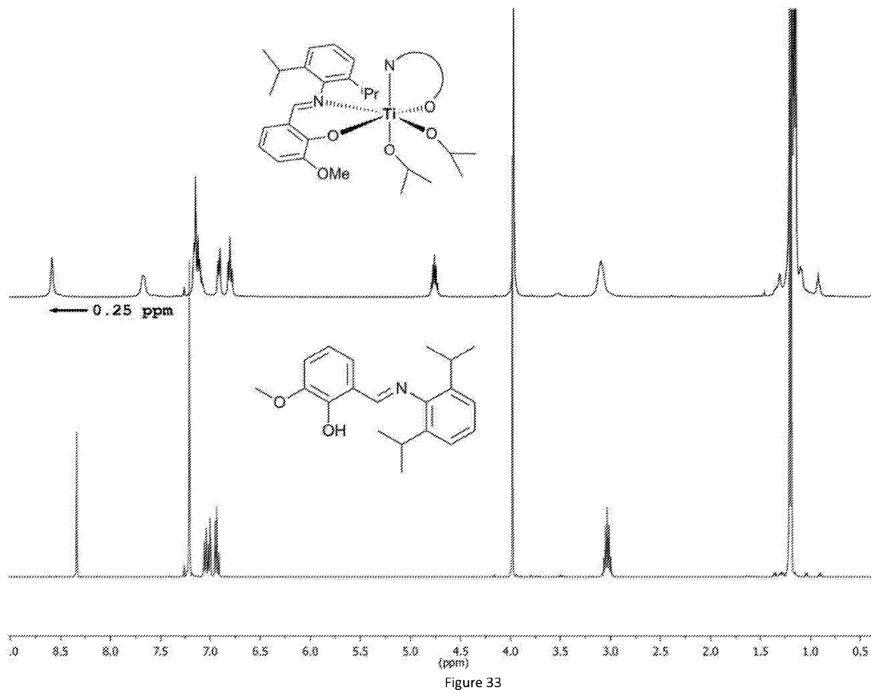

FIG. 33 shows comparative ¹H NMR spectra of (L₄)₂Ti(OⁱPr)₂ and HL₄, in CDCl₃, 400 MHz

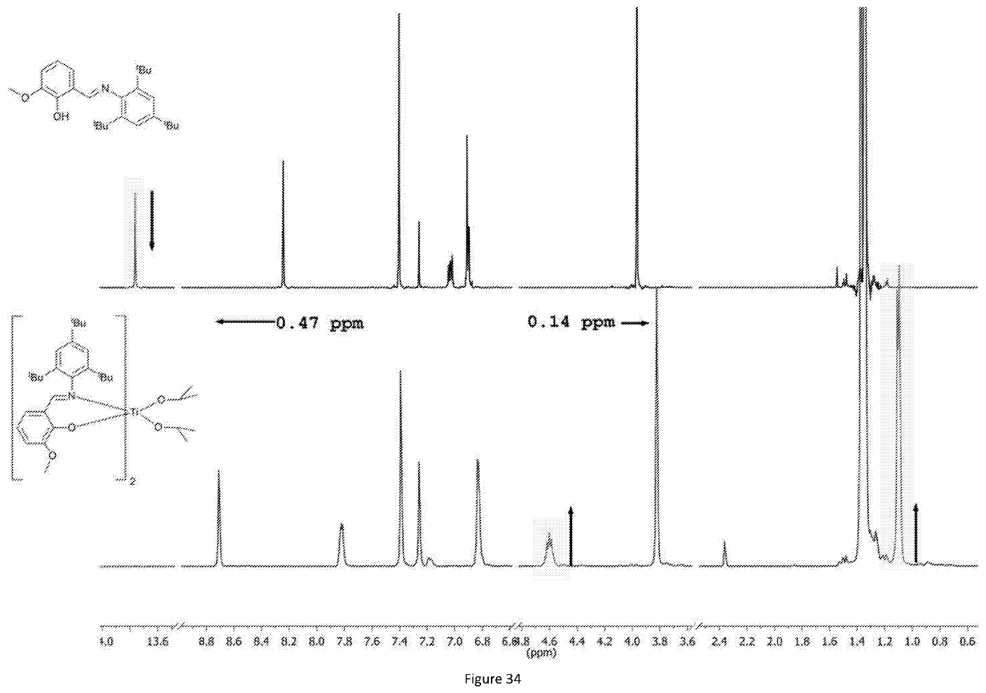

FIG. 34 shows comparative ¹H NMR spectra of (L₇)₂Ti(OⁱPr)₂ and HL₇, in CDCl₃, 400 MHz

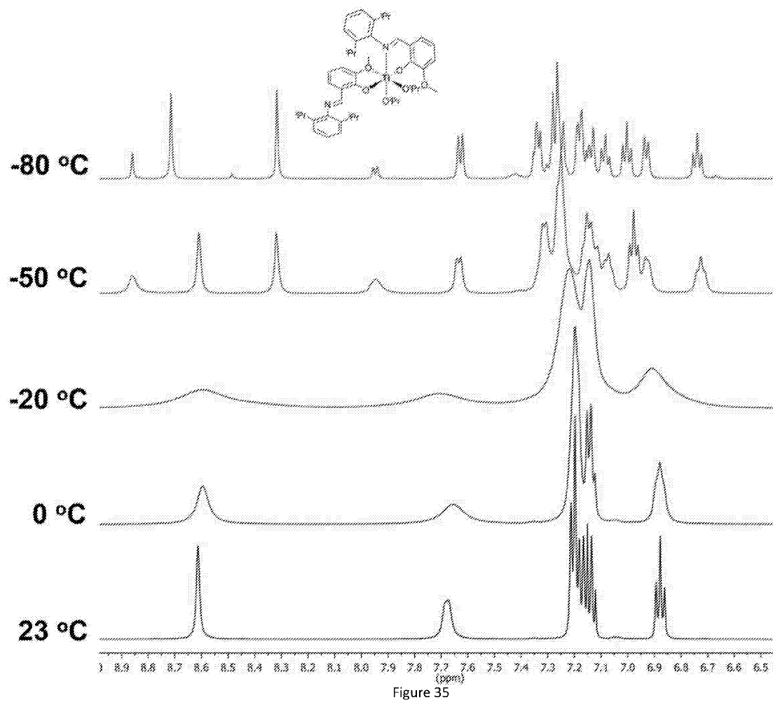

FIG. 35 shows variable temperature NMR of the imine region of (L₄)₂Ti(OⁱPr)₂ in d⁶-THF (500 MHz).

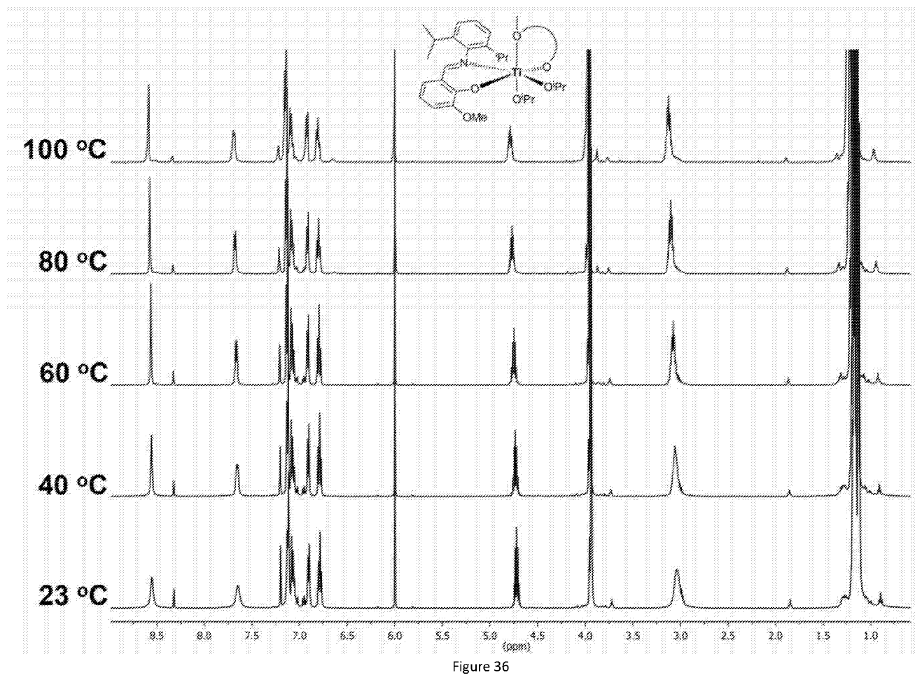

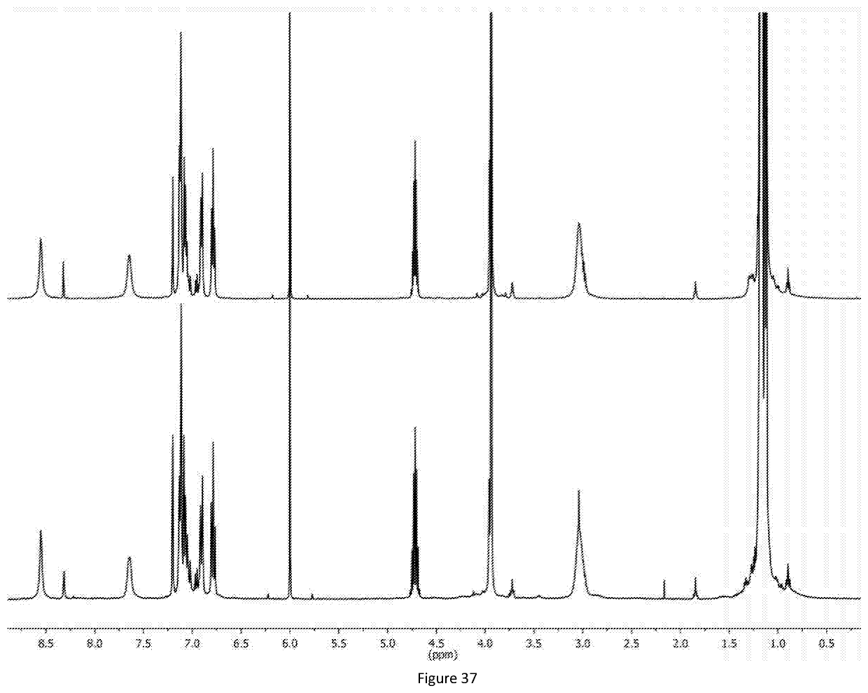

FIG. 36 shows variable high temperature ¹H NMR (500 MHz) of (L₄)₂Ti(OⁱPr)₂ in d²-tetrachloroethane

FIG. 37 shows ¹H NMR of (L₄)₂Ti(OⁱPr)₂ in d²-tetrachloroethane before heating (Top) and after heating for 24 h at 100° C. (bottom).

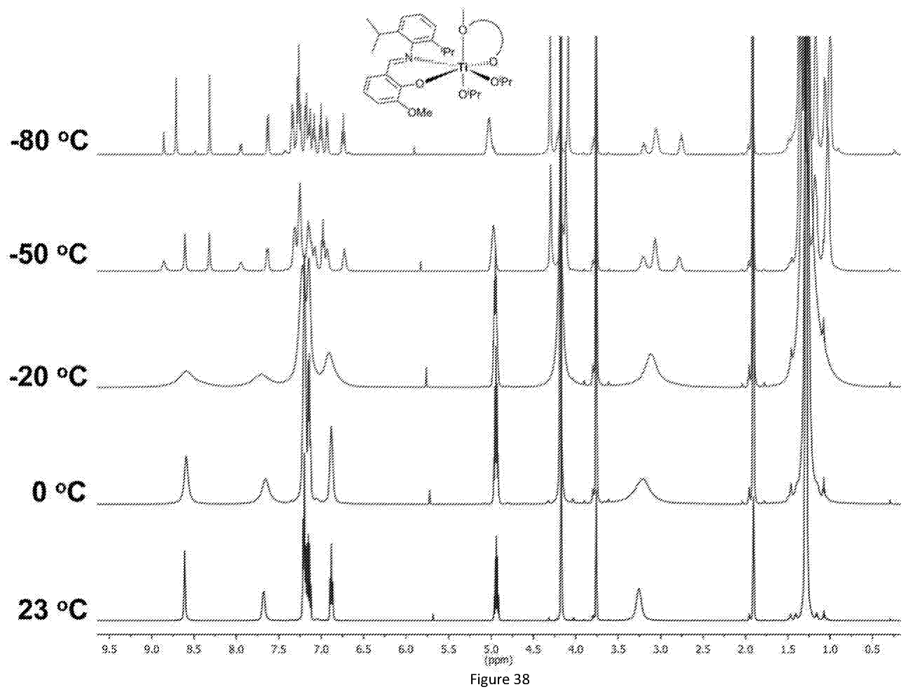

FIG. 38 shows variable low temperature ¹H NMR (500 MHz) of (L₄)₂Ti(OⁱPr)₂ in d⁸-THF

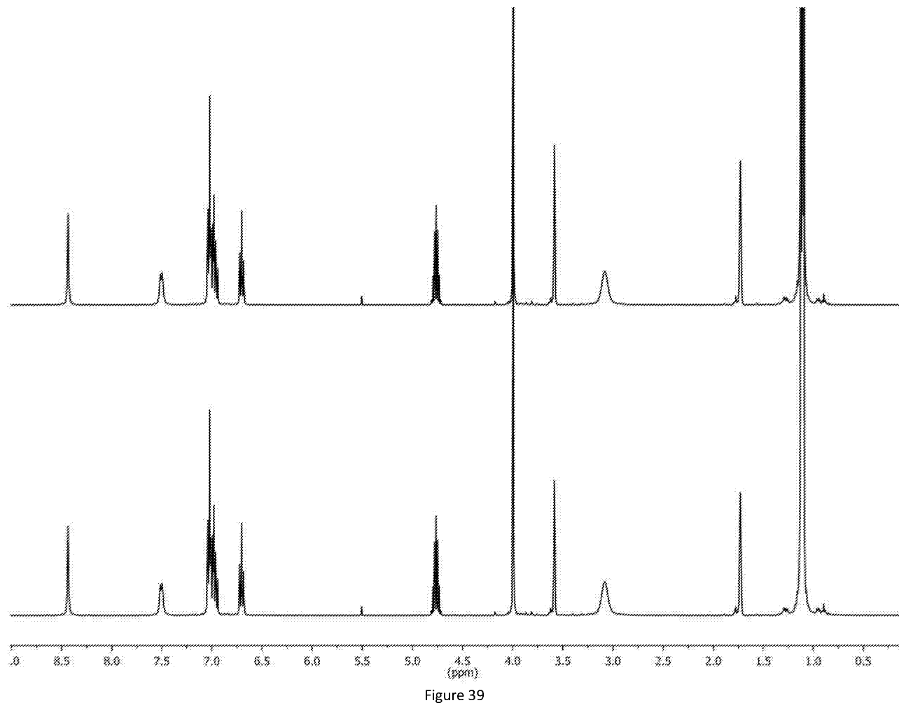

FIG. 39 shows ¹H NMR of (L₄)₂Ti(OⁱPr)₂ in d⁸-THF before heating (top) and after heating for 5 h at 70° C. (bottom).

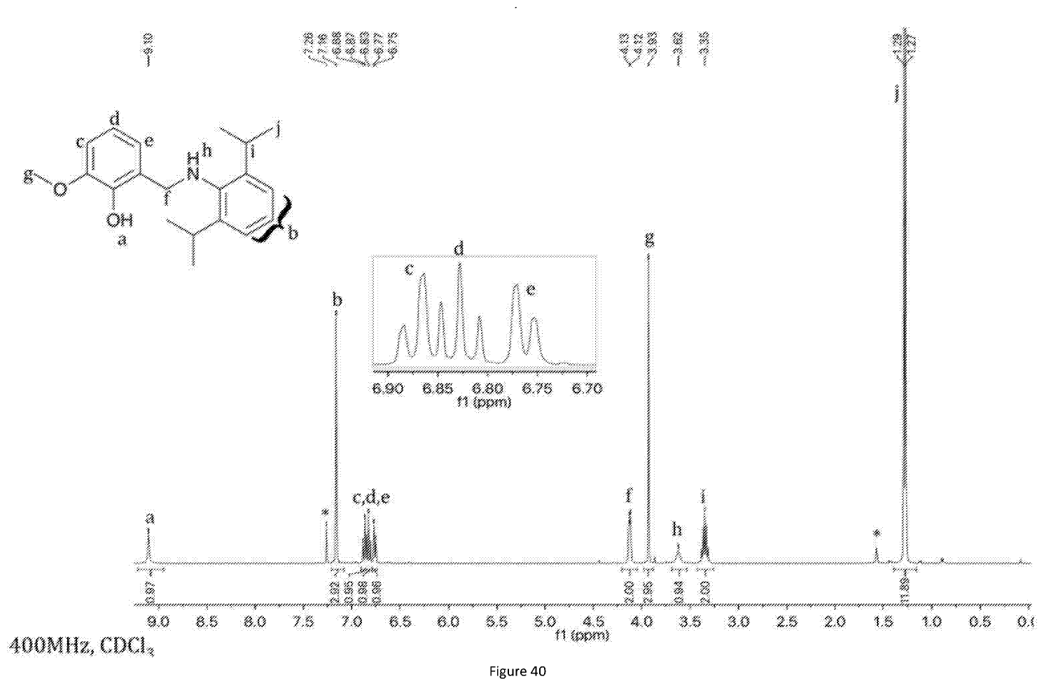

FIG. 40 shows the ¹H NMR spectrum of HL₄′ in CDCl₃, 400 MHz.

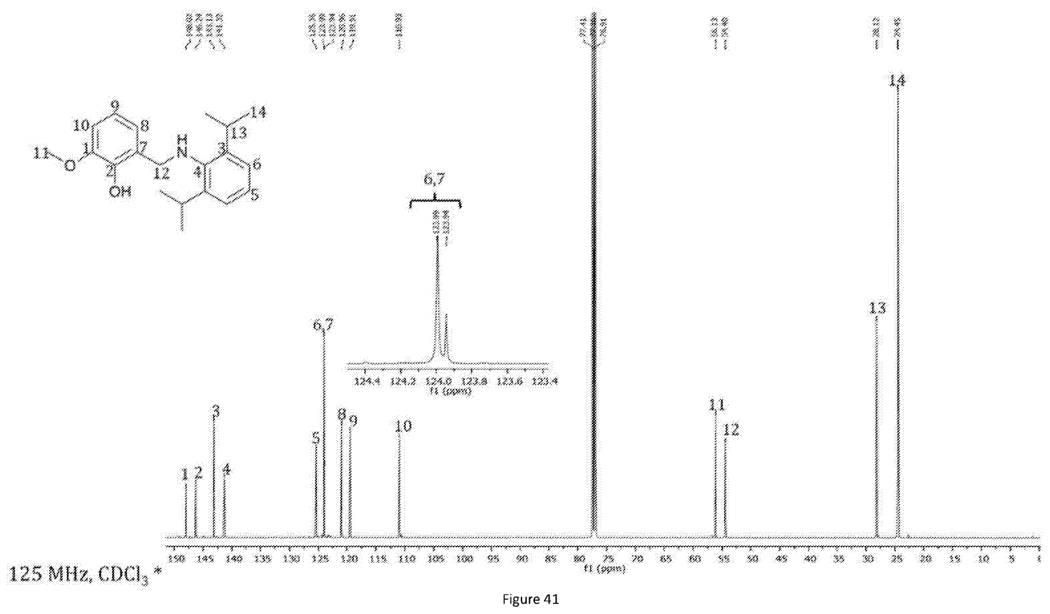

FIG. 41 shows the ¹³C{¹H} NMR spectrum of HL₄′ in CDCl₃, 400 MHz.

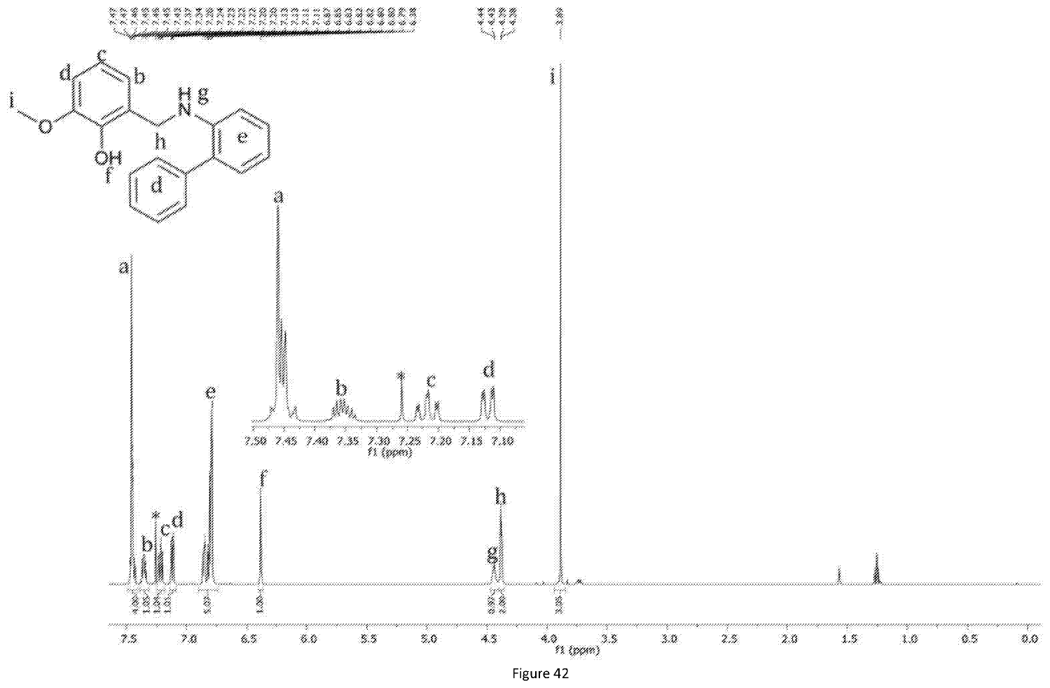

FIG. 42 shows the ¹H NMR spectrum of HL₅′ in CDCl₃, 400 MHz.

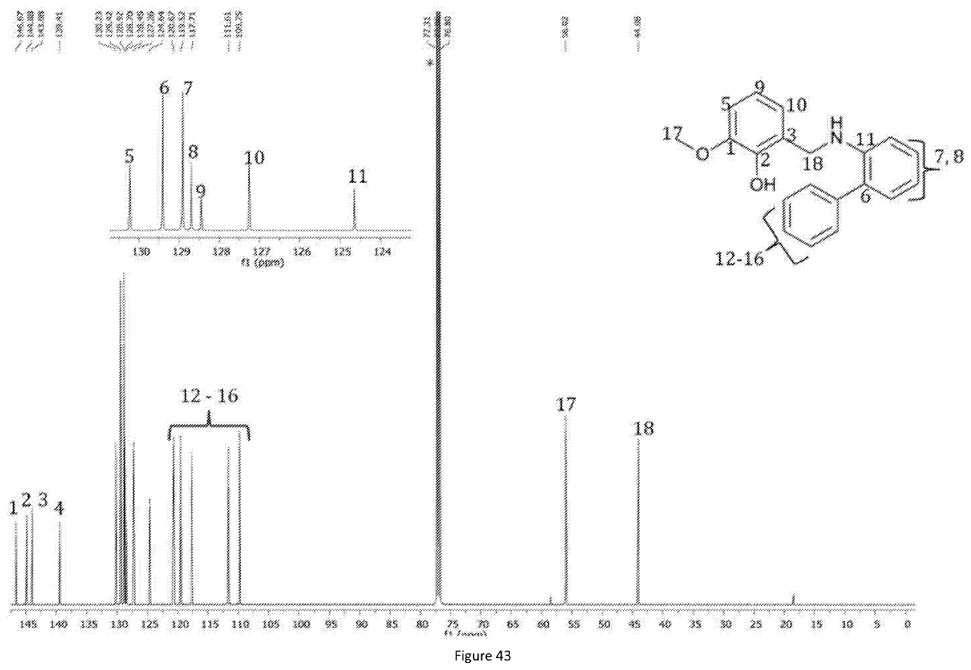

FIG. 43 shows the ¹³C{¹H} NMR spectrum of HL₅′ in CDCl₃, 400 MHz.

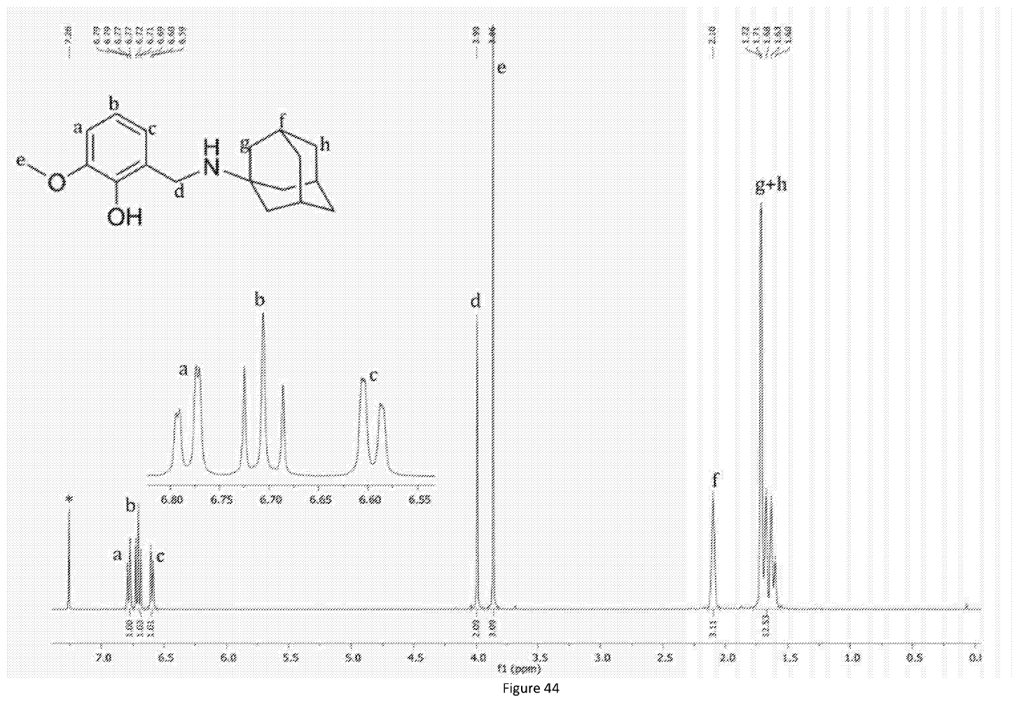

FIG. 44 shows the ¹H NMR spectrum of HL₆′ in CDCl₃, 400 MHz.

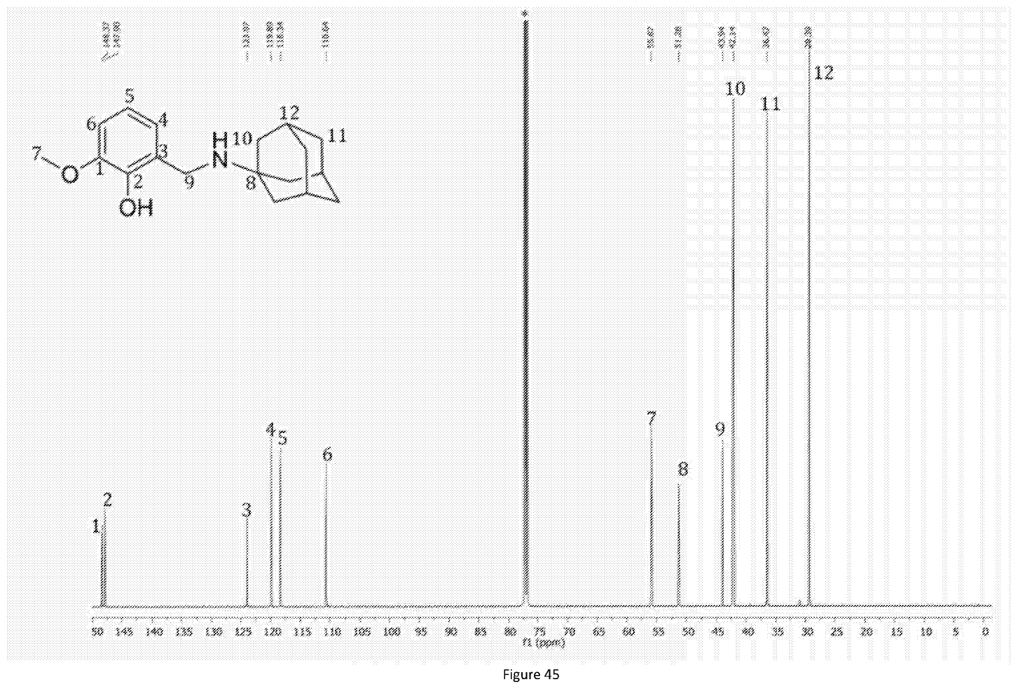

FIG. 45 shows the ¹³C{¹H} NMR spectrum of HL₆′ in CDCl₃, 400 MHz.

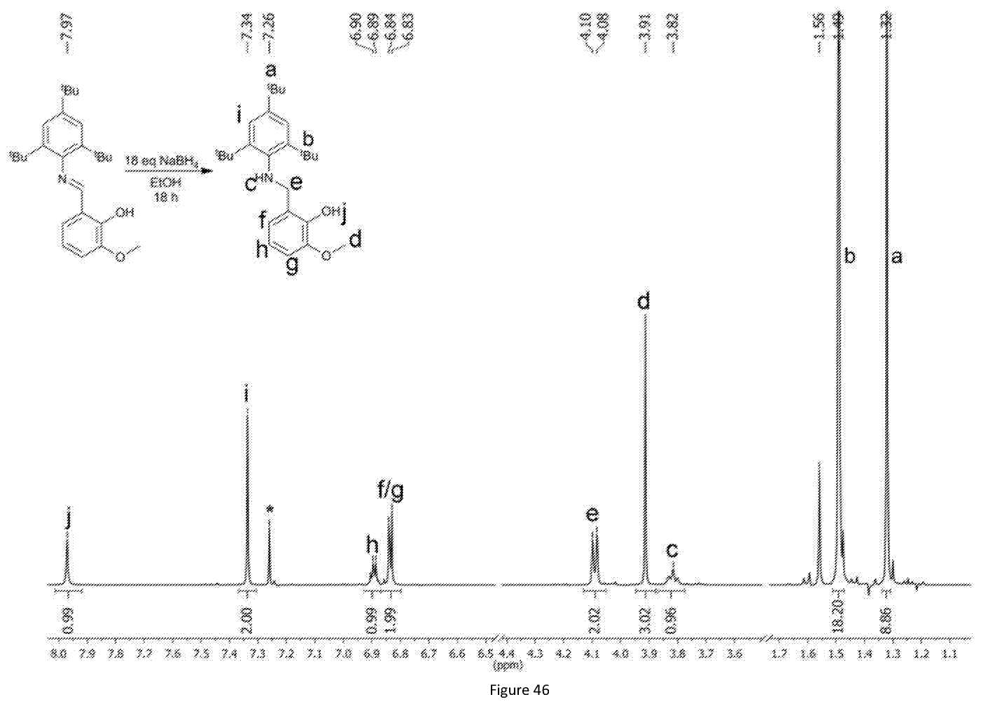

FIG. 46 shows the ¹H NMR spectrum of HL₇′ in CDCl₃, 500 MHz.

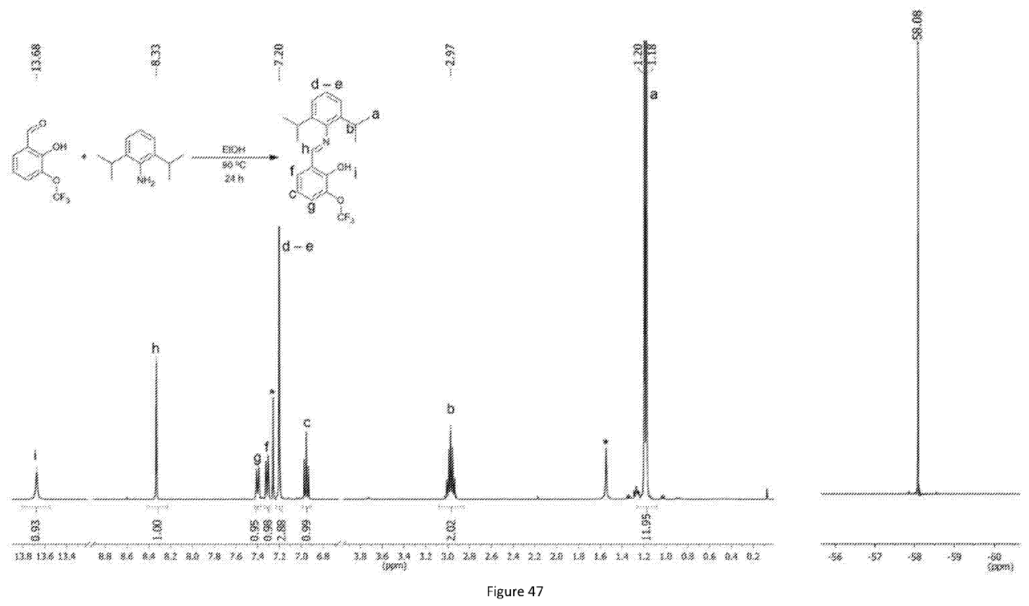

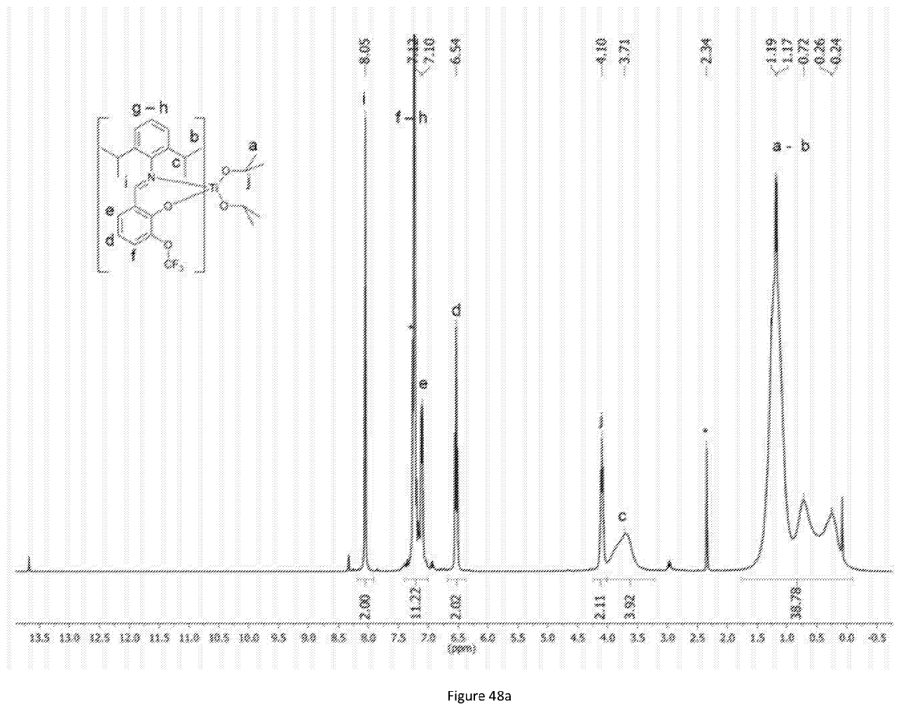

FIG. 47 shows the ¹H NMR spectrum of HL₄^{F} in CDCl₃, 400 MHz.

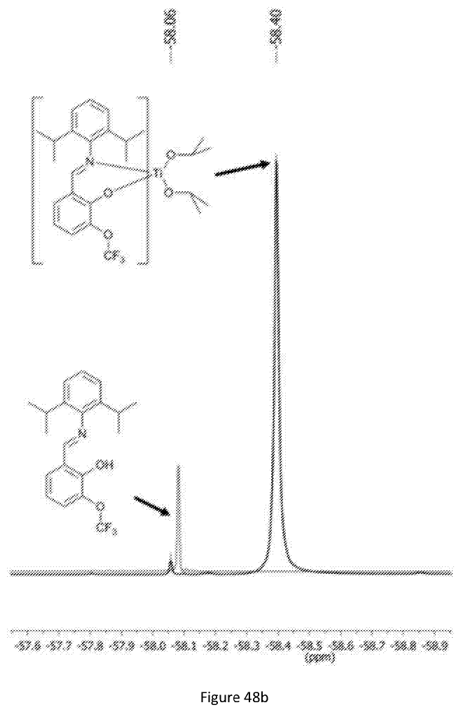

FIG. 48 shows the ¹H NMR spectrum of [(LF₄)₂Ti(OⁱPr)₂] in CDCl₃, 400 MHz, as well as the ¹⁹F{¹H} NMR spectrum comparing HL^{F}₄ (−58.1 ppm) and [(L^{F}₄)₂Ti(OⁱPr)₂] (−58.4) 400 MHz in CDCl₃.

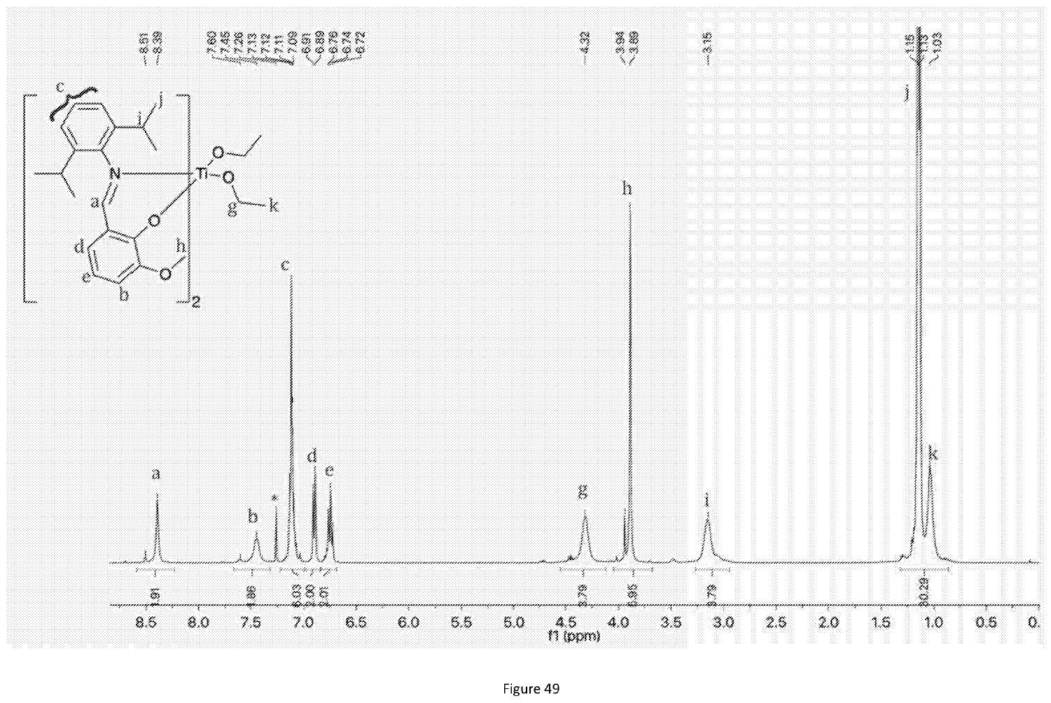

FIG. 49 shows the ¹H NMR spectrum of (L₄)₂Ti(OEt)₂ in CDCl₃ at 298 K.

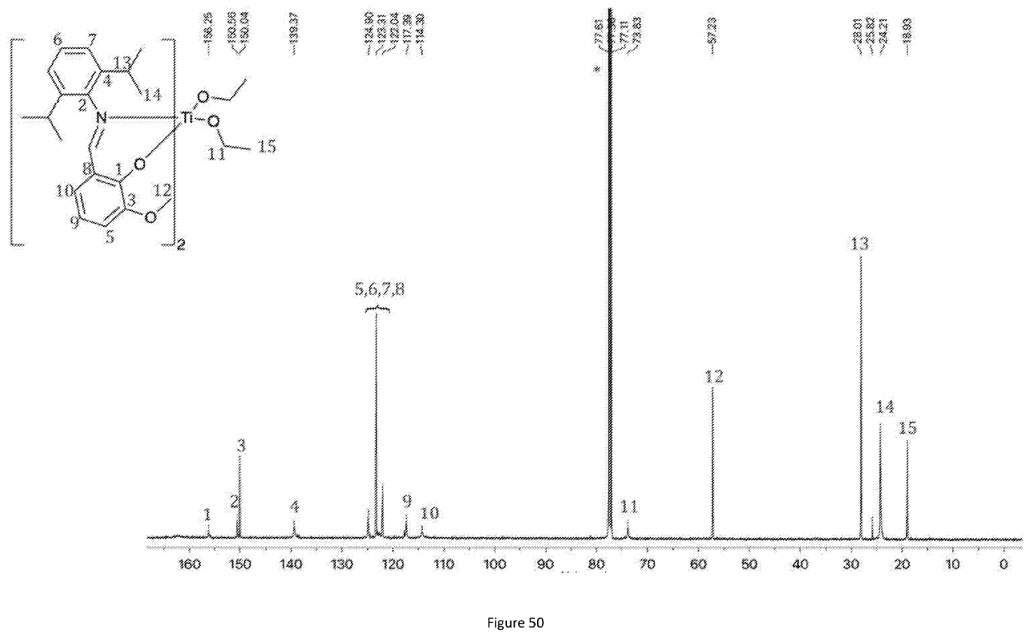

FIG. 50 shows the ¹³C{¹H} NMR spectrum of (L₄)₂Ti(OEt)₂ in CDCl₃ at 298 K.

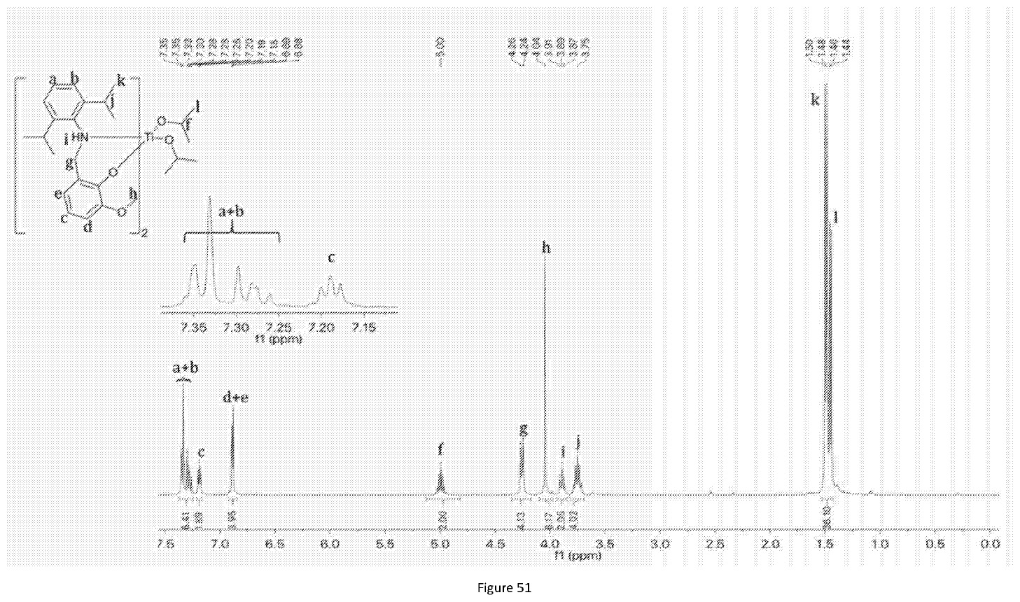

FIG. 51 shows the ¹H NMR spectrum of (L₄′)₂Ti(OⁱPO₂ in CDCl₃ at 298 K.

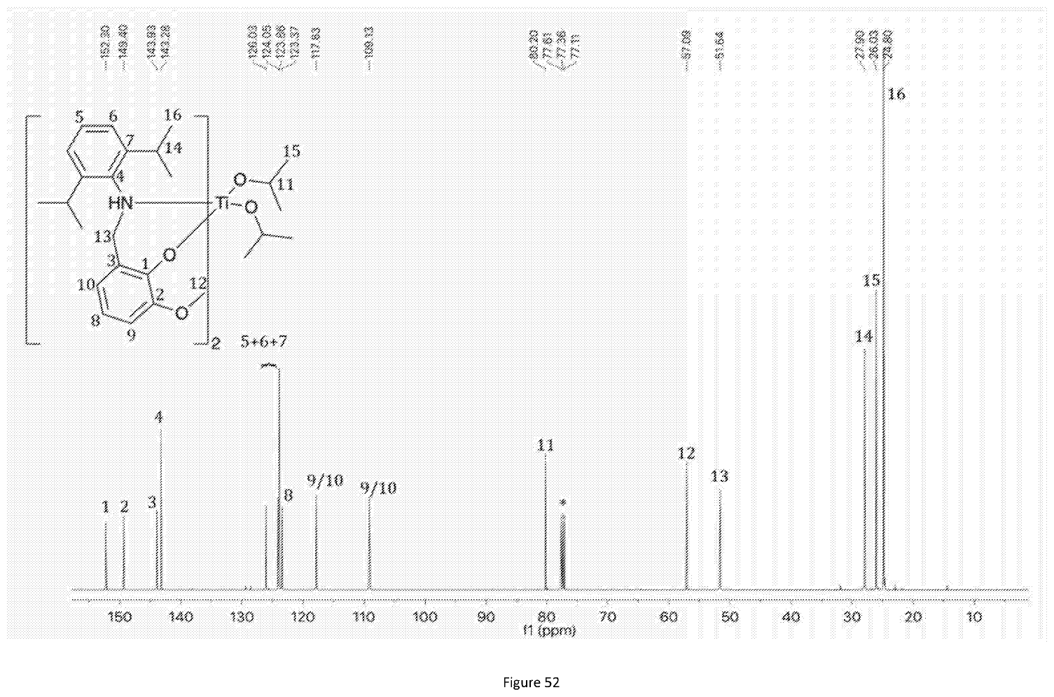

FIG. 52 shows the ¹³C{¹H} NMR spectrum of (L₄′)₂Ti(OⁱPO₂ in CDCl₃ at 298 K.

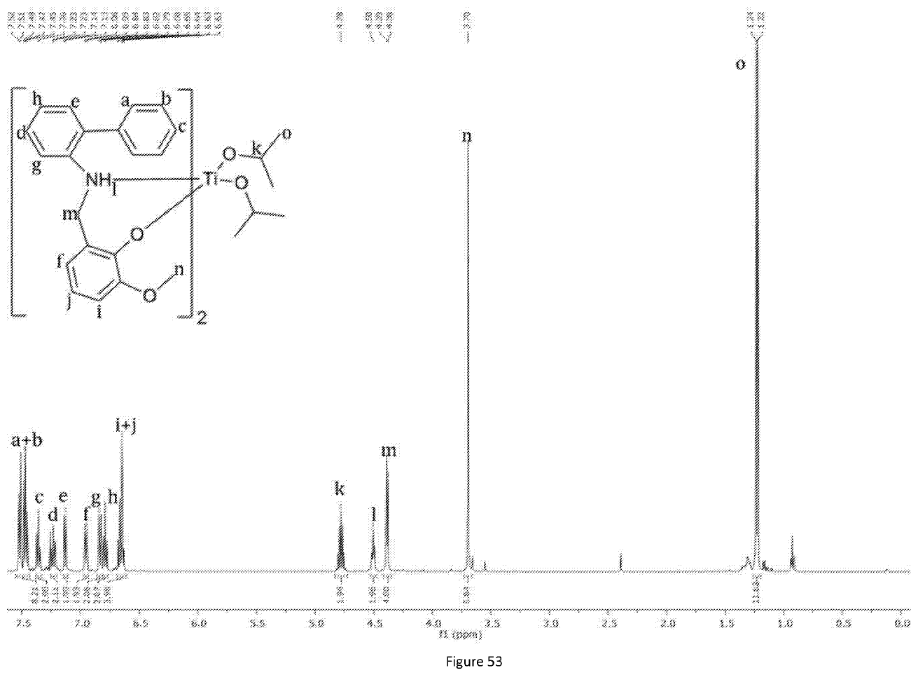

FIG. 53 shows the ¹H NMR spectrum of (L₅′)₂Ti(OⁱPr)₂ in CDCl₃ at 298 K.

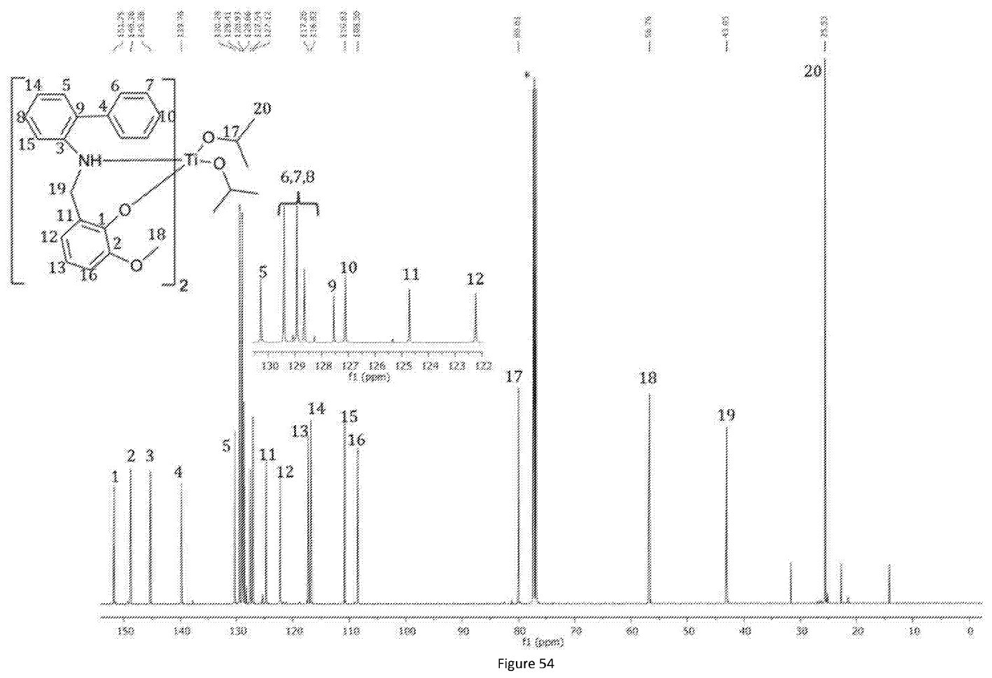

FIG. 54 shows the ¹³C{¹H} NMR spectrum of (L₅′)₂Ti(OⁱPr)₂ in CDCl₃ at 298 K.

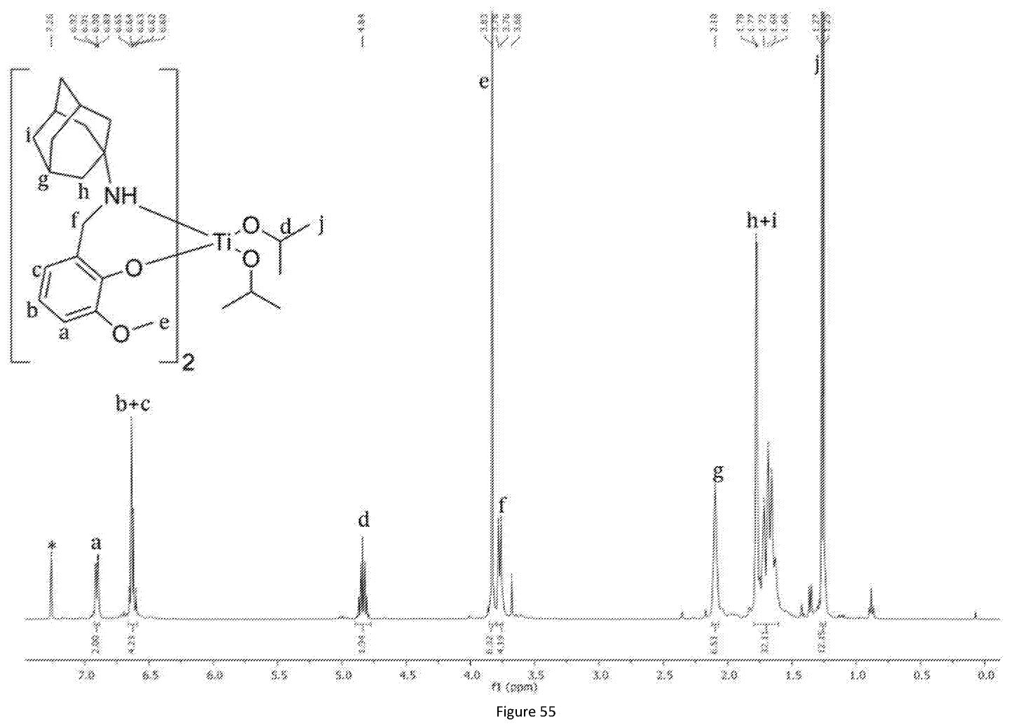

FIG. 55 shows the ¹H NMR spectrum of (L₆′)₂Ti(OⁱPO₂ in CDCl₃ at 298 K.

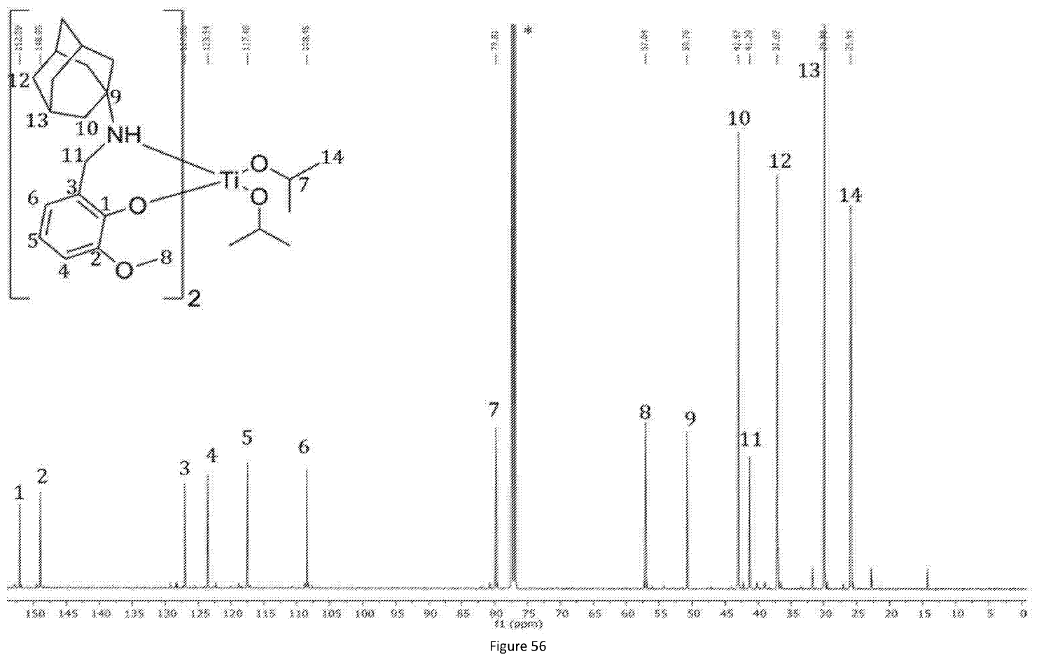

FIG. 56 shows the ¹³C{¹H} NMR spectrum of (L₆′)₂Ti(OⁱPr)₂ in CDCl₃ at 298 K.

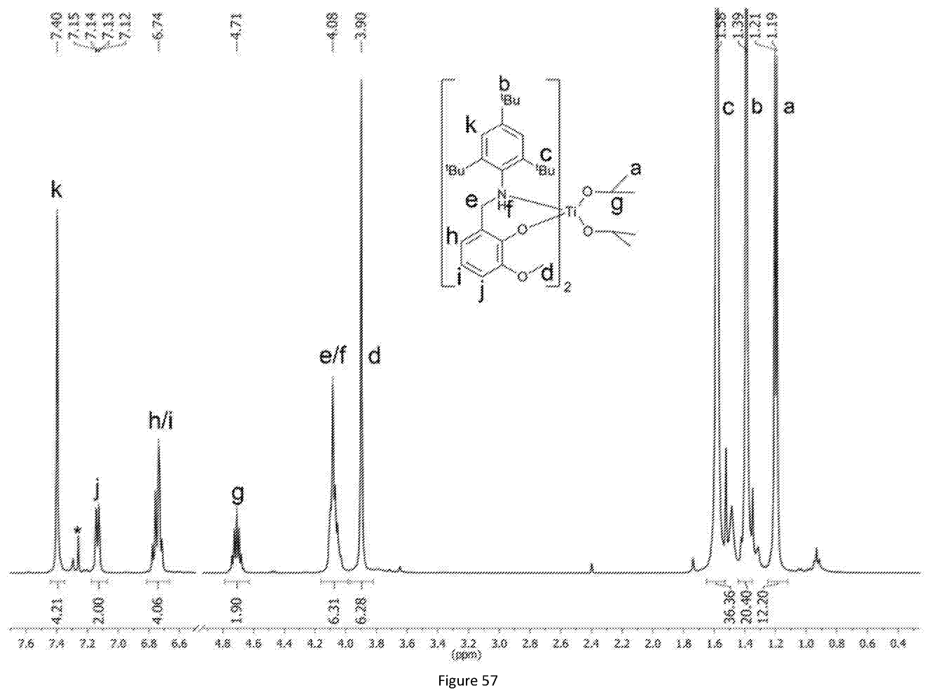

FIG. 57 shows the ¹H NMR spectrum of (L₇′)₂Ti(OⁱPr)₂ in CDCl₃ at 298 K. 400 MHz.

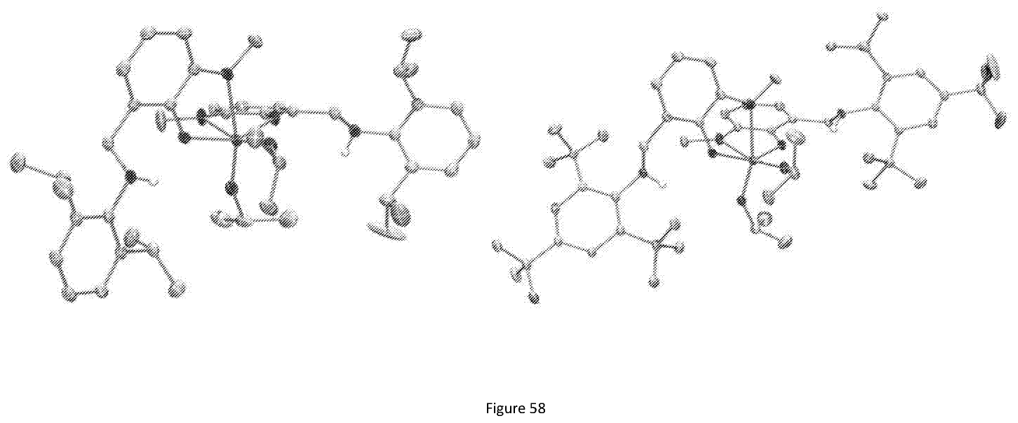

FIG. 58 shows X-ray crystal structures of (L₄′)₂Ti(OⁱPr)₂ (left) and (L₇′)₂Ti(OⁱPr)₂ (right) showing Type C coordination.

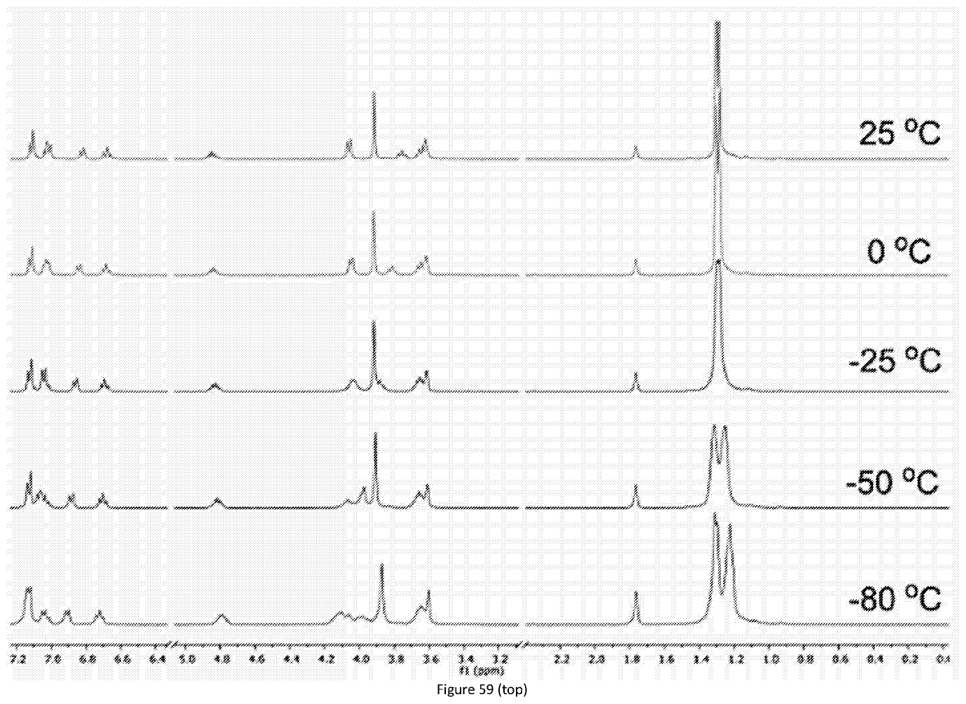

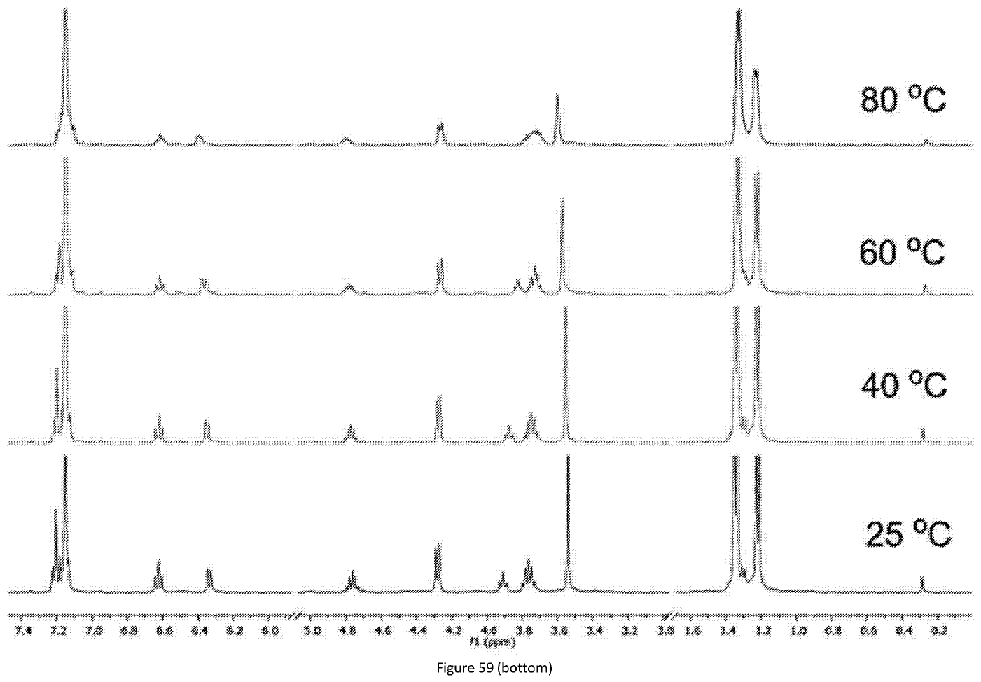

FIG. 59 shows low temperature ¹H NMR spectrum of complex (L₄′)₂Ti(OⁱPr)₂ in d⁸-THF (top) and high temperature ¹H NMR spectrum of complex (L₄′)₂Ti(OⁱPr)₂ (bottom) in C₆D₆.

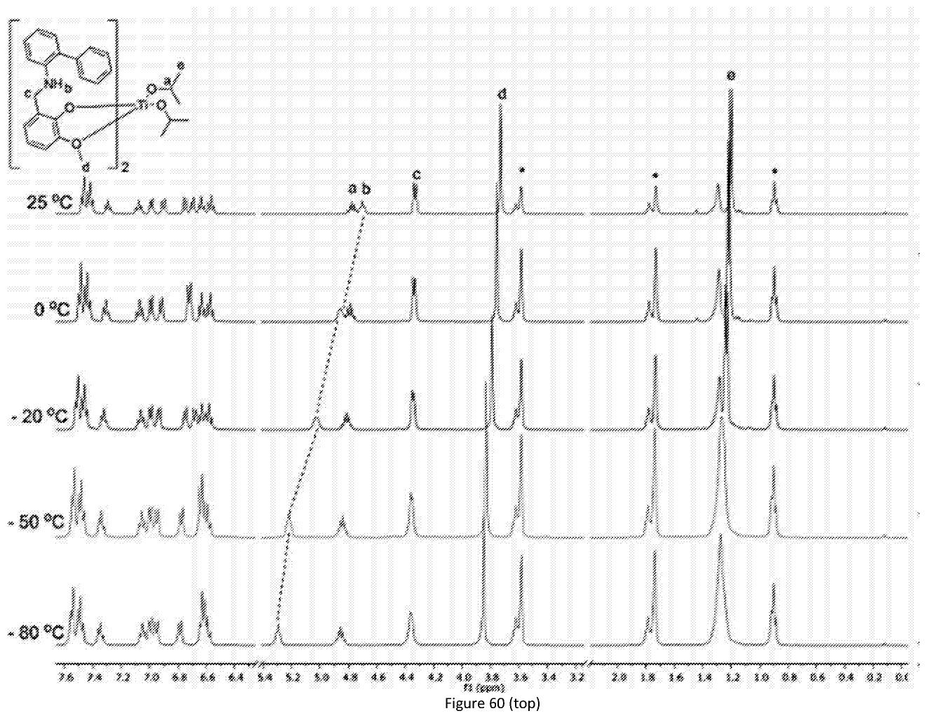

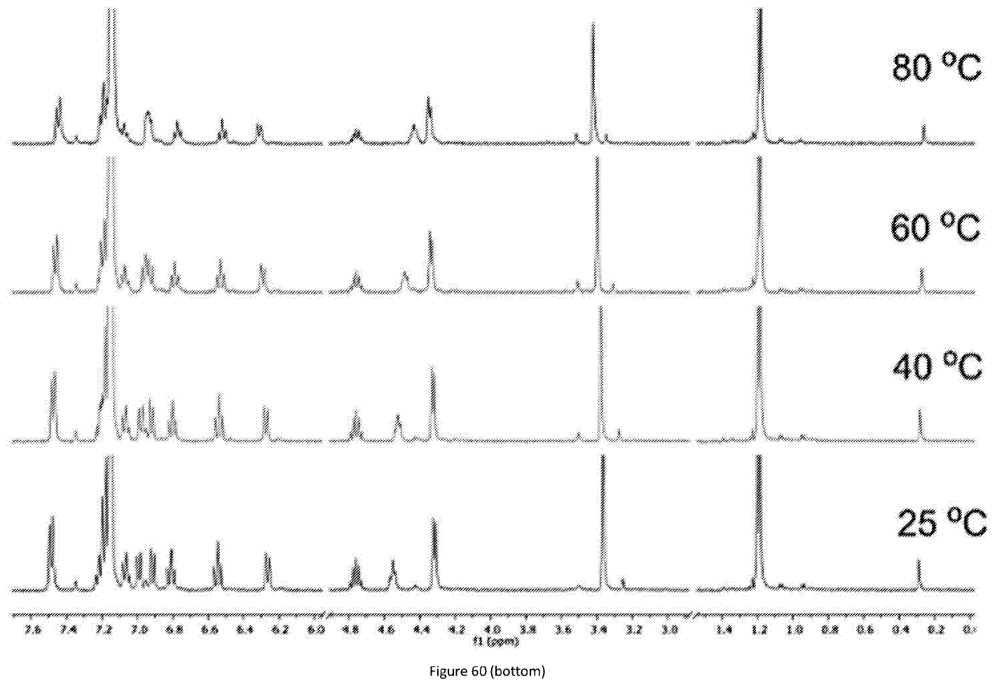

FIG. 60 shows Low temperature ¹H NMR of complex (L₅′)₂Ti(OⁱPO₂ (shown in its conjectured structure) in THF-d⁸ (* THF or hexane) (top) and high temperature ¹H NMR of complex (L₅′)₂Ti(OⁱPr)₂ in C₆D₆ (bottom).

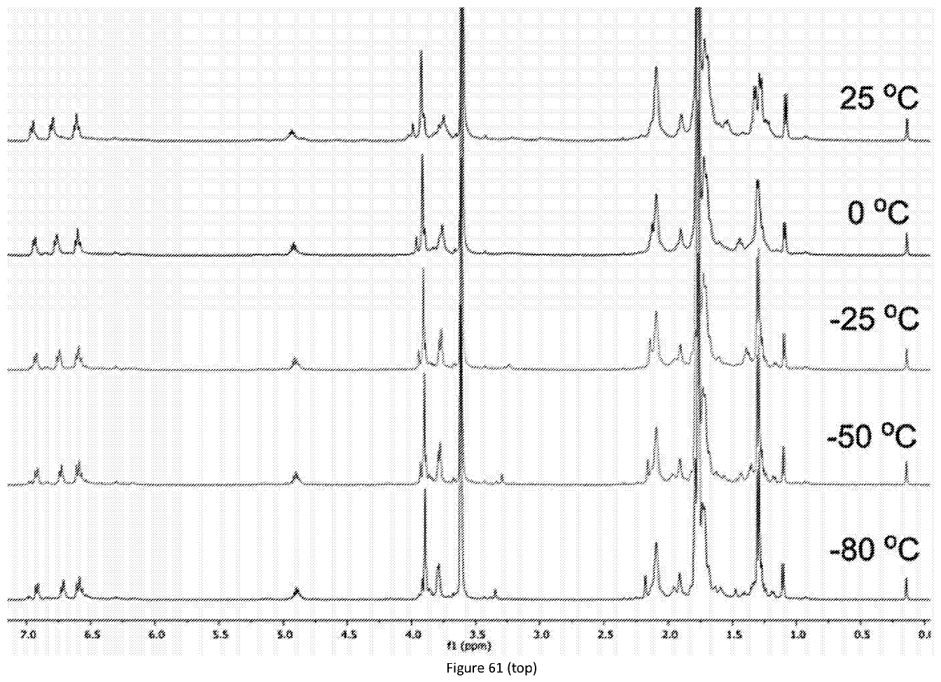

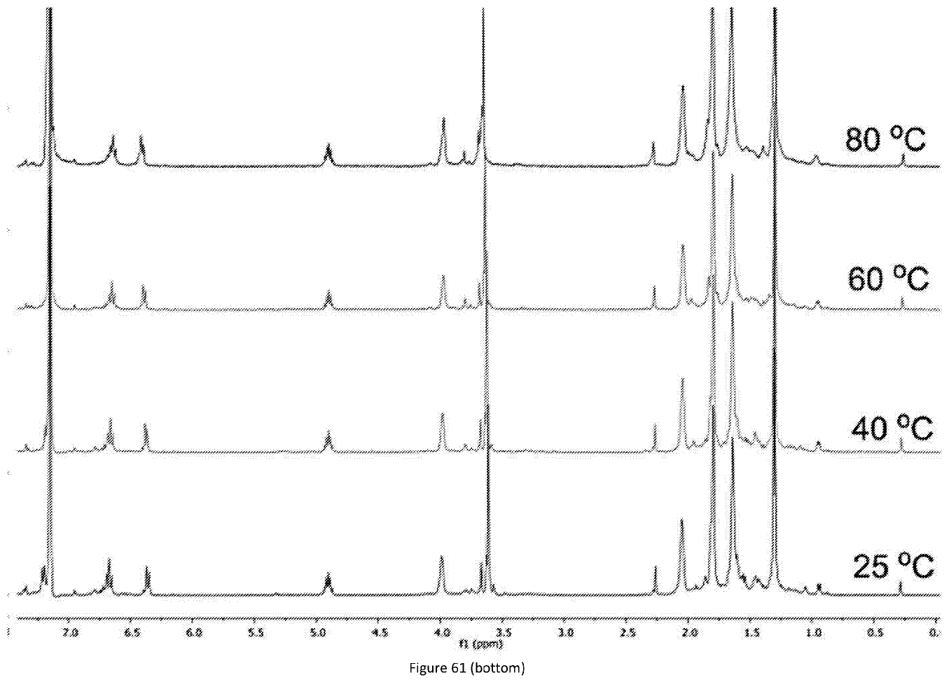

FIG. 61 shows Low temperature ¹H NMR spectrum of complex (L₆′)₂Ti(OⁱPO₂ in d⁶-THF (top) and high temperature ¹H NMR of complex (L₆′)₂Ti(OⁱPr)₂ in C₆D₆ (bottom).

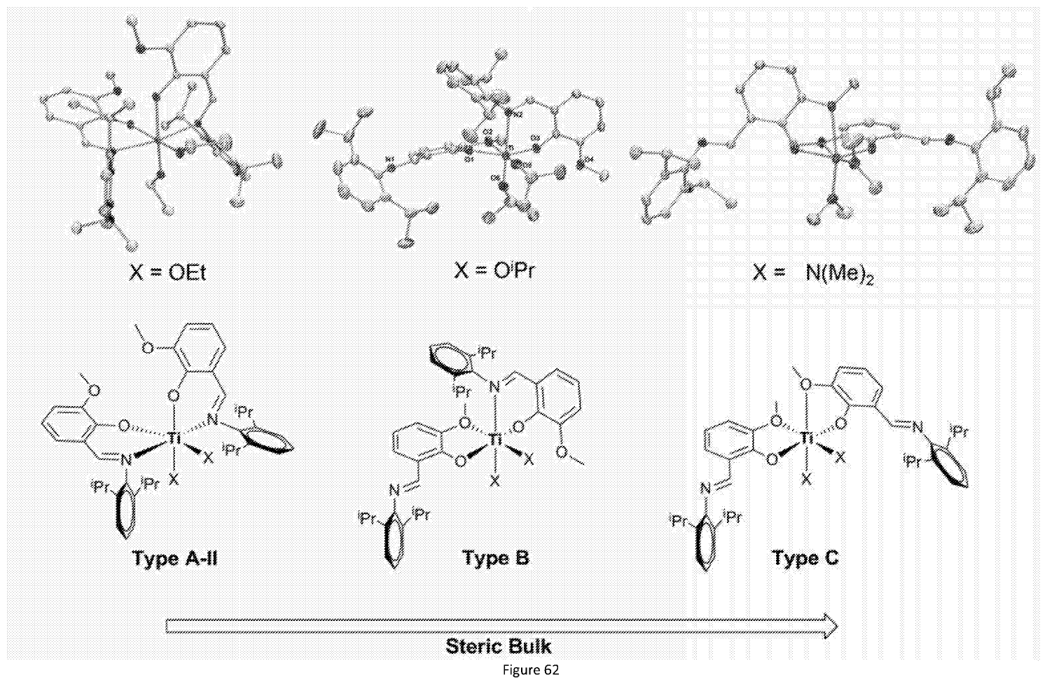

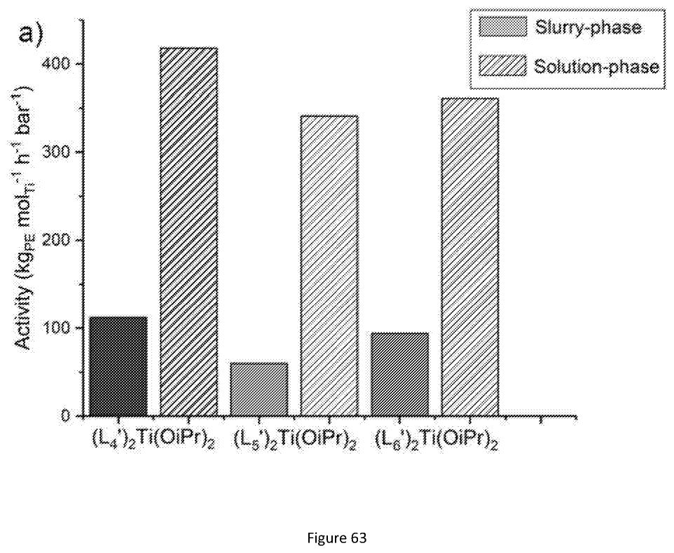

FIG. 62 shows X-ray crystal structures of (L₄)₂Ti(OEt)₂ (left), (L₄)₂Ti(OⁱPr)₂ (middle), and (L₄)₂Ti(NMe₂)₂ (right) showing the variability of coordination based on initiator.

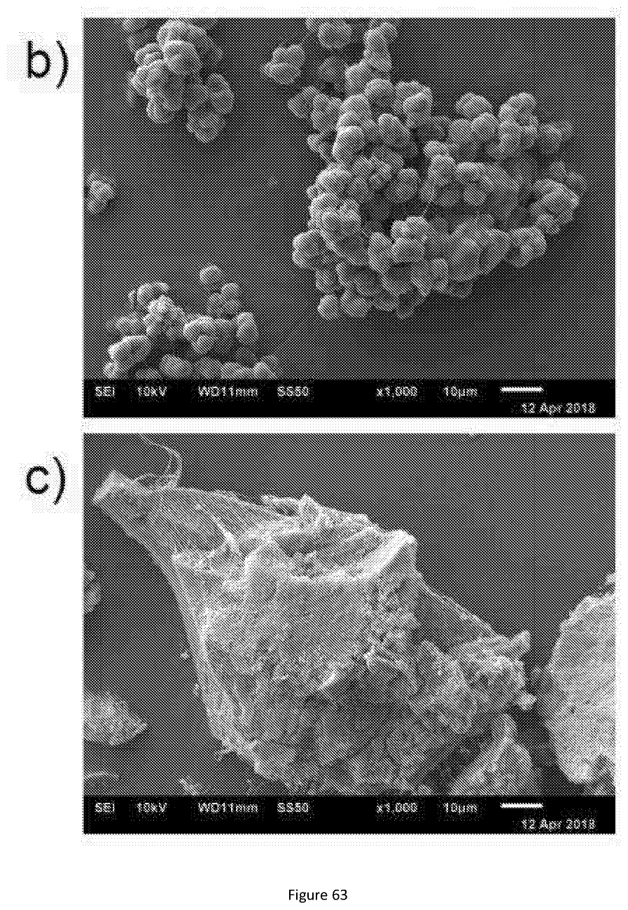

FIG. 63 shows a) ethylene polymerization activity of catalysts (L₄₋₆′)₂Ti(OⁱPO₂ in the slurry and solution phase. b) SEM of polyethylene derived from (L₄′)₂Ti(OⁱPr)₂ immobilized on sMAO. Magnification ×1000. c) SEM of polyethylene derived from (L₄′)₂Ti(OⁱPr)₂ initiated with MAO. Magnification ×1000.

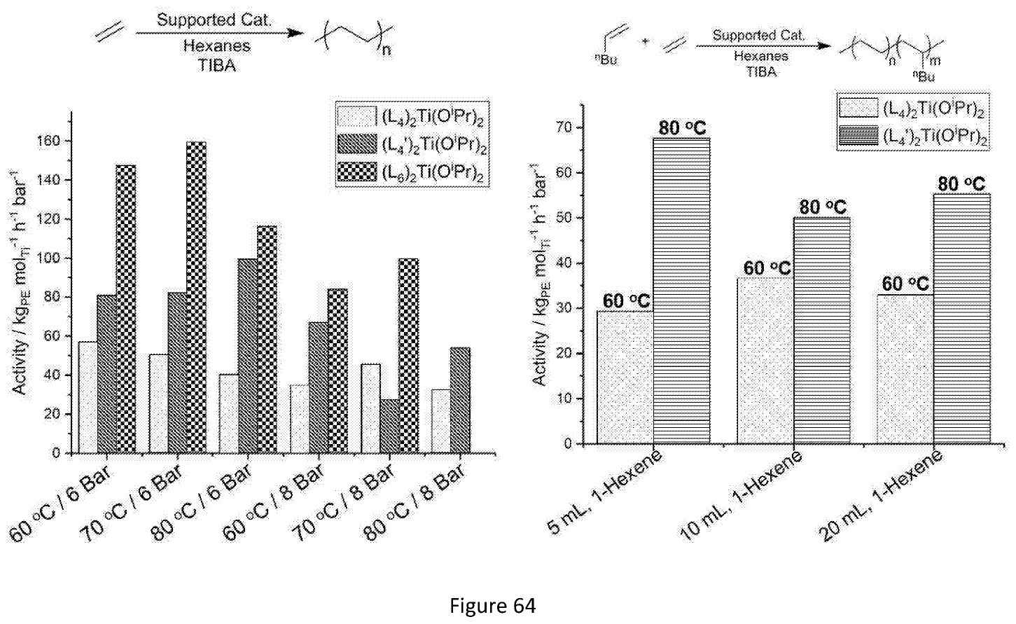

FIG. 64 shows (left) the ethylene homopolymerization activity of (L₄₋₆)₂Ti(OⁱPr)₂ and (L₄′)₂Ti(OⁱPr)₂ at various temperatures and pressures; (right) the ethylene/1-hexene copolymerization activity of (L₄)₂Ti(OⁱPr)₂ and (L₄′)₂Ti(OⁱPr)₂ at various temperatures.

### MATERIALS AND METHODS

All metal complexes were synthesized under anhydrous conditions, using MBraun gloveboxes and standard Schlenk techniques. Solvents and reagents were obtained from Sigma Aldrich or Strem and were used as received unless stated otherwise. THF and toluene were dried by refluxing over sodium and benzophenone and stored under nitrogen. All dry solvents were stored under nitrogen and degassed by several freeze-pump-thaw cycles. NMR spectra were recorded using a Bruker AV 400 or 500 MHz spectrometer. Correlation between proton and carbon atoms were obtained by COSY, HSQC, and HMBC spectroscopic methods and subsequently assigned. Elemental analysis was carried out by Mr. Stephen Boyer of the London Metropolitan University.

Crystals suitable for single crystal x-ray diffraction were grown either through slow evaporation of hexanes into THF or through low temperature crystallization in concentrated THF at −30° C. Samples were isolated in a glovebox under a pool of fluorinated oil and mounted on MiTeGen MicroMounts. The crystal was then cooled to 150 K with an Oxford Cryosystems Cryostream nitrogen cooling device. Data collection was carried out with an Oxford Diffraction Supernova diffractometer using Cu Kα (λ=1.5417 Å) or Mo Kα (λ=0.7107 Å) radiation. The resulting raw data was processed using CrysAlisPro. Structures were solved by SHELXT and Full-matrix least-squares refinements based on F² were performed in SHELXL-14¹, as incorporated in the WinGX package.² For each methyl group, the hydrogen atoms were added at calculated positions using a riding model with U(H)=1.5 Ueq (bonded carbon atom). The rest of the hydrogen atoms were included in the model at calculated positions using a riding model with U(H)=1.2 Ueq (bonded atom). Neutral atom scattering factors were used and include terms for anomalous dispersion.³

### Part A

### Example 1—Ligand Synthesis

A variety of ligands, HL₁-HL₈, were prepared according to the general synthesis depicted in Scheme 1 shown below:

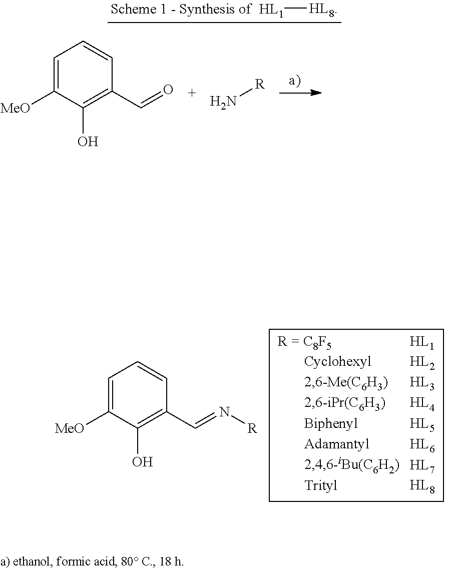

### Synthesis of HL₁

o-Vanillin (5 g, 32.9 mmol) was added to a round bottom flask and dissolved in ethanol (60 mL). 2,3,4,5,6-pentafluoroaniline (6.02 g, 32.9 mmol) was added into the stirring solution along with several drops of formic acid. This reaction mixture was refluxed for 72 hours resulting in a bright orange precipitate and a pale yellow solution. Precipitate was filtered, washed with ethanol (20 mL) and pentane (3×20 mL) and dried under vacuum. Crude product was then washed with hot ethanol (30 mL) and dried. Yield: 3.67 g (35%) ¹H NMR (400 MHz, CDCl₃) δ (ppm): 12.58 (s, 1H), 8.85 (s, 1H), 7.05 (m, 2H), 6.93 (t, 1H), 3.94 (s, 3H).

FIG. 1 shows the ¹H NMR spectrum of HL₁ in CDCl₃ at 400 MHz.

### Synthesis of HL₂

o-Vanillin (2.75 g, 18.0 mmol) was added to a round bottom flask and dissolved in ethanol (30 mL). Cyclohexylamine (1.79 g, 18.0 mmol) was syringed into the stirring solution along with several drops of formic acid. Reaction mixture was refluxed for 18 hours resulting in an orange solution. Volatiles were removed under vacuum yielding a viscus yellow oil. The oil was placed in a −30° C. freezer to solidify into a soft yellow solid. Yield: 3.85 g (91%) ¹H NMR (400 MHz, CDCl₃) δ (ppm): 8.29 (s, 1H), 6.88-6.82 (m, 2H), 6.73 (t, 1H), 3.87 (s, 3H), 3.28 (m, 1H), 1.81 (m, 4H), 1.62-1.32 (m, 6H).

FIG. 2 shows the ¹H NMR spectrum of HL₂ in CDCl₃ at 400 MHz.

### Synthesis of HL₃

o-Vanillin (3 g, 19.7 mmol) was added to a round bottom flask and dissolved in ethanol (30 mL). 2,6-dimethylaniline (2.34 g, 19.7 mmol) was syringed into the stirring solution along with several drops of formic acid. Reaction mixture was refluxed for 18 hours resulting in a yellow solution. Upon removal of several mL of ethanol under vacuum yellow solid precipitated from solution. This solid was filtered and washed with pentane (3×20 mL). The resulting dark yellow powder was dried to remove residual solvent. Yield: 3.57 g (71%) ¹H NMR (400 MHz, CDCl₃) δ (ppm): 13.5 (bs, 1H), 8.35 (s, 1H), 7.12 (m, 2H), 7.04 (m, 2H), 6.97 (m, 1H), 6.91 (t, 1H), 3.96 (s, 3H), 2.21 (s, 6H).

FIG. 3 shows the ¹H NMR spectrum of HL₃ in CDCl₃ at 400 MHz.

### Synthesis of HL₄

o-Vanillin (3 g, 19.7 mmol) was added to a round bottom flask and dissolved in ethanol (30 mL). 2,6-diisopropylaniline (3.5 g, 19.7 mmol) was syringed into the stirring solution along with several drops of formic acid. Reaction mixture was refluxed for 18 hours resulting in an orange solution. Upon cooling to room temperature copious amounts of large orange crystals formed. These crystals were filtered, washed with pentane (3×20 mL) and dried under vacuum. Yield: 5.0 g (82%) ¹H NMR (400 MHz, CDCl₃) δ (ppm): 13.5 (bs, 1H), 8.34 (s, 1H), 7.21 (m, 3H), 7.21-7.02 (m, 2H), 7.0 (t, 1H), 3.98 (s, 4H), 3.03, (sep, 2H), 1.20 (d, 12H).

FIG. 4 shows the ¹H NMR spectrum of HL₄ in CDCl₃ at 400 MHz.

### Synthesis of HL₅

o-Vanillin (5 g, 32.9 mmol) was added to a round bottom flask and dissolved in ethanol (25 mL). 2-aminobiphenyl (5.56 g, 32.9 mmol) was added to the stirring solution along with several drops of formic acid. The reaction mixture was refluxed for 24 hours resulting in a deep red solution. Volatiles were removed under vacuum. Yield: 8.06 g (81%). ¹H NMR (400 MHz, CDCl₃) δ (ppm): 12.9 (1H, bs), 8.60 (s, 1H), 7.43-7.36 (m, 8H), 7.22 (d, 1H), 6.96 (m, 2H), 6.86 (t, 1H), 3.88 (s, 3H).

FIG. 5 shows the ¹H NMR spectrum of HL₅ in CDCl₃ at 400 MHz.

### Synthesis of HL₆

o-Vanillin (3 g, 19.7 mmol) was added to a round bottom flask and dissolved in ethanol (30 mL). Adamantan-1-amine (2.98 g, 19.7 mmol) was then added to the stirring solution along with several drops of formic acid. Reaction mixture was refluxed for 20 hours resulting in an orange solution. Volatiles were removed under vacuum yielding an orange solid which was washed with pentane (20 mL×3) Yield: 3.67 g, (65%) ¹H NMR (400 MHz, CDCl₃) δ (ppm): 15.16 (bs, 1H), 8.25 (s, 1H), 6.85 (m, 2H), 6.69 (t, 1 h), 3.88 (s, 3H), 2.19 (m, 3H), 1.85 (d, 6H), 1.73 (m, 6H).

FIG. 6 shows the ¹H NMR spectrum of HL₆ in CDCl₃ at 400 MHz.

### Synthesis of HL₇

o-Vanillin (1.5 g, 9.86 mmol) was added to a round bottom flask and dissolved in ethanol (30 mL). 2,4,6-tritertbutylaniline (2.58 g, 9.86 mmol) was added into the stirring solution along with several drops of formic acid. Reaction mixture was refluxed for 18 hours resulting in an orange solution. Volatiles were removed under vacuum to yield a yellow solid which was recrystallized from hot ethanol (30 mL). The pure yellow crystalline product was washed with cold pentane (20 mL×3) and dried under vacuum. Yield: 2.8 g (71%) ¹H NMR (400 MHz, CDCl₃) δ (ppm): 13.8 (s, 1H), 8.24 (s, 1H), 7.41 (s, 2H), 7.03 (m, 1H), 6.91 (m, 2H), 3.97 (s, 3H), 1.35 (s, 9H), 1.34 (s, 18H).

FIG. 7 shows the ¹H NMR spectrum of HL₇ in CDCl₃ at 400 MHz.

### Synthesis of HL₈

o-Vanillin (1.5 g, 9.86 mmol) was added to a round bottom flask and dissolved in ethanol (30 mL). tritylamine (2.56 g, 9.86 mmol) was added into the stirring solution along with several drops of formic acid. This reaction mixture was refluxed for 24 hours resulting in a bright yellow precipitate and a pale yellow solution. Precipitate was filtered, washed with ethanol (30 mL) and pentane (3×20 mL) and dried under vacuum. Yield: 3.65 g (94%) ¹H NMR (400 MHz, CDCl₃) δ (ppm): 14.8 (s, 1H), 7.97 (s, 1H), 7.35-7.23 (m, 15H), 6.98 (dd, 1H), 6.82 (t, 1H), 6.78 (m, 1H), 3.97 (s, 3H).

FIG. 8 shows the ¹H NMR spectrum of HL₈ in CDCl₃ at 400 MHz.

### Example 2—Complex Synthesis

Using ligands HL₁-HL₈ prepared in Example 1, a variety of complexes, (Li)₂Ti(OⁱPr)₂-(L₈)₂Ti(OⁱPr)₂, were prepared according to the general synthesis depicted in Scheme 2 shown below:

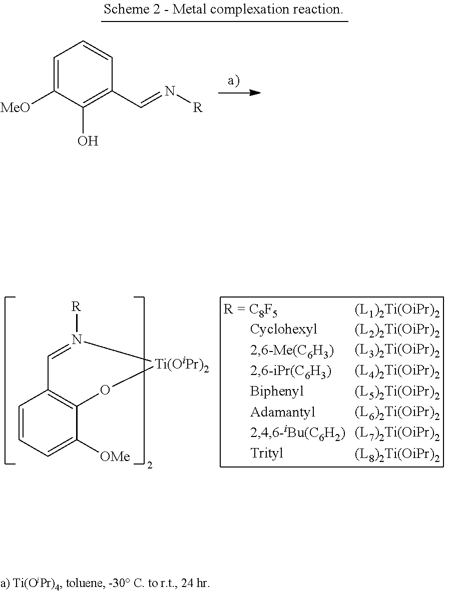

The o-vanillin derived ligands were found to possess two separate modes of coordination to the metal: 6-membered N,O coordination, and 5-membered O,O coordination. These two coordination modes were found to be independent of one another, thus the eight catalysts synthesized each exhibit one of three basic types of coordination chemistries found to be possible in these systems. Type A: N,O:N,O coordination, Type B: N,O:O,O coordination, Type C: O,O:O,O coordination. Within each type there are also additional isomers that are theoretically possible. Upon increasing steric bulk, coordination around the metal centre rearranges from: Type A-I to Type A-II, then to Type B followed by Type C. (Scheme 3).

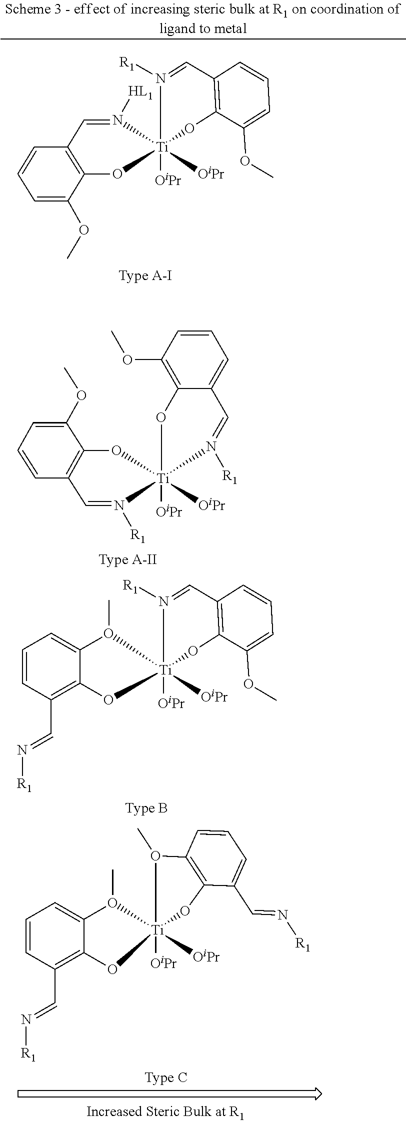

Synthesis of (Li)₂Ti(OⁱPr)₂

HL₁ (0.50 g, 1.58 mmol) and Ti(OⁱPr)₄ (0.224 g, 0.79 mmol) were dissolved separately in toluene (7 mL and 3 mL, respectively), and cooled to −30° C. in a glovebox freezer. The two solutions were then mixed and allowed to stir for 18 hours. Volatiles were removed in vacuo yielding a bright orange solid. Yield: 316 mg (50%) MALDI-TOF MS (m/z): 739.64 (calc. for [M⁺-OⁱPr=739.077]) ¹H NMR (400 MHz, CDCl₃) δ (ppm): 8.23 (bs, 2H), 7.16 (bm, 4H), 6.93 (t, 2H), 4.88 (m, 2H), 3.82 (s, 6H), 1.17 (d, 12H). ¹³C{¹H} (125 MHz, CDCl₃) δ (ppm): 171.4, 156.4, 149.5, 141.7, 139.3, 137.3, 136.4, 127.7, 126.2, 121.1, 117.3, 80.7, 56.3, 25.1 C₃₄H₂₈F₁₀N₂O₆Ti (798.45 g/mol) Calculated: C, 51.15; H, 3.53; N, 3.51%. Found: C, 51.03; H, 3.39; N, 3.66%.

FIG. 9 shows the ¹H NMR spectrum of (Li)₂Ti(OⁱPr)₂ in CDCl₃ at 400 MHz.

FIG. 10 shows the ¹³C{¹H} NMR spectrum of (Li)₂Ti(OⁱPr)₂ in CDCl₃ at 125 MHz.

FIG. 11 shows the ORTEP representation of (Li)₂Ti(OⁱPr)₂. (Li)₂Ti(OⁱPr)₂ crystallize in the centrosymmetric space group P-1 and adopt Type A-I coordination, with imine nitrogens in a cis arrangement. Due to the low steric pressure exerted around the titanium metal centre by R₁=C₆F₅ this complex prefers the coordination mode typically seen in salicylaldehyde derivatives. The coordination is reinforced by the electron deficient C₆F₅ substituent π-stacking with the adjacent Ph-OMe substituent, with an average difference between rings of 3.10 Å.

Synthesis of (L₂)₂Ti(OⁱPr)₂

HL₂ (0.30 g, 1.29 mmol) and Ti(OⁱPr)₄ (0.183 g, 0.643 mmol) were dissolved separately in toluene (15 mL and 5 mL, respectively), and cooled to −30° C. in a glovebox freezer. The two solutions were then mixed and allowed to stir for 24 hours turning from yellow to light orange. Volatiles were removed in vacuo and hexane (30 mL) was added to the resulting orange-yellow wax. Crude mixture was recrystallized from a minimum of THF in a −30° C. freezer. Crude Yield: 332 mg (82%) MALDI-TOF MS (m/z): 571.3003 (calc. for [M⁺-OⁱPr=571.2651]) ¹H NMR (400 MHz, CDCl₃) δ (ppm): 8.10 (bs, 2H), 6.87 (m, 2H), 6.81 (m, 2H), 6.67 (t, 2H), 3.86 (s, 6H), 2.07 (m, 2H), 1.85-0.88 (m, 30H), 0.36 (m, 2H). C₃₄H₅₀N₂O₆Ti (630.65 g/mol) Calculated: C, 64.75; H, 7.99; N, 4.44%. Found: C, 64.90; H, 8.05; N, 4.32%.

FIG. 12 shows the ¹H NMR spectrum of (L₂)₂Ti(OⁱPr)₂ in CDCl₃ at 400 MHz.

FIG. 13 shows the ORTEP representation of (L₂)₂Ti(OⁱPr)₂. (L₂)₂Ti(OⁱPr)₂ crystallize in the centrosymmetric space group P-1 and adopt Type A-I coordination, with imine nitrogens in a cis arrangement. Due to the low steric pressure exerted around the titanium metal centre by R₁=Cy this complex prefers the coordination mode typically seen in salicylaldehyde derivatives.

Synthesis of (L₃)₂Ti(OⁱPr)

HL₃ (0.246 g, 0.964 mmol) and Ti(OⁱPr)₄ (0.137 g, 0.482 mmol) were dissolved separately in toluene (15 mL and 5 mL, respectively), and cooled to −30° C. in a glovebox freezer. The two solutions were then mixed and allowed to stir for 24 hours. Volatiles were removed in vacuo and hexane (10 mL) was added to the resulting orange-yellow wax. This hexane was removed under vacuum to provide the final complex as a bright orange powder. Yield: 327 mg (99%). MALDI-TOF MS (m/z): 615.3101 (calc. for [M⁺-OⁱPr=615.2338]) ¹H NMR (400 MHz, CDCl₃) δ (ppm): 8.18 (s, 2H), 7.3 (m, 1H)*, 6.91-6.86 (m, 9H), 6.70 (t, 2H), 4.82 (m, 2H), 4.00 (s, 6H), 2.14 (s, 12H), 1.11 (d, 12H) ¹³C{¹H} (125 MHz, CDCl₃) δ (ppm): 156.2, 151.6, 149.5, 129.0, 128.7, 128.2, 127.6, 124.0, 121.9, 116.6, 80.1, 56.8, 25.4, 18.5 C₃₈H₄₆N₂O₆Ti (674.28 g/mol) Calculated: C, 67.65; H, 6.87; N, 4.15%. Found: C, 67.42; H, 6.89; N, 4.22%.

FIG. 14 shows the ¹H NMR spectrum of (L₃)₂Ti(OⁱPr)₂ in CDCl₃ at 400 MHz

FIG. 15 shows the ¹³C{¹H} NMR spectrum of (L₃)₂Ti(OⁱPr)₂ in CDCl₃ at 125 MHz.

FIG. 16 shows the ORTEP representation of (L₃)₂Ti(OⁱPr)₂. Upon increasing steric hindrance to form (L₃)₂Ti(OⁱPr)₂ a rearrangement is observed from Type A-I to Type A-II where imine nitrogens prefer a trans geometry. In this arrangement, steric pressure is relieved by creating space between R groups while still maintaining O,N:O,N coordination. As a result of this rearrangement, the Ti—N bond distances shorten and Ti—O distances elongate by ˜0.08 Å compared to (L₂)₂Ti(OⁱPr)₂.

Synthesis of (L₄)₂Ti(OⁱPr)

HL₄ (0.30 g, 0.946 mmol) and Ti(OⁱPr)₄ (0.137 g, 0.482 mmol) were dissolved separately in toluene (15 mL and 5 mL, respectively), and cooled to −30° C. in a glovebox freezer. The two solutions were then mixed and allowed to stir for 24 hours. Volatiles were removed in vacuo and hexane (10 mL) was added to the resulting orange-yellow wax. This hexane was removed under vacuum to provide the final complex as a bright orange powder. Yield: 176 mg (46%) MALDI-TOF MS (m/z): 727.5702 (calc. for [M⁺-OⁱPr=727.3590]) ¹H NMR (400 MHz, CDCl₃) δ (ppm): 8.59 (s, 2H), 7.67 (bs, 2H), 7.15 (m, 6H), 6.91 (d, 2H), 6.80 (t, 2H), 4.76 (m, 2H), 3.97 (s, 6H), 3.10 (bs, 4H), 1.19-1.15 (d, 38H) ¹³C{¹H} (125 MHz, CDCl₃) δ (ppm): 159.9, 155.7, 150.0, 149.6, 138.3, 122.9, 121.9, 120.9, 117.3, 112.9, 80.6, 56.9, 27.8, 25.5, 23.7. C₄₆H₆₂N₂O₆Ti (786.9 g/mol): Calculated: C, 70.22; H, 7.94; N, 3.56%. Found: C, 70.17; H, 8.02; N, 3.56%.

FIG. 17 shows the ¹H NMR spectrum of (L₄)₂Ti(OⁱPr)₂ in CDCl₃ at 400 MHz.

FIG. 18 shows the ¹³C{¹H} NMR spectrum of (L₄)₂Ti(OⁱPr)₂ in CDCl₃ at 125 MHz.

FIG. 19 shows the ORTEP representation of (L₄)₂Ti(OⁱPr)₂. (L₄)₂Ti(OⁱPr)₂ crystallizes in the chiral orthorhombic space group Pna2₁ and adopts Type B coordination with one nitrogen trans to OⁱPr and one detached, in favour of O—O coordination through the o-methoxy group. Due to the formation of a five-membered ring, the O(1)-Ti—O(2) bite angle is far more acute, at 72.92(8°), than the O(3)-Ti—N(2) bite angle, which is similar to that seen in (L₂)₂Ti(OⁱPr)₂, at 80.72(9°). Additionally, Ti—OⁱPr distances are significantly shorter than in Type A by ca. 0.05 Å, and the bound imine moiety is 0.02 Å shorter than the unbound imine, which is expected.

Synthesis of (L₅)₂Ti(OⁱPr)

HL₅ (2 g, 6.60 mmol) and Ti(OⁱPr)₄ (0.937 g, 3.30 mmol) were dissolved separately in toluene (15 mL and 5 mL, respectively), and cooled to −30° C. in a glovebox freezer. The two solutions were then mixed and allowed to stir for 24 hours. Volatiles were removed in vacuo yielding an amber solid. Crude mixture was recrystallized by layering hexanes and THF. Yield: 2.28 g (89%). MALDI-TOF MS (m/z): 712.2714 (calc. for [M⁺-OⁱPr]=711.2338) ¹H NMR (400 MHz, CDCl₃) δ (ppm): 8.36 (bs, 2H), 7.23 (m, 18H), 6.78 (bm, 2H), 6.60 (m, 2H), 4.87 (bm, 2H), 3.71 (s, 6H), 1.17 (m, 12H).

FIG. 20 shows the ORTEP representation of (L₅)₂Ti(OⁱPr)₂. (L₅)₂Ti(OⁱPr)₂ crystallizes in the centrosymmetric space group P2/n and adopts Type B coordination with one nitrogen trans to OⁱPr and one detached, in favour of O—O coordination through the o-methoxy group. Due to the formation of a five-membered ring, the O(1)-Ti—O(2) bite angle is far more acute, at 72.92(8°), than the O(3)-Ti—N(2) bite angle, which is similar to that seen in (L₂)₂Ti(OⁱPr)₂, at 80.72(9°). Additionally, Ti—OⁱPr distances are significantly shorter than in Type A by ca. 0.05 Å, and the bound imine moiety is 0.02 Å shorter than the unbound imine, which is expected.

Synthesis of (L₆)₂Ti(OⁱPr)

HL₆ (1.193 g, 3.03 mmol) and Ti(OⁱPr)₄ (0.429 g, 1.51 mmol) were dissolved separately in toluene (15 mL and 5 mL, respectively), and cooled to −30° C. in a glovebox freezer. The two solutions were then mixed and allowed to stir for 24 hours. Volatiles were removed in vacuo yielding a light yellow powder. Crude mixture was recrystallized by layering hexanes and THF. Yield: 1.29 g (90%) MALDI-TOF MS (m/z): 675.9662 (calc. for [M⁺-OⁱPr]=675.3277) ¹H NMR (400 MHz, CDCl₃) δ (ppm): 8.77 (s, 2H), 7.54 (dd, 2H), 6.72 (m, 4H), 4.90 (m, 2), 3.77 (s, 6H), 2.16 (s, 6H). 1.85 (s, 12H), 1.73 (m, 12H), 1.33 (d, 12H). ¹³C{¹H} (125 MHz, CDCl₃) δ (ppm): 154.1, 152.1, 149.3, 123.0, 120.1, 117.5, 111.1, 80.3, 57.9, 57.0, 43.4, 36.7, 29.8, 25.5.

FIG. 21 shows the ¹H NMR spectrum of (L₆)₂Ti(OⁱPr)₂ in CDCl₃ at 400 MHz.

FIG. 22 shows the ¹³C{¹H} NMR spectrum of (L₆)₂Ti(OⁱPr)₂ in CDCl₃ at 125 MHz.

FIG. 23 shows the ORTEP representation of (L₆)₂Ti(OⁱPr)₂. (L₆)₂Ti(OⁱPr)₂ crystallizes in a centrosymmetric space group and adopts Type C coordination, where steric bulk forces O,O chelation of both ligands. (L₆)₂Ti(OⁱPr)₂ shows O—Ti—O bite angles similar to those found in (L₄)₂Ti(OⁱPr)₂ at 73.67(5)° [O(1)-Ti—O(2)] and 73.99(5)° [O(3)-Ti—O(4)]. OⁱPr moieties arrange trans to the neutral OMe groups and Ti—OⁱPr distances are shorter than those found Type A and B complexes. (Table 1) Both Imine C═N bonds are ca. 1.27 Å as expected.

Synthesis of (L₇)₂Ti(OⁱPr)

HL₇ (0.40 g, 1.01 mmol) and Ti(OⁱPr)₄ (0.144 g, 0.51 mmol) were dissolved separately in toluene (7 mL and 3 mL, respectively), and cooled to −30° C. in a glovebox freezer. The two solutions were then mixed and allowed to stir for 18 hours. Volatiles were removed in vacuo yielding an orange solid. Yield: 176 mg (46%) MALDI-TOF MS (m/z): 896.6176 (calc. for [M⁺-OⁱPr]=895.5468) ¹H NMR (400 MHz, CDCl₃) δ (ppm): 8.71 (s, 2H), 7.82 (m, 2H), 7.39 (s, 4H), 6.84 (m, 4H), 4.60 (m, 2H), 3.82 (s, 6H), 1.37 (s, 36H), 1.35 (s, 18H), 1.11 (d, 12H). ¹³C{¹H} (125 MHz, CDCl₃) δ (ppm): 157.8, 155.3, 151.4, 149.9, 143.6, 138.4, 121.7, 120.7, 117.7, 111.7, 80.7, 56.9, 36.0, 34.8, 31.7 31.5, 25.5. C₅₈H₈₆N₂O₆Ti (955.20 g/mol) Calculated: C, 72.93; H, 9.08; N, 2.93%. Found: C, 72.81; H, 9.17; N, 3.12%.

FIG. 24 shows the ¹H NMR spectrum of (L₇)₂Ti(OⁱPr)₂ in CDCl₃ at 400 MHz.

FIG. 25 shows the ¹³C{¹H} NMR spectrum of (L₇)₂Ti(OⁱPr)₂ in CDCl₃ at 125 MHz.

FIG. 26 shows the ORTEP representation of (L₇)₂Ti(OⁱPr)₂. (L₇)₂Ti(OⁱPr)₂ crystallizes in a centrosymmetric space group and adopts Type C coordination, where steric bulk forces O,O chelation of both ligands. OⁱPr moieties arrange trans to the neutral OMe groups and Ti—OⁱPr distances are shorter than those found Type A and B complexes. (Table 1) Both Imine C═N bonds are ca. 1.27 Å as expected.

Synthesis of (L₈)₂Ti(OⁱPr)

HL₈ (2.04 g, 5.18 mmol) was suspended in toluene (20 mL) and THF (5 mL) and Ti(OⁱPr)₄ (0.736 g, 2.59 mmol) dissolved in toluene (5 mL) was added dropwise. The yellow suspension cleared after several minutes of stirring and allowed to react for 24 hours. Volatiles were removed in vacuo yielding a light yellow solid. Yield: 2.32 (94%) MALDI-TOF MS (m/z): 891.3367 (calc. for [M⁺-OⁱPr]=891.3277) ¹H NMR (400 MHz, CDCl₃) δ (ppm): 8.40 (s, 2H), 7.91 (dd, 2H), 7.32-7.23 (m, 30H), 6.72 (m, 4H), 4.59 (m, 2H), 3.64 (s, 6H), 1.06 (d, 12H). ¹³C{¹H} (125 MHz, CDCl₃) δ (ppm): 156.2, 154.8, 149.3, 146.4, 129.9, 127.6, 126.6, 125.3, 122.5, 120.3, 117.4, 111.1, 80.3, 78.4, 56.9, 25.5. C₆₀H₅₈N₂O₆Ti (951.00 g/mol) Calculated: C, 75.78; H, 6.15; N, 2.95%. Found: C, 75.88; H, 6.24; N, 3.03%.

FIG. 27 shows the ¹H NMR spectrum of (L₈)₂Ti(OⁱPr)₂ in CDCl₃ at 400 MHz.

FIG. 28 shows the ¹³C{¹H} NMR spectrum of (L₈)₂Ti(OⁱPr)₂ in CDCl₃ at 125 MHz.

FIG. 29 shows the ORTEP representation of (L₈)₂Ti(OⁱPr)₂. (L₈)₂Ti(OⁱPr)₂ crystallizes in a centrosymmetric space group and adopts Type C coordination, where steric bulk forces O,O chelation of both ligands. OⁱPr moieties arrange trans to the neutral OMe groups and Ti—OⁱPr distances are shorter than those found Type A and B complexes. (Table 1) Both Imine C═N bonds are ca. 1.27 Å as expected.

Using ligands HL₂ and HL₃ prepared in Example 1, complexes (L₂)₂ZrCl₂ and (L₃)₂ZrCl₂ were prepared according to the general synthesis depicted in Scheme 4 shown below

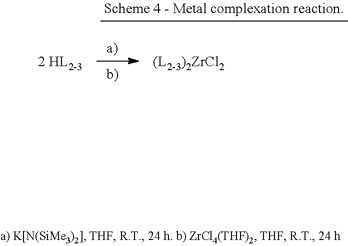

Synthesis of (L₂)₂ZrCl₂

HL₂ (0.40 g, 1.71 mmol) and K[N(SiMe₃)₂] (0.342 g, 1.71 mmol) were dissolved separately in THF (5 mL and 3 mL, respectively). The K[N(SiMe₃)₂] solution was then added dropwise to the stirring solution of ligand and allowed to react for 24 hours. ZrCl₄(THF)₂ (0.323 g, 0.857 mmol) was dissolved in THF (5 mL) and added to the deprotonated ligand. After stirring for 24 hours the resulting cloudy yellow solution was centrifuged and the solution was decanted. Volatiles were removed in vacuo and hexane (10 mL) was added to the resulting yellow wax. This hexane was removed under vacuum to provide the final complex as a light powder. MALDI-TOF MS (m/z): 589.1416 (calc. for [M⁺-Cl=589.1411]) ¹H NMR (400 MHz, CDCl₃) δ (ppm): 8.18 (s, 2H), 7.06 (m, 2H), 6.89 (t, 2H), 6.87 (m, 2H), 4.16 (m, 2H), 3.98 (s, 6H), 3.74 (m, 4H, THF), 1.85 (m, 4H, THF), 1.59-1.07 (bm, 20H). Calculated: C, 53.66; H, 5.79; N, 4.47%. C, 53.78; H, 5.80; N, 4.31%.

FIG. 30 shows the ¹H NMR spectrum of (L₂)₂ZrCl₂ in CDCl₃ at 400 MHz.

Synthesis of (L₃)₂ZrCl₂

HL₃ (0.246 g, 0.964 mmol) and K[N(SiMe₃)₂] (0.192 g, 0.964 mmol) were dissolved separately in THF (5 mL and 3 mL, respectively). The K[N(SiMe₃)₂] solution was then added dropwise to the stirring solution of ligand and allowed to react for 24 hours. ZrCl₄(THF)₂ (0.182 g, 0.482 mmol) was dissolved in THF (5 mL) and added to the deprotonated ligand. After stirring for 24 hours the resulting cloudy yellow solution was centrifuged and the solution was decanted. Volatiles were removed in vacuo and hexane (10 mL) was added to the resulting yellow wax. This hexane was removed under vacuum to provide a light powder, which could be recrystallized by layering of hexanes and THF. Yield: 0.282 mg, 87.3%. MALDI-TOF MS (m/z): 633.1627 (calc. for [M⁺-Cl=633.1098]) ¹H NMR (400 MHz, CDCl₃) δ (ppm): 8.33 (s, 2H), 7.09 (m, 6H), 7.06 (d, 2H), 7.0 (d, 2H), 6.90 (t, 2H), 3.78 (s, 6H), 2.45 (s, 12H).

FIG. 31 shows the ¹H NMR spectrum of (L₃)₂ZrCl₂ in CDCl₃ at 400 MHz.

### Example 3—Crystallographic Studies

Table 1 below provides a summary of the T—O distances in complexes (L₁)₂Ti(OⁱPr)₂-(L₈)₂Ti(OⁱPr)₂.

TABLE 1
Summary of T—O distances in complexes (L₁)₂Ti(OⁱPr)₂-(L₈)₂Ti(OⁱPr)₂

| Compound | Ti—OⁱPr(1) Dist. (Å) | Ti—OⁱPr(2) Dist. (Å) | Coordination Type |
|---|---|---|---|
| (L₁)₂Ti(OⁱPr)₂ | 1.847(2) | 1.834(2) | A-I |
| (L₂)₂Ti(OⁱPr)₂* | 1.77 | 1.81 | A-I |
| (L₃)₂Ti(OⁱPr)₂ | 1.795(1) | 1.803(1) | A-II |
| (L₄)₂Ti(OⁱPr)₂ | 1.77 | 1.786(2) | B |
| (L₅)₂Ti(OⁱPr)₂ | 1.787(1) | 1.800(1) | B |
| (L₆)₂Ti(OⁱPr)₂ | 1.760(2) | 1.785(2) | C |
| (L₅)₂Ti(OⁱPr)₂ | 1.758(2) | 1.776(2) | C |
| (L₈)₂Ti(OⁱPr)₂ | 1.774(2) | 1.780(2) | C |

*An average is given between the two enantiomers in the asymmetric unit

Table 2 below provides select crystallographic details for (L₁)₂Ti(OⁱPr)₂-(L₄)₂Ti(OⁱPr)₂.

TABLE 2
Select crystallographic details for (L₁)₂Ti(OⁱPr)₂-(L₄)₂Ti(OⁱPr)₂

| Compound | (L₁)₂Ti(OⁱPr)₂ | (L₂)₂Ti(OⁱPr)₂ | (L₃)₂Ti(OⁱPr)₂ | (L₄)₂Ti(OⁱPr)₂ |
|---|---|---|---|---|
| Chemical formula | C₃₄H₂₈F₁₀N₂O₆Ti | C₃₇H₅₇N₂O₆Ti | C₃₈H₄₅N₂O₆Ti | C₄₆H₆₂N₂O₆Ti |
| Formula weight | 798.48 | 673.74 | 674.67 | 786.87 |
| Temp (K.) | 150(2) | 150(2) | 150(2) | 150(2) |
| Space group | Triclinic, P-1 | Triclinic, P-1 | Triclinic, P-1 | Orthorhombic, Pna2₁ |
| a (Å) | 13.7054(3) | 10.9569(3) | 10,2329(3) | 23,3761(6) |
| b (Å) | 14.1810(4) | 13.4552(4) | 10.4196(2) | 13.2107(3) |
| c (Å) | 19.1110(5) | 14.3513(4) | 19.4022(5) | 14.8217(4) |
| α(°) | 10.121(2) | 103.976(3) | 79.916(2) | |
| β(°) | 102.985(2) | 105.967(2) | 79.672(2) | |
| γ(°) | 91.205(2) | 109.032(3) | 66,375(2) | |
| V (A³) | 3379.78(16) | 1790.69(10) | 1756.99(8) | 4577.2(2) |
| Z | 4 | 2 | 2 | 4 |
| D_{calcd} (Mg/m³) | 1.570 | 1.250 | 1.275 | 1.142 |
| Crystal size (mm) | 0.27 × 0.20 × 0.08 | 0.25 × 0.20 × 0.06 | 0.25 × 0.25 × 0.15 | 0.25 × 0.15 × 0.08 |
| Theta range for data collection (°) | 3.655 to 76.329 | 3.732 to 76.089 | 4.663 to 76.178 | 3.843 to 76.405 |
| μ(mm⁻¹) | (Cu, Kα) 3,093 | (Cu, Kα) 2.394 | (Cu, Kα) 2.449 | (Cu, Kα) 1.944 |
| Reflections collected | 51454 | 26538 | 38003 | 51906 |
| Unique reflections | 13998 [Rᵢₙₜ = 0.0293] | 7376 [Rᵢₙₜ = 0.0365] | 7295 [Rᵢₙₜ = 0.0276] | 8674 [Rᵢₙₜ = 0.0605] |
| Data Completeness to [θ] | 100.0% [67.684] | 100.0% [67.684] | 100.0% [67.684] | 100.0% [67.684] |
| Data/restraints/parameters | 13998/12/979 | 7376/0/422 | 7295/0/434 | 8674/45/533 |
| R1^{a} (%) (all data) | 3.00 (3.50) | 4.44 (5.22) | 3.04 (3.21) | 4.20 (4.60) |
| wR₂^{b} (%)(all data) | 7.75 (8.07) | 12.55 (13.38) | 8.41 (8.55) | 10.70 (11.36) |
| Goodness-of-fit on F² | 1.025 | 1.062 | 1.047 | 1.025 |
| Largest diff peak and hole (e Å⁻³) | 0.334 and −0.380 | 1.187 and −0.411 | 0.254 and −0.379 | 0.396 and −0.409 |

^{a}R1 = Σ∥Fₒ| − |F_{c}∥/Σ|Fₒ| × 100
^{b}wR2 = [Σw(Fₒ² − F_{c}²)²/Σ(w|Fₒ|²)²]^{1/2} × 100

Table 3 below select crystallographic details for (L₅)₂Ti(OⁱPr)₂-(L₈)₂Ti(OⁱPr)₂,

TABLE 3
Select crystallographic details for (L₅)₂Ti(OⁱPr)₂-(L₈)₂Ti(OⁱPr)₂

| Compound | (L₅)₂Ti(OⁱPr)₂ | (L₆)₂Ti(OⁱPr)₂ | (L₇)₂Ti(OⁱPr)₂ | (L₈)₂Ti(OⁱPr)₂ |
|---|---|---|---|---|
| Chemical formula | C₄₆H₄₆N₂O₆Ti | C₄₂H₅₈N₂O₆Ti | C₆₆H₁₀₂N₂O₆Ti | C₆₃H₆₅N₂O₆Ti |
| Formula weight | 770.75 | 734.80 | 1099.39 | 994.07 |
| Temp (K.) | 150( ) | 150(2) | 150(2) | 150(2) |
| Space group | Monoclinic, P2₁/n | Monoclinic, P2₁/c | Monoclinic, P2₁/c | Triclinic, P-1 |
| a (Å) | 16.0712(4) | 22.6717(4) | 19,6212(3) | 9.3703(5) |
| b (Å) | 9.9873(2) | 14.4902(2) | 17.3312(3) | 16.9578(10) |
| c (Å) | 25.2051(5) | 12.0146(2) | 19.3123(3) | 18.9044(15) |
| α(°) | | | | 67.887(7) |
| β(°) | 94.390(2) | 91.2620(2) | 95.4930(10) | 86.252(5) |
| γ(°) | | | | 75.730(5) |
| V (A³) | 4033.75(15) | 3946.05(11) | 6537.16(18) | 2695.8(3) |
| Z | 4 | 4 | 4 | 2 |
| D_{calcd} (Mg/m³) | 1.269 | 1.237 | 1.117 | 1.225 |
| Crystal size (mm) | 0.30 × 0.15 × 0.08 | 0.25 × 0.25 × 0.18 | 0.25 × 0.22 × 0.15 | 0.25 × 0.20 × 0.06 |
| Theta range for data collection (°) | 3.517 to 76.264 | 3.620 to 76.238 | 3.434 to 76.282 | 3.307 to 30.439 |
| μ(mm⁻¹) | (Cu, Kα) 2.205 | (Cu, Kα) 2.218 | (Cu, Kα) 1.510 | (Mo, Kα) 0.212 |
| Reflections collected | 25780 | 36803 | 50743 | 27281 |
| Unique reflections | 8359 [Rᵢₙₜ = 0.0293] | 8213 [Rᵢₙₜ = 0.0305] | 13570 [Rᵢₙₜ = 0.0336] | 13947 [Rᵢₙₜ = 0.0600] |
| Data Completeness to [θ] | 100.0% [67.684] | 100.0% [67.684] | 100.0% [67.684] | 99.7% [25.000] |
| Data/restraints/parameters | 8359/0/502 | 8213/26/496 | 13570/167/846 | 13947/96/734 |
| R1^{a} (%) (all data) | 3.53 (4.41) | 4.58 (5.03) | 4.85 (6.08) | 7.33 (16.83) |
| wR₂^{b} (%)(all data) | 8.84 (9.48) | 12.53 (12.99) | 13.59 (14.69) | 11.65 (14.90) |
| Goodness-of-fit on F² | 1.020 | 1.028 | 1.039 | 1.003 |
| Largest diff peak and hole (e Å⁻³) | 0.259 and −0.334 | 0.733 and −0.476 | 0.454 and −0.524 | 0.324 and −0.396 |

^{a}R1 = Σ∥Fₒ| − |F_{c}∥/Σ|Fₒ| × 100
^{b}wR2 = [Σw(Fₒ² − F_{c}²)²/Σ(w|Fₒ|²)²]^{1/2} × 100

### Example 4—NMR Studies

Evidence of different isomers in solution can be seen by following the ¹H NMR spectra of each type. For (Li)₂Ti(OⁱPr)₂, which has Type A-I coordination, the imine CH resonance shifts up field by 0.67 ppm, relative to the parent ligand, and broadens significantly. (FIG. 32) (L₄)₂Ti(OⁱPr)₂ which adopts Type B coordination shows a single CH imine peak shifted 0.25 ppm downfield from the parent ligand, along with a slight broadening. (FIG. 33) Broadening is likely due to the rapid conversion between A and A enantiomers, along with fluxionality between the two asymmetrically bound ligands, vida infra. This rapid conversion has been seen previously in similar systems and can be frozen out by variable temperature NMR. Broadening can also be seen in the aryl ⁱPr resonance at ˜3 ppm which suggests restricted rotation of these groups in solution. (L₆-L₈)₂Ti(OⁱPr)₂ adopt the third conformation, Type C, where both ligands are O—O chelated, and they all display the same gross features in their ¹H NMR. In each case the imine CH resonance shifts significantly down field by ca. 0.5 ppm, while the OMe resonance shifts up field from the parent ligand. (FIG. 34)

### Example 5—Variable Temperature NMR

To better understand the nature of intermediate case of Type B catalysts, variable temperature NMR experiments were undertaken on (L₄)₂Ti(OⁱPr)₂. As Type B coordination shows both N,O and O,O chelation, but only shows a single imine resonance, it was necessary to confirm that the asymmetry observed in the solid state structure remains in solution. (FIG. 35) Upon cooling (L₄)₂Ti(OⁱPr)₂ from room temperature to −80° C. the imine resonance at ˜8.6 ppm broadened and split into two peaks at ˜8.75 and 8.3 ppm. These two peaks correlate to the individual imine resonance on the O,N and O,O bound ligands. Additionally, the ppm value of the O,N imine resonance correlates closely with that seen in Type A complexes, ˜8.3 ppm, while the ppm value of the O,O resonance correlates to that seen in Type C complexes, ˜8.7 ppm. This indicates that the Type B coordination is retained in solution, and at room temperature signals are averaged due to dynamic exchange between ligands.

Upon heating (L₄)₂Ti(OⁱPr)₂ in d²-1,1,2,2-tetrachloroethane (TCE) incrementally from room temperature to 100° C., peaks sharpened slightly but did not shift (FIG. 36). Additionally, after being held at this temperature for 24 hours, the ¹H NMR of (L₄)₂Ti(OⁱPr)₂ showed no discernible change. There was also no change in the ¹H NMR after heating at 70° C. in d⁸-THF for five hours. This resilience at high temperature indicates that the molecule retains its structure under reaction conditions in both coordinating and non-coordinating solvent.

### Example 6—Catalyst Immobilisation

In a glovebox, sMAO (40.2 wt. % Al, 200 mg) and the desired catalyst (1.49×10⁻⁵ mmol) were added to a Schlenk flask. Toluene (40 mL) was then added and the slurry was heated at 60° C. for one hour with occasional stirring by hand. The suspension was allowed to settle for several hours at room temperature and the toluene was decanted by cannula. Finally, the resulting powder was dried under high vacuum for several hours to yield the final immobilized catalysts as pale yellow powder.

### Example 7—Polymerisation Studies

### Ethylene Polymerisation

The standard conditions for carrying out the ethylene polymerisation process were as follows: In a glovebox, the immobilized catalyst (10 mg) was weighed into a thick walled ampule, along with triisobutylaluminum (TIBA, 150 mg), and hexane (50 mL). The ampule was then cycled on to a Schlenk line and the N₂ atmosphere was partially removed under vacuum. The slurry was heated to the desired temperature and stirred vigorously prior to the addition of ethylene at 2 bar. After the desired time had elapsed, the ampule was removed from heat and ethylene was removed from the system under vacuum and replaced with N₂. The resulting polymer was filtered, washed several times with pentane, and dried.

The polymerisation results are presented in Table 4 below:

TABLE 4
Ethylene polymerisation using selected (Lₓ)₂Ti(OⁱPr)₂catalysts

| | | Temp | Yield | | Coordination |
|---|---|---|---|---|---|
| Entry | Catalyst ^{a} | (° C.) | (mg) | Activity^{b} | Type |
| 1 | (L₅)₂Ti(OⁱPr)₂ | 80 | 24 | 64 | B |
| 2 | (L₈)₂Ti(OⁱPr)₂ | 80 | 47 | 127 | C |
| 3 | (L₈)₂Ti(OⁱPr)₂* | 80 | 53 | 143 | C |
| 4 | (L₈)₂Ti(OⁱPr)₂ | 50 | 35 | 94 | C |

^{a}200:1 Al:Ti, sMAO, 10 mg supported catalyst, 150 mg TIBA, 50 mL hexane, 2 bar ethylene, 30 m
^{b}Calculated as (kg PE/mol catalyst × time)
*Duplicate run.

The results presented in Table 4 illustrate that the compounds of formula (I-A), (I-B) and (I-C) are effective in the polymerisation of olefins such as ethylene.

### Part B

### Example 8—Ligand Synthesis

### Amine Ligands

Following the formation of imine ligands previously described (L₁₋₈) a reduction with excess NaBH₄ could be performed to yield amine ligands (La). These ligands were characterized through ¹H and ¹³C{¹H} NMR.

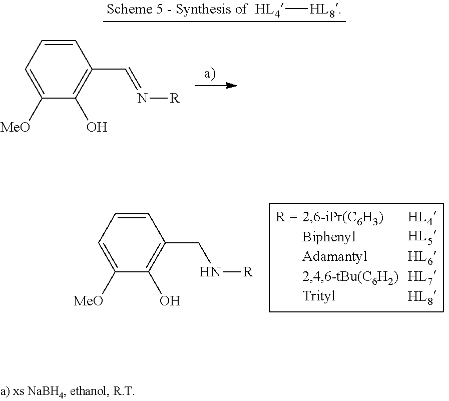

### Synthesis of HL₄′

2 equivalents of NaBH₄ (0.49 g, 12.84 mmol) were slowly added to HL₄ (2.00 g, 6.42 mmol) dissolved in ethanol (20 mL), and the solution was stirred for 2 hours, until it turned from yellow to colourless. Water (10 mL) was added dropwise to the flask at 0° C. causing a white precipitate to form. Concentrated HCl was added dropwise until a neutral pH was obtained. The reaction was left without stirring for an hour, then the solid was filtered, washed with cold water, and dried in a vacuum oven at 40° C. Isolated Yield: 1.91 g, 6.08 mmol, 95%. ¹H NMR (400 MHz, CDCl₃) δ (ppm): 9.10 (s, 1H), 7.16 (s, 3H), 6.88-6.87 (d, 1H), 6.83 (t, 1H), 6.77-6.75 (d, 1H), 4.13 (s, 2H), 3.93 (s, 3H), 3.62 (bs, 1H), 3.35 (septet, 2H), 1.29-1.27 (d, 12H). ¹³C{¹H} NMR (125 MHz, CDCl₃) δ (ppm): 148.0, 146.2, 143.1, 141.3, 125.4, 124.0, 123.9, 121.0, 119.5, 110.9, 56.1, 54.4, 28.1, 24.5.

FIG. 40 shows the ¹H NMR spectrum of HL₄′ in CDCl₃, 400 MHz.

FIG. 41 shows the ¹³C{¹H} NMR spectrum of HL₄′ in CDCl₃, 400 MHz.

### Synthesis of HL₅′

4 equivalents of NaBH₄ (0.50 g, 13.19 mmol) were slowly added to HL₅ (1.00 g, 3.30 mmol) which was partially dissolved in ethanol (20 mL), and the reaction was stirred for 3 hours, until the solution turned colourless. Water (40 mL) was added slowly to the flask at 0° C., and was left without stirring overnight, producing a small amount of off-white aggregated solid. The liquid was decanted off and recrystallised from ethanol to give a solid which was washed with pentane and dried under vacuum. Isolated Yield: 0.71 g, 2.32 mmol, 71%.¹H NMR (400 MHz, CDCl₃) δ (ppm): 7.47-7.43 (m, 4H), 7.39-7.34 (m, 1H), 7.24-7.20 (td, 1H), 7.13-7.11 (dd, 1H), 6.87-6.79 (m, 5H), 6.38 (s, 1H), 4.44 (bs, 1H), 4.39-4.38 (m, 2H), 3.89 (s, 3H). ¹³C{¹H} NMR (125 MHz, CDCl₃) δ (ppm): 146.7, 144.9, 144.0, 139.4, 130.2, 129.4, 128.9, 128.7, 128.5, 127.3, 124.5, 120.7, 119.5, 117.7, 111.6, 109.8, 56.0, 44.1.

FIG. 42 shows the ¹H NMR spectrum of HL₅′ in CDCl₃, 400 MHz.

FIG. 43 shows the ¹³C{¹H} NMR spectrum of HL₅′ in CDCl₃, 400 MHz.

### Synthesis of HL₆′

2 equivalents of NaBH₄ (0.66 g, 17.52 mmol) were slowly added to HL₆ (2.50 g, 8.76 mmol) dissolved in ethanol (30 mL), and the reaction was stirred for 2 hours, until the solution turned colourless, and a white precipitate appeared. Water (20 mL) was added dropwise to the flask at 0° C. without stirring. The solid formed was filtered, washed with cold water and dried under vacuum. Isolated Yield: 2.20 g, 7.66 mmol, 87%.¹H NMR (400 MHz, CDCl₃) δ (ppm): 6.79-6.77 (m, 1H), 6.72 (t, 1H), 6.60-6.59 (m, 1H), 3.99 (s, 2H), 3.86 (s, 3H), 2.10 (bs, 3H), 1.72-1.60 (m, 12H). ¹³C{¹H} NMR (125 MHz, CDCl₃) δ (ppm): 148.4, 147.9, 124.0, 119.9, 118.3, 110.6, 55.9, 51.3, 43.9, 42.1, 36.5, 29.4.

FIG. 44 shows the ¹H NMR spectrum of HL₆′ in CDCl₃, 400 MHz.

FIG. 45 shows the ¹³C{¹H} NMR spectrum of HL₆′ in CDCl₃, 400 MHz.

### Synthesis of HL₇′

12 equivalents of NaBH₄ (1.15 g, 37.83 mmol) were added to HL₇ (1 g, 2.5 mmol) dissolved in ethanol (30 mL), over the course of 8 hours, until the solution turned colourless. The next day water (60 mL) was added to the flask at 0° C. without stirring. The solid formed was filtered, washed with cold water and dried under vacuum. Isolated Yield: 0.937 g, 2.36 mmol, 95%.¹H NMR (500 MHz, CDCl₃) δ (ppm): 7.97 (s, 1H), 7.34 (s, 2H), 6.90 (m, 1H), 6.84 (d, 2H), 4.09 (d, 2H), 3.91 (s, 3H), 3.82 (t, 1H), 1.49 (2, 18H), 1.32 (s, 9H).

FIG. 46 shows the ¹H NMR spectrum of HL₇′ in CDCl₃, 500 MHz.

### Synthesis of HL₈′

12 equivalents of NaBH₄ (1.15 g, 30.49 mmol) were added gradually to HL₈ (1.00 g, 2.45 mmol) which was partially dissolved in ethanol (20 mL) over 4 hours, producing a colourless solution. The flask was left to stir overnight and an off-white solid formed. Water (10 mL) was added dropwise to the flask at 0° C. HCl was added to neutralise the solution and the reaction was stirred for an hour. The resulting white solid was filtered and washed with cold water twice. Because some solid appeared in the filtrate, this was re-filtered, washed similarly, and all product was dried in a vacuum oven at 40° C. Isolated Yield: 0.74 g, 1.86 mmol, 74%. ¹H NMR (400 MHz, CDCl₃) δ (ppm): 10.63 (s, 1H), 7.50-7.23 (m, 15H), 6.83-6.80 (d, 1H), 6.72 (t, 1H), 6.53-6.51 (s, 1H), 3.93 (s, 3H), 3.59 (s, 2H), 2.56 (bs, 1H). ¹³C{¹H} NMR (125 MHz, CDCl₃) δ (ppm): 148.3, 146.9, 144.8, 129.0, 128.5, 127.2, 123.9, 121.1, 119.4, 110.8, 72.0, 56.3, 47.0, 31.3.

### Fluorinated Methoxy Ligands

Synthesis of HL₄^{F}

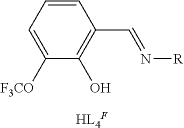

2-Hydroxy-3-(Trifluoromethoxy)benzaldehyde) (0.50 g, 2.4 mmol) was added to a round bottom flask and dissolved in ethanol (15 mL). 2,6-diisopropylaniline (0.43 g, 2.4 mmol) was added into the stirring solution and his reaction mixture was refluxed for 24 hours resulting in a bright solution. Ethanol was removed and the crude product was recrystallized from DCM. ¹H NMR (400 MHz, CDCl₃) δ (ppm): 13.9 (s, 1H), 8.33 (s, 1H), 7.45 (d, 1H), 7.30 (d, 1H), 7.20 (s, 3H), 6.95 (t, 1H), 2.97 (m, 2H), 1.19 (d, 12H). ¹⁹F{¹H} NMR (376 MHz, CDCl₃) δ (ppm): 58.08

FIG. 47 shows the ¹H NMR spectrum of HL₄^{F} in CDCl₃, 400 MHz.

### Example 9—Complex Synthesis

### Using Imine Ligands

Synthesis of [(L₄^{F})₂Ti(OⁱPr)₂]

HL₄^{F} (0.50 g, 1.37 mmol) and Ti(OⁱPr)₄ (0.19 g, 0.68 mmol) were dissolved separately in toluene (5 mL and 5 mL, respectively), and cooled to −30° C. in a glovebox freezer. The two solutions were then mixed and allowed to stir for 24 hours. Volatiles were removed in vacuo and hexane (10 mL) was added to the resulting orange-yellow wax. This hexane was removed under vacuum to provide the final complex as a bright orange powder. ¹H NMR (400 MHz, CDCl₃) δ (ppm): 8.05 (s, 2H), 7.25-7.10 (m, 10H), 6.54 (t, 2H), 4.10 (m, 2H), 3.71 (bm, 4H), 1.19-0.24 (bm, 36H). ¹⁹F{¹H} (376 MHz, CDCl₃) δ (ppm): 58.4.

FIG. 48 shows the ¹H NMR spectrum of [(L^{F}₄)₂Ti(OⁱPr)₂] in CDCl₃, 400 MHz, as well as the ¹⁹F{¹H} NMR spectrum comparing HL^{F}₄ (−58.1 ppm) and [(L^{F}₄)₂Ti(OⁱPr)₂] (−58.4)₄₀₀ MHz in CDCl₃.

Synthesis of [(L₄)₂Ti(OEt)₂]

HL₄ (0.5 g, 1.61 mmol) and Ti(OEt)₄ (0.18 g, 0.80 mmol) were dissolved separately in toluene (10 mL and 10 mL, respectively), and cooled to −30° C. in a glovebox freezer. The two solutions were then mixed and allowed to stir for 24 hours. Volatiles were removed in vacuo and hexane (10 mL) was added to the resulting orange-yellow solid. This hexane was removed under vacuum to provide the final complex as a bright yellow powder (0.49 g, 0.65 mmol, 81%).¹H NMR (400 MHz, CDCl₃) δ (ppm): 8.51-8.39 (m, 2H), 7.6-7.45 (bs, 2H), 7.13-7.09 (m, 6H), 6.90 (d, 2H), 6.74 (t, 2H), 4.32 (bs, 4H), 3.94-3.89 (m, 6H), 3.15 (bs, 4H), 1.15-1.03 (m, 30H). *Broad signals as well as shouldering suggests isomerization in solution.

FIG. 49 shows the ¹H NMR spectrum of (L₄)₂Ti(OEt)₂ in CDCl₃ at 298 K.

FIG. 50 shows the ¹³C{¹H} NMR spectrum of (L₄)₂Ti(OEt)₂ in CDCl₃ at 298 K.

Synthesis of [(L₄)₂Ti(NMe₂)₂]

HL₄ (2 eq.) and Ti(NMe₂)₄ (1 eq) were dissolved separately in toluene (10 mL and 10 mL, respectively), and cooled to −30° C. in a glovebox freezer. The two solutions were then mixed and allowed to stir for 24 hours. Volatiles were removed in vacuo and hexane (10 mL) was added to the resulting red solid. Hexane was removed under vacuum to provide the final complex as a dark red powder. Crystals suitable for XRD were grown from slow evaporation of CDCl₃. ¹H NMR was inconclusive, most likely due to fluxionality in the catalyst.

### Using Amine Ligands

### General Synthesis

The appropriate amine ligand and Ti(OⁱPr)₄ in a 2:1 molar ratio, were dissolved separately in toluene (20 mL and 5 mL, respectively), and cooled in a glovebox freezer to −30° C. The dissolved ligand was added slowly to the Ti(OⁱPr)₄ solution in a Schlenk flask. After stirring for 24 hours, volatiles were removed under vacuum, and the resulting solid was twice dissolved in hexane and dried under vacuum to yield a coloured solid.

Synthesis of [(L₄)₂Ti(OⁱPr)₂]

HL₄′ (1.00 g, 3.19 mmol) was reacted with Ti(OⁱPr)₄ (0.45 g, 1.60 mmol) to give a yellow powder. Isolated Yield: 0.98 g, 1.20 mmol, 75%.¹H NMR (400 MHz, CDCl₃) δ (ppm): 7.35-7.26 (m, 6H), 7.20-7.18 (m, 2H), 6.89-6.88 (m, 4H), 5.00 (septet, 2H), 4.26-4.24 (d, 4H), 4.04 (s, 6H), 3.91-3.87 (t, 2H), 3.75 (septet, 4H), 1.50-1.44 (m, 36H). ¹³C{¹H} NMR (125 MHz, CDCl₃) δ (ppm): 152.3, 149.4, 143.9, 143.3, 126.0, 124.1, 123.9, 123.4, 117.8, 109.1, 80.2, 57.1, 51.6, 27.9, 26.0, 24.8.

FIG. 51 shows the ¹H NMR spectrum of (L₄′)₂Ti(OⁱPr)₂ in CDCl₃ at 298 K.

FIG. 52 shows the ¹³C{¹H} NMR spectrum of (L₄′)₂Ti(OⁱPr)₂ in CDCl₃ at 298 K.

Synthesis of [(L₅)₂Ti(OⁱPr)₂]

HL₅′ (0.40 g, 1.31 mmol) was reacted with Ti(OⁱPr)₄ (0.19 g, 1.31 mmol) to give a pale-yellow powder. Isolated Yield: 0.23 g, 0.30 mmol, 46%. ¹H NMR (400 MHz, CDCl₃): 7.52-7.45 (m, 8H), 7.36 (m, 2H), 7.23 (m, 2H), 7.14-7.13 (dd, 2H), 6.96-6.95 (dd, 2H), 6.83 (d, 2H), 6.79 (td, 2H), 6.68-6.63 (m, 4H), 4.78 (septet, 2H), 4.50 (t, 2H), 4.38 (d, 4H), 3.7 (s, 6H), 1.23 (d, 12H). ¹³C{¹H} NMR (125 MHz, CDCl₃) δ (ppm): 151.8, 148.8, 145.3, 139.8, 130.3, 129.4, 128.9, 128.7, 127.5, 127.1, 124.7, 122.2, 117.3, 116.8, 110.8, 108.5, 80.0, 56.8, 43.1, 25.5.

FIG. 53 shows the ¹H NMR spectrum of (L₅′)₂Ti(OⁱPr)₂ in CDCl₃ at 298 K.

FIG. 54 shows the ¹³C{¹H} NMR spectrum of (L₅′)₂Ti(OⁱPr)₂ in CDCl₃ at 298 K.

Synthesis of [(L₆)₂Ti(OⁱPr)₂]

HL₆′ (2.00 g, 6.96 mmol) was reacted with Ti(OⁱPr)₄ (0.99 g, 6.96 mmol) to give an orange solid. Isolated Yield: 1.60 g, 2.16 mmol, 62%. ¹H NMR (400 MHz, CDCl₃): 6.90 (d, 2H), 6.65-6.60 (m, 4H), 4.84 (septet, 2H), 3.83 (s, 6H), 3.77 (d, 4H), 2.10 (s, 6H), 1.78-1.66 (m, 30H), 1.26 (d, 12H). ¹³C{¹H} NMR (125 MHz, CDCl₃) δ (ppm): 152.1, 149.0, 127.1, 123.5, 117.5, 108.5, 79.8, 57.0, 50.8, 43.0, 41.3, 37.1, 29.9, 25.9.

FIG. 55 shows the ¹H NMR spectrum of (L₆′)₂Ti(OⁱPO₂ in CDCl₃ at 298 K.

FIG. 56 shows the ¹³C{¹H} NMR spectrum of (L₆′)₂Ti(OⁱPO₂ in CDCl₃ at 298 K.

Synthesis of [(L₇)₂Ti(OⁱPr)₂]

HL₇′ (0.80 g, 2.02 mmol) was reacted with Ti(OⁱPr)₄ (0.29 g, 1.01 mmol) to give a yellow solid. Isolated Yield: 0.749 g, 0.780 mmol, 77%. ¹H NMR (400 MHz, CDCl₃): 7.40 (s, 4H), 7.14 (d, 2H), 6.74 (m, 4H), 4.71 (m, 2H), 4.08 (m, 6H), 3.90 (s, 6H), 1.58 (s, 36H), 1.39 (s, 18H), 1.20 (d, 12H).

FIG. 57 shows the ¹H NMR spectrum of (L₇′)₂Ti(OⁱPr)₂ in CDCl₃ at 298 K. 400 MHz.

### Example 10—Crystallodraphic Studies

The structure of the complexes prepared from amine ligands could in some cases be confirmed by X-ray crystallography and are shown to adopt Type C coordination (O,O/O,O coordination, Scheme 3). FIG. 58 shows the X-ray crystal structures of (L₄′)₂Ti(OⁱPr)₂ (top) and (L₇′)₂Ti(OⁱPr)₂ (bottom) showing Type C coordination.

Having regard to FIGS. 59 to 61, the ¹H NMR spectra of (L₄-6′)₂Ti(OⁱPO₂ remain virtually unchanged upon cooling (R.T. to −80° C.) or heating (R.T. to 80° C.) confirming (based on the assignment of the R.T. ¹H NMR and the solid state structures of (L₄₋₆′)₂Ti(OⁱPr)₂) that 1) all of these catalysts contain Type C coordination 2) and these catalysts retain this coordination chemistry from −80° C. to 80° C.

The initiating group on the titanium could be changed from isopropoxide to ethoxide or dimethylamide by changing the titanium precursor to Ti(OEt)₄ or Ti(NMe₂)₄, thus yielding (L₄)₂Ti(OEt)₂ and (L₄)₂Ti(NMe₂)₂ respectively. The structures of these compounds were confirmed using x-ray crystallography. FIG. 62 suggests that changing the steric bulk of the initiating group has an effect on the observed coordination type.

### Example 11—Polymerisation Studies

Amide catalysts (L₄₋₆′)₂Ti(OⁱPO₂ were tested for ethylene polymerization in solution with MAO as an initiator and in the slurry phase after being preimmobilized on sMAO (according to the procedure described in Example 6).

Polymerization in the solution phase was carried out as follows: MAO (mole ratio 1000:1, Al:Ti) and n-hexane (50 mL) were added to a high-pressure Rotaflo ampoule. To this 1 mg of complex was introduced by adding 200 μL of a 1 mL stock solution containing 5 mg solid. After degassing the headspace of the ampoule, ethylene (2 bar) was passed to the flask heated at 80° C. for 5 minutes, after which time the ethylene was removed under vacuum, and the flask was taken out of the oil bath. The sticky solid formed on the stirrer bar was filtered, washed with pentane and dried.

Polymerization in the slurry phase was carried out according to the following procedure: Triisobutylaluminium (TIBA) (150 mg, 0.76 mmol) in 10 mL n-hexane was used to wash the inside of a high-pressure Rotaflo ampoule. Supported complex (10 mg, 7.45×10⁻⁴ mmol Ti) was then added, and the solid washed into the flask with a further 40 mL n-hexane. After degassing the headspace, ethylene (2 bar) was passed into the flask and heated at 80° C. for 30 minutes, after which time the reaction was stopped by removing the ethylene under vacuum, and the ampoule was taken out of the oil bath. The resulting solid was filtered, washed with pentane, and dried under vacuum. The yield was calculated from the total solid mass minus the mass of supported catalyst used (10 mg).

FIG. 63 illustrates the activity of the tested catalysts, as well as the morphology of the obtained polyethylene (PE). It is clear from FIG. 63 that the PE produced on sMAO showed relatively uniform morphology in the SEM where the PE produced from solution phase polymerization was less uniform. The melting temperature of PE derived from slurry phase polymerization was uniformly higher than the corresponding solution phase polymerization. In addition, PE derived from slurry phase polymerization could be annealed through slow cooling cycles in order to increase the melt temperature of the final product by 2-3° C. (Table 5).

TABLE 5
Melt temperature of pre- and post-annealed polyethylenes prepared by slurry and
solution phase polymerisation

| Catalyst | | Tₘ/° C. | ΔTₘ/° C. |
|---|---|---|---|
| (L₄′)₂Ti(OⁱPr)₂(sMAO) | Pre-anneal | 133.8 | +3.4 |
| | Post-anneal | 137.2 | |
| (L₄′)₂Ti(OⁱPr)₂(Solution) | Pre-anneal | 130.7 | 0.0 |
| | Post-anneal | 130.7 | |
| (L₅′)₂Ti(OⁱPr)₂(sMAO) | Pre-anneal | 132.4 | +4.6 |
| | Post-anneal | 137.0 | |
| (L₅′)₂Ti(OⁱPr)₂(Solution) | Pre-anneal | 129.9 | −0.3 |
| | Post-anneal | 129.6 | |
| (L₆′)₂Ti(OⁱPr)₂(sMAO) | Pre-anneal | 136.0 | +2.0 |
| | Post-anneal | 138.0 | |
| (L₆′)₂Ti(OⁱPr)₂(Solution) | Pre-anneal | 128.6 | −0.1 |
| | Post-anneal | 128.5 | |

In a separate experiment, the carbocation, [Ph₃C][B(PhF₅)₄], in conjunction with triisobutylaluminum, was able to initiate the polymerization of ethylene in (L₄)₂Ti(OⁱPr)₂ and (L₆)₂Ti(OⁱPr)₂. The PE produced was a free-flowing off-white powder with a melting point of ˜130° C.

In a separate experiment, (L₄₋₆)₂Ti(OⁱPO₂ and (L₄′)₂Ti(OⁱPO₂ were tested at elevated pressure and over a variety of temperatures. These high pressure experiments were carried out according to the following procedure: Triisobutylaluminium (TIBA) (600 mg, 3 mmol) as injected into a 1 L stainless steel high pressure reaction vessel along with 18 700 mL of hexane. The desired amount of supported catalyst (0.03-0.05 g) was then added along with ˜50 mL of hexane. The reaction vessel was then heated to the desired temperature and pressurised with ethylene. After the desired reaction time the resulting polymer was filtered and allowed to dry for at least 12 hours.

It is clear from FIG. 64 that all catalysts were active for the polymerization of ethylene following the order: (L₄)₂Ti(OiPO₂<(L₄′)₂Ti(OiPO₂<(L₆)₂Ti(OiPO₂. The catalysts were also shown to be active in the presence of comonomers such as 1-hexene, methyl methacrylate and styrene.

While specific embodiments of the invention have been described herein for the purpose of reference and illustration, various modifications will be apparent to a person skilled in the art without departing from the scope of the invention as defined by the appended claims.

### REFERENCES

1. Sheldrick, G. M., A short history of SHELX. Acta Crystallographica Section A: Foundations of Crystallography 2008, 64, 112-122.
2. Farrugia, L. J., WinGX and ORTEP for Windows: an update. Journal of Applied Crystallography 2012, 45, 849-854.
3. Wilson, A. J. C., International Tables for Crystallography. 1st ed.; Kluwer Academic Publishers: Dordrecht, 1992; Vol. C.

1. A process for the polymerisation of at least one olefin, the process comprising the step of contacting the at least one olefin with a compound having a structure according to formula (I-A), (I-B) or (I-C) shown below: 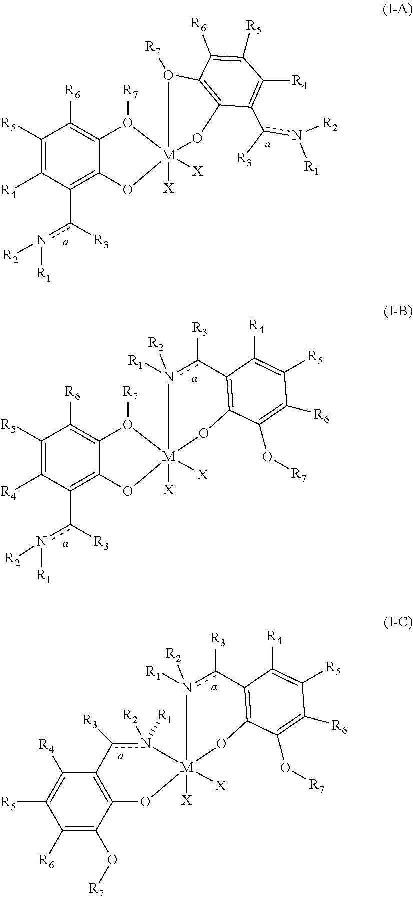
wherein
M is a Group IV transition metal,
each X is independently selected from halo, hydrogen, a phosphonate, sulfonate or boronate group, (1-4C)dialkylamino, (1-6C)alkyl, (1-6C)alkoxy, aryl, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃,
R₂ is absent or is selected from hydrogen, halo, oxo, hydroxy, amino, nitro, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
bond a is a carbon-nitrogen single bond (C—N) or a carbon-nitrogen double bond (C═N), with the proviso that when R₂ is absent, bond a is a carbon-nitrogen double bond (C═N), and when R₂ is other than absent, bond a is a carbon-nitrogen single bond (C—N),
R₃, R₄, R₅ and R₆ are each independently selected from hydrogen, halo, oxo, hydroxy, amino, nitro, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
R₇ is selected from (1-6C)alkyl, (2-6C)alkenyl, (2-6C)alkynyl, (1-6C)haloalkyl, aryl, heteroaryl, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and (1-6C)alkoxy,
R₁ is a group having the formula (II) shown below: 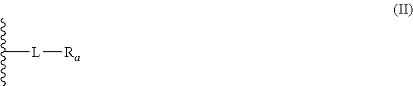
wherein
Rₐ is selected from (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (2-6C)alkenyl, (2-6C)alkynyl, (1-6C)haloalkyl, aryl, aryloxy, heteroaryl, heteroaryloxy, carbocyclyl and heterocyclyl,
L is a group —[C(Rₓ)₂]ₙ—
wherein
each Rₓ is independently selected from hydrogen, (1-6C)alkyl, (2-6C)alkenyl, (2-6C)alkynyl, (1-6C)haloalkyl, (1-6C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-6C)alkyl, (2-6C)alkenyl, (2-6C)alkynyl, (1-6C)haloalkyl and aryl, and
n is 0, 1, 2, 3 or 4.

2. The process of claim 1, wherein the compound has a structure according to formula (I-A) or (I-B).

3. The process of claim 1, wherein the compound has a structure according to formula (I-A).

4. The process of claim 1, wherein the compound has a structure according to formula (I-B).

5. The process of claim 1, wherein the compound has a structure according to formula (I-C).

6. The process of any preceding claim, wherein M is selected from titanium, zirconium and hafnium.

7. The process of any preceding claim, wherein M is selected from titanium and zirconium.

8. The process of any preceding claim, wherein M is titanium.

9. The process of any preceding claim, wherein each X is independently selected from halo, hydrogen, (1-6C)alkoxy, —N(CH₃)₂, —N(CH₂CH₃)₂, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃.

10. The process of any preceding claim, wherein each X is independently selected from halo, hydrogen, (1-6C)alkoxy, and aryloxy, any of which may be optionally substituted one of more groups selected from halo, oxo, hydroxy, amino, nitro, (1-6C)alkyl, (2-6C)alkenyl, (2-6C)alkynyl, (1-6C)haloalkyl, (1-6C)alkoxy, aryl and Si[(1-4C)alkyl]₃.

11. The process of any one of claims 1 to 9, wherein each X is independently selected from halo, hydrogen, (1-6C)alkoxy, —N(CH₃)₂, —N(CH₂CH₃)₂ and aryloxy, any of which may be optionally substituted one of more groups selected from halo, oxo, hydroxy, amino, nitro, (1-6C)alkyl, (1-6C)haloalkyl, (1-6C)alkoxy and aryl.

12. The process of claim 11, wherein each X is independently selected from halo, hydrogen, (1-6C)alkoxy, and aryloxy, any of which may be optionally substituted one of more groups selected from halo, oxo, hydroxy, amino, nitro, (1-6C)alkyl, (1-6C)haloalkyl, (1-6C)alkoxy and aryl.

13. The process of any one of claims 1 to 9, wherein each X is independently selected from halo, hydrogen, (1-4C)alkoxy, —N(CH₃)₂, —N(CH₂CH₃)₂ and phenoxy, any of which may be optionally substituted one of more groups selected from halo, oxo, hydroxy, amino, nitro, (1-4C)alkyl, (1-4C)haloalkyl, (1-4C)alkoxy and phenyl.

14. The process of claim 13, wherein each X is independently selected from halo, hydrogen, (1-4C)alkoxy, and phenoxy, any of which may be optionally substituted one of more groups selected from halo, oxo, hydroxy, amino, nitro, (1-4C)alkyl, (1-4C)haloalkyl, (1-4C)alkoxy and phenyl.

15. The process of any preceding claim, wherein each X is independently selected from halo, hydrogen, and (1-4C)alkoxy, any of which may be optionally substituted one of more groups selected from halo, hydroxy, amino, (1-4C)alkyl and (1-4C)alkoxy.

16. The process of any preceding claim, wherein each X is independently selected from chloro, bromo and (1-4C)alkoxy.

17. The process of any preceding claim, wherein each X is independently (1-4C)alkoxy.

18. The process of any preceding claim, wherein each X is isopropoxy.

19. The process of any one of claims 1 to 9, wherein each X is independently —N(CH₃)₂ or —N(CH₂CH₃)₂.

20. The process of any preceding claim, wherein R₂ is absent or hydrogen.

21. The process of any preceding claim, wherein R₂ is absent.

22. The process of any one or claims 1 to 20, wherein R₂ is hydrogen.

23. The process of any preceding claim, wherein R₃, R₄, R₅ and R₆ are each independently selected from hydrogen, halo, oxo, hydroxy, amino, nitro, (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which may be optionally substituted with one or more substituents selected from halo, oxo, hydroxy, amino, nitro, (1-4C)alkyl, (2-4C)alkenyl, (2-4C)alkynyl, (1-4C)haloalkyl and (1-4C)alkoxy.

24. The process of any preceding claim, wherein R₃, R₄, R₅ and R₆ are each independently selected from hydrogen, halo, oxo, hydroxy, amino, nitro, (1-4C)alkyl, (1-4C)haloalkyl, (1-4C)alkoxy, aryl and heteroaryl, any of which may be optionally substituted with one or more substituents selected from halo, oxo, hydroxy, amino, nitro, (1-4C)alkyl, (1-4C)haloalkyl and (1-4C)alkoxy.

25. The process of any preceding claim, wherein R₃, R₄, R₅ and R₆ are each independently selected from hydrogen, halo, amino, nitro, (1-4C)alkyl, (1-4C)haloalkyl, (1-4C)alkoxy, aryl and heteroaryl, any of which may be optionally substituted with one or more substituents selected from halo and (1-4C)alkyl.

26. The process of any preceding claim, wherein R₃ is hydrogen.

27. The process of any preceding claim, wherein R₃, R₄, R₅ and R₆ are hydrogen.

28. The process of any preceding claim, wherein R₇ is selected from (1-6C)alkyl, (2-6C)alkenyl, (2-6C)alkynyl, (1-6C)haloalkyl, aryl and heteroaryl, any of which may be optionally substituted with one or more substituents selected from halo, oxo, hydroxy, amino, nitro, (1-6C)alkyl, (1-6C)haloalkyl and (1-6C)alkoxy.

29. The process of any preceding claim, wherein R₇ is selected from (1-4C)alkyl, (2-4C)alkenyl, (2-4C)alkynyl, (1-4C)haloalkyl, aryl and heteroaryl, any of which may be optionally substituted with one or more substituents selected from halo, oxo, hydroxy, amino, nitro, (1-4C)alkyl, (1-4C)haloalkyl and (1-4C)alkoxy.

30. The process of any preceding claim, wherein R₇ is selected from (1-4C)alkyl, (1-4C)haloalkyl, aryl and heteroaryl, any of which may be optionally substituted with one or more substituents selected from halo, hydroxy, amino, (1-4C)alkyl and (1-4C)alkoxy.

31. The process of any preceding claim, wherein R₇ is selected from (1-4C)alkyl and aryl, any of which may be optionally substituted with one or more substituents selected from halo, hydroxy, amino, (1-4C)alkyl and (1-4C)alkoxy.

32. The process of any preceding claim, wherein R₇ is selected from (1-2C)alkyl and phenyl, any of which may be optionally substituted with one or more substituents selected from halo, hydroxy, amino and (1-4C)alkyl.

33. The process of any preceding claim, wherein R₇ is selected from (1-2C)alkyl, which may be optionally substituted with one or more substituents selected from halo (e.g. fluoro).

34. The process of any preceding claim, wherein R₇ is (1-2C)alkyl.

35. The process of any preceding claim, wherein R₇ is methyl.

36. The process of any preceding claim, wherein Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (2-6C)alkenyl, (2-6C)alkynyl, (1-6C)haloalkyl, aryl, aryloxy, heteroaryl, heteroaryloxy, carbocyclyl and heterocyclyl.

37. The process of any preceding claim, wherein Rₐ is selected from (1-4C)alkyl, (2-4C)alkenyl, (2-4C)alkynyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy.

38. The process of any preceding claim, wherein Rₐ is selected from (1-4C)alkyl, (1-4C)haloalkyl, (1-4C)alkoxy, aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy.

39. The process of any preceding claim, wherein Rₐ is selected from aryl, aryloxy, heteroaryl, heteroaryloxy, carbocyclyl and heterocyclyl, any of which (for example the aryl group) may be optionally substituted with one or more substituents selected from halo, oxo, hydroxy, amino, nitro, (1-6C)alkyl, (1-6C)haloalkyl, aryl, aryloxy, heteroaryl and heteroaryloxy.

40. The process of any preceding claim, wherein Rₐ is selected from phenyl, phenoxy, 5-7 membered heteroaryl, 5-7 membered heteroaryloxy, 5-12 membered carbocyclyl and 5-12 membered heterocyclyl, any of which (for example the phenyl group) may be optionally substituted with one or more substituents selected from halo, oxo, hydroxy, amino, nitro, (1-5C)alkyl, (1-5C)haloalkyl, phenyl, phenoxy, heteroaryl and heteroaryloxy.

41. The process of any preceding claim, wherein Rₐ is selected from phenyl, 5-7 membered heteroaryl and 5-12 membered carbocyclyl, any of which (for example the phenyl group) may be optionally substituted with one or more substituents selected from halo, oxo, hydroxy, amino, nitro, (1-5C)alkyl, (1-5C)haloalkyl, phenyl, and heteroaryl.

42. The process of any preceding claim, wherein Rₐ is selected from phenyl and 5-12 membered carbocyclyl, any of which (for example the phenyl group) may be optionally substituted with one or more substituents selected from halo, hydroxy, amino, (1-5C)alkyl, (1-5C)haloalkyl, phenyl, and heteroaryl.

43. The process of any preceding claim, wherein Rₐ is selected from phenyl, cyclohexyl and adamantyl, any of which (for example the phenyl group) may be optionally substituted with one or more substituents selected from halo, (1-5C)alkyl, phenyl, and heteroaryl.

44. The process of any preceding claim, wherein each Rₓ is independently selected from hydrogen, (1-6C)alkyl, (1-6C)alkoxy and aryl, any of which may be optionally substituted with one or more substituents selected from halo, oxo, hydroxy, amino, nitro, (1-6C)alkyl and (1-6C)haloalkyl.

45. The process of any preceding claim, wherein each Rₓ is independently selected from hydrogen, (1-4C)alkyl, (1-4C)alkoxy and phenyl, any of which may be optionally substituted with one or more substituents selected from halo, amino and (1-6C)alkyl.

46. The process of any preceding claim, wherein each Rₓ is independently selected from hydrogen, (1-4C)alkyl, and phenyl, any of which may be optionally substituted with one or more substituents selected from halo, amino and (1-3C)alkyl.

47. The process of any preceding claim, wherein each Rₓ is phenyl.

48. The process of any preceding claim, wherein n is 0, 1 or 2.

49. The process of any preceding claim, wherein n is 0 or 1.

50. The process of any preceding claim, wherein the compound is immobilized on a supporting substrate.

51. The process of claim 50, wherein the supporting substrate is a solid.

52. The process of claim 50 or 51, wherein the supporting substrate is selected from solid methyaluminoxane, silica, silica-supported methylaluminoxane, alumina, zeolite, layered double hydroxide and layered double hydroxide-supported methylaluminoxane.

53. The process of claim 50, 51 or 52, wherein the supporting substrate is solid methylaluminoxane.

54. The process of any preceding claim, wherein the at least one olefin is at least one (2-10C)alkene.

55. The process of any preceding claim, wherein the at least one olefin is at least one α-olefin.

56. The process of any preceding claim, wherein the at least one olefin is ethene and optionally one or more other (3-10C)alkenes (e.g. 1-hexene, styrene and/or methyl methacrylate).

57. The process of any preceding claim, wherein the at least one olefin is ethene.

58. The process of any preceding claim, wherein the mole ratio of the compound of formula (I-A), (I-B) or (I-C) to the at least one olefin is 1:50 to 1:10,000.

59. The process of any preceding claim, wherein the mole ratio of the compound of formula (I-A), (I-B) or (I-C) to the at least one olefin is 1:100 to 1:1000.

60. The process of any preceding claim, wherein the mole ratio of the compound of formula (I-A), (I-B) or (I-C) to the at least one olefin is 1:150 to 1:300.

61. The process of any preceding claim, wherein the process is conducted in a solvent selected from toluene, hexane and heptane.

62. The process of any preceding claim, wherein the process is conducted for a period of 1 minute to 96 hours.

63. The process of any preceding claim, wherein the process is conducted for a period of 5 minute to 72 hours.

64. The process of any preceding claim, wherein the process is conducted at a pressure of 0.9 to 10 bar.

65. The process of any preceding claim, wherein the process is conducted at a pressure of 1.5 to 3 bar.

66. The process of any preceding claim, wherein the process is conducted at a temperature of 30 to 120° C.

67. The process of any preceding claim, wherein the process is conducted in the presence of an activator or co-catalyst.

68. The process of claim 67, wherein the activator or co-catalyst is one or more organoaluminium compounds.

69. The process of claim 68, wherein the one or more organoaluminium compounds are selected from methylaluminoxane, triisobutylaluminum and triethylaluminium.
